(19) United States
(12) Patent Application Publication
(10) Pub. No.: US 2026/0301021 A1
(43) Pub. Date: Oct. 1, 2026

(54) INFORMATION PROCESSING SYSTEM, INFORMATION PROCESSING METHOD, AND APPARATUS

(71) Applicant: Hidetoshi Kikuchi, Tokyo (JP)

(72) Inventor: Hidetoshi Kikuchi, Tokyo (JP)

(73) Assignee: Ricoh Company, Ltd., Tokyo (JP)

(21) Appl. No.: 19/573,561

(22) Filed: Mar. 20, 2026

(30) Foreign Application Priority Data
Apr. 1, 2025 (JP) 2025-060567
Sep. 25, 2025 (JP) 2025-159631

(51) Int. Cl. G06Q 30/0251; G06T 11/00; G10L 15/183; G10L 15/22; G10L 15/30; G10L 25/63

(52) U.S. Cl. CPC G06Q 30/0251; G06T 11/00; G10L 15/183; G10L 15/22; G10L 15/30; G10L 25/63

(57) ABSTRACT

An information processing system includes: an information processing apparatus including first circuitry that receives, from a terminal apparatus, audio data including an utterance made by a person in a space, transmits to artificial intelligence (AI) a prompt including space information and content of the audio data and requesting a proposal, acquires a response transmitted from the AI, generates, based on the response, display data of a screen including the proposal, and transmits the display data to the terminal apparatus; and the terminal apparatus including second circuitry that transmits the audio data to the information processing apparatus, and causes a display in the space to display the screen including the proposal for the person based on the display data.

### CROSS-REFERENCE TO RELATED APPLICATIONS

This patent application is based on and claims priority pursuant to 35 U.S.C. § 119(a) to Japanese Patent Application Nos. 2025-060567, filed on Apr. 1, 2025, 2025-159631, filed on Sep. 25, 2025, in the Japan Patent Office, the entire disclosure of which is hereby incorporated by reference herein.

### BACKGROUND

### Technical Field

The present disclosure relates to an information processing system, an information processing method, and an apparatus.

### Related Art

When persons have a conversation in a space, information to be presented by the persons is proposed to facilitate the conversation. Proposal materials are presented while taking into account the emotions of a customer. For example, the emotions of a customer are analyzed based on the customer's speech or video, and the analysis results are used to propose materials for addressing the customer's issues. In addition, the results of daily emotion analysis are compared with the analysis results of the emotions at the time of the proposal, and proposal materials related to a keyword in the speech are presented.

### SUMMARY

The present disclosure described herein provides an information processing system including an information processing apparatus, a terminal apparatus, a microphone located in a space, and a display located in the space. The information processing apparatus includes first circuitry. The first circuitry receives audio data from the terminal apparatus. The audio data includes an utterance made by a person in the space. The utterance is input to the microphone. The first circuitry transmits a prompt to artificial intelligence (AI). The prompt includes space information and content of the audio data and requests a proposal based on the space information and the content of the audio data, the space information including information related to the space. The first circuitry acquires a response transmitted from the AI, generates, based on the response, display data of a screen including the proposal, and transmits the display data to the terminal apparatus. The terminal apparatus includes second circuitry. The second circuitry transmits the audio data to the information processing apparatus, and causes the display to display the screen including the proposal for the person, based on the display data.

The present disclosure described herein provides an information processing method including receiving audio data, the audio data including an utterance made by a person in a space, the utterance being input to a microphone located in the space; transmitting a prompt to artificial intelligence (AI), the prompt including space information and content of the audio data and requesting a proposal based on the space information and the content of the audio data, the space information including information related to the space; acquiring a response transmitted from the AI; generating, based on the response, display data of a screen including the proposal; and causing a display located in the space to display the screen including the proposal for the person, based on the display data.

The present disclosure described herein provides an apparatus including circuitry. The circuitry acquires audio data. The audio data includes an utterance made by a person in a space, the utterance being input to a microphone located in the space. The circuitry transmits a prompt to artificial intelligence (AI). The prompt includes space information and content of the audio data and requests a proposal based on the space information and the content of the audio data. The space information includes information related to the space. The circuitry acquires a response transmitted from the AI, generates, based on the response, display data of a screen including the proposal, and causes a display located in the space to display the screen including the proposal for the person, based on the display data.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example configuration of an information processing system located in a space;

FIG. 2 is a diagram illustrating an example hardware configuration of a server apparatus and a terminal apparatus;

FIG. 3 is a diagram illustrating an example functional configuration of an information processing system;

FIG. 4 is a diagram illustrating an example of a text data table stored in a text data storage unit;

FIG. 5 is a diagram illustrating an example of a temporarily stored information table registered in a temporarily stored information storage unit;

FIG. 6 is a diagram illustrating an example of a customer information table registered in a customer information storage unit;

FIG. 7 is a diagram illustrating an example of schedule information registered in a schedule information storage unit;

FIGS. 8A and 8B are diagrams illustrating an example of a product information table and a service information table registered in a product information storage unit, respectively;

FIG. 9 is a diagram illustrating an example of a business negotiation history table registered in a business negotiation history information storage unit;

FIG. 10 is a diagram illustrating an example of a daily report information table registered in a daily report information storage unit;

FIG. 11 is a diagram illustrating an example of a spatial feature information table registered in a spatial feature information storage unit;

FIG. 12 is a flowchart illustrating an example of a flow of control performed by a control unit for a business negotiation;

FIG. 13 is a sequence diagram illustrating an example of opening processing and operations at the time of a customer visit;

FIG. 14 is a diagram illustrating an example welcome message screen displayed on a display;

FIG. 15 is a diagram illustrating an example business negotiation space settings screen displayed on a terminal apparatus;

FIG. 16 is a sequence diagram illustrating an example of opening processing and operations at the time of a customer visit;

FIG. 17 is a diagram illustrating an example business negotiation space settings screen displayed on a terminal apparatus;

FIG. 18 is a diagram illustrating an example customer list screen displayed on a terminal apparatus;

FIG. 19 is a sequence diagram illustrating an example of processing performed by a server apparatus to display a proposal based on audio data acquired from a space and space information;

FIG. 20 is a diagram illustrating an example proposal display screen displayed on a display by a server apparatus;

FIG. 21 is a diagram illustrating an example proposal display screen displayed on a display by a server apparatus;

FIG. 22 is a sequence diagram illustrating an example of processing for displaying a closing screen on a display;

FIG. 23 is a diagram illustrating an example closing screen displayed on a display;

FIG. 24 is a sequence diagram illustrating an example of processing performed by a server apparatus to generate a business negotiation history and a daily report;

FIG. 25 is a diagram illustrating an example daily report screen displayed on a terminal apparatus;

FIG. 26 is a sequence diagram illustrating an example of processing performed by a server apparatus to register or update customer information;

FIG. 27 is a diagram illustrating an example of conversation text data stored in a text data storage unit in a sales solution;

FIG. 28 is a diagram illustrating an example proposal display screen displayed on a display by a server apparatus;

FIG. 29 is a diagram illustrating an example proposal display screen displayed on a display by a server apparatus;

FIGS. 30A and 30B are diagrams illustrating example proposal display screens displayed on a terminal apparatus and a display by a server apparatus, respectively;

FIG. 31 is a diagram illustrating an example of confidential information;

FIG. 32 is a sequence diagram illustrating an example of processing performed by a server apparatus to display a proposal on a terminal apparatus and a display;

FIGS. 33A, 33B, and 33C are diagrams illustrating example proposal display screens displayed on a terminal apparatus and a display by a server apparatus;

FIG. 34 is a sequence diagram illustrating an example of processing performed by a server apparatus to display a proposal on a terminal apparatus and a display based on audio data and space information in accordance with an operation by a sales representative;

FIG. 35 is a diagram illustrating example proposals provided via voice messages delivered through an earphone by an artificial intelligence (AI) system based on a conversation;

FIG. 36 is a sequence diagram illustrating an example of processing performed by a server apparatus to output a voice message from an earphone based on audio data and space information;

FIG. 37 is a diagram illustrating an example functional configuration of an information processing system;

FIG. 38 is a sequence diagram illustrating an example of processing performed by a server apparatus to display a proposal based on audio data acquired from a space and space information, and to display emotion information;

FIG. 39 is a diagram illustrating an example proposal display screen displayed on a terminal apparatus by a server apparatus;

FIG. 40 is a diagram illustrating an example system configuration of an information processing system;

FIG. 41 is a diagram illustrating an example functional configuration of an information processing system;

FIG. 42 is a sequence diagram illustrating an example of processing performed by a server apparatus to register information generated during a business negotiation in an external service system;

FIG. 43 is a sequence diagram illustrating an example of processing and operations for allowing a sales representative to download, from an external service system, information generated during a business negotiation;

FIG. 44 is a diagram illustrating an example information search screen displayed on a terminal apparatus in step S201 of the sequence diagram illustrated in FIG. 43;

FIG. 45 is a diagram illustrating an example registered-information list screen displayed on a terminal apparatus in step S209 of the sequence diagram illustrated in FIG. 43;

FIG. 46 is a diagram illustrating an example display located in a space;

FIG. 47 is a diagram illustrating an example functional configuration of an information processing system;

FIG. 48 is a diagram illustrating an example setting screen for setting information to be displayed on displays by a sales representative;

FIG. 49 is a diagram illustrating an example functional configuration of an information processing system;

FIG. 50 is a flowchart illustrating an example of processing performed by a terminal apparatus to display a proposal based on audio data acquired from a space and space information;

FIG. 51 is a sequence diagram illustrating an example of processing performed by a Web browser to display an optimal proposal or a predicted proposal on a proposal display screen;

FIG. 52 is a diagram illustrating an information processing system located in a space according to a modification;

FIG. 53 is a diagram illustrating an information processing system located in a space according to a modification; and

FIG. 54 is a perspective view of a wearable microphone.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An information processing system and an information processing method performed by the information processing system according to an embodiment of the present disclosure are described below with reference to the drawings.

### Added Value for Space

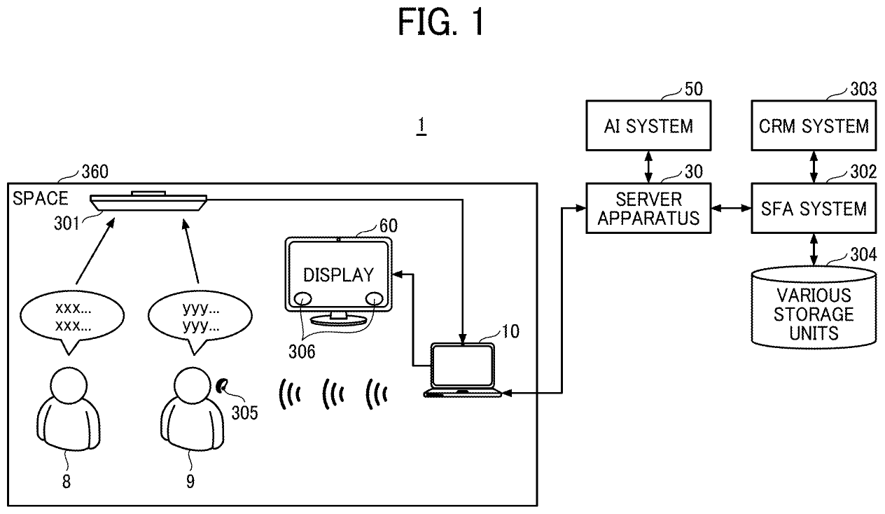

A scenario that may arise during a conversation, such as a business negotiation, between persons in a space will be described with reference to FIG. 1. FIG. 1 is a diagram illustrating an example configuration of an information processing system 1 located in a space. In a business negotiation room, for example, a sales representative 9 and a customer 8 have a conversation. The sales representative 9 might find it difficult to draw out true intentions of the customer 8 during the conversation and to propose a product leading to a purchase while maintaining an appropriate distance from the customer 8.

For example, the sales representative 9 preferably grasps customer data such as attributes and past purchase history of the customer 8 before starting a business negotiation with the customer 8. This is to avoid proposing the same product or asking inappropriate questions. However, investigating these items before the start of the business negotiation can be time-consuming. If the customer 8 visits earlier than expected, preparation may be incomplete.

Furthermore, even when the customer 8 states a desired product, if the statement is ambiguous or if the sales representative 9 fails to appropriately grasp its meaning, proposed products may not align with the product desired by the customer 8. Excessively long speech by the customer 8 may make it difficult for the sales representative 9 to identify key points and organize requests.

Furthermore, even if a specific product is elicited from the customer 8, if the product is out of stock, the sales representative 9 often hesitates as to what product to propose as an alternative. Also, when the customer 8 has a fixed budget, it may be difficult to propose a satisfactory product or service within the same price range. Additionally, when the same product is sold online, it is challenging to make a proposal that encourages the customer 8 to purchase at the store while avoiding direct price competition.

Furthermore, the sales representative 9 may use technical terms when explaining a product, which may fail to be fully understood by the customer 8. If the sales representative 9 notices the lack of understanding, the sales representative 9 can rephrase the explanation using terms that are easier for the customer 8 to understand; however, the sales representative 9 may fail to notice it. Moreover, even if the sales representative 9 notices it, it can be difficult to immediately provide an appropriate paraphrase.

Furthermore, if the sales representative 9 lacks sufficient product knowledge, it may be difficult for the sales representative 9 to provide immediate answers to questions from the customer 8, which can create distrust. The sales representative 9 may fail to immediately respond when asked about differences from other products, such as “How does this differ from Product X?”. In this case, it would be ideal to propose a product superior to other products; however, it can take time to propose a product of a category with which the sales representative 9 is unfamiliar.

Furthermore, even if a specific product is elicited from the customer 8, some sales representatives 9 find it difficult to make a proposal that anticipates needs. Anticipating needs refers to anticipatorily proposing a product that has a high probability of being desired in the future although not directly mentioned in the conversation. If such an anticipatory proposal is made, the sales representative 9 can propose products to the customer 8 at an early stage, thereby gaining a competitive advantage over other companies.

Furthermore, when a business negotiation approaches its end, failure to take notes on discussions up to that time may prevent the sales representative 9 from sharing final decisions and purchased products with the customer 8. Conversely, taking detailed notes on the discussions may make it difficult for the sales representative 9 to concentrate on the business negotiation. While the sales representative 9 registers a daily report or a business negotiation history after the business negotiation, creating these documents while recalling the details of the discussions imposes a burden.

Accordingly, in an embodiment of the present disclosure, rather than simply proposing a product based on a conversation, a server apparatus 30 causes an artificial intelligence (AI) system 50 to recognize the situation within a space and propose a product or a service. The situation within the space is provided to the AI system 50 by using space information 1, space information 2, and space information 3 described below. However, not all of the space information 1, the space information 2, and the space information 3 may be included in a prompt.

By using the space information 1, the space information 2, and the space information 3 in addition to audio data of a conversation, the present embodiment provides added value in a workspace such as a business negotiation room or a conference room. In the present embodiment, a space such as a business negotiation room or a conference room may be referred to as a space 360. In the present embodiment, AI is utilized to implement creative work within the space 360.

As illustrated in FIG. 1, the space 360 is equipped with a microphone 301, speakers 306, a display 60, and a terminal apparatus 10. The microphone 301 is communicably connected to the terminal apparatus 10, and the display 60 is communicably connected to the terminal apparatus 10. The terminal apparatus 10 is connected to the server apparatus 30 via a network, and the server apparatus 30 is connected to a Sales Force Automation (SFA) system 302.

The microphone 301 acquires audio data of a conversation between the customer 8 and sales representative 9, and transmits the audio data to the terminal apparatus 10. The microphone 301 acquires conversations of persons within the space 360 without limitation to the customer 8 and the sales representative 9.

The terminal apparatus 10 transmits the audio data to the server apparatus 30. The server apparatus 30 inputs, for example, the audio data acquired by the microphone 301, the space information 1, the space information 2, the space information 3, and product information to the AI system 50, and the AI system 50 generates a product proposal matching the needs of the customer 8 in response to the input. The server apparatus 30 transmits the generated proposal to the terminal apparatus 10, and the terminal apparatus 10 causes the display 60 or a display of the terminal apparatus 10 to display the proposal. Each device is described below.

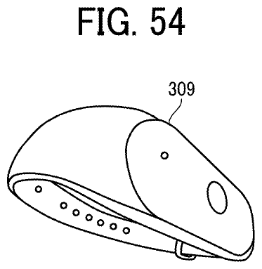

The microphone 301 preferably has directivity and has sensitivity in a direction in which the customer 8 and the sales representative 9 are located. The microphone 301 is, for example, an array microphone having multiple microphones that are combined to enhance sound from a specific direction while suppressing unwanted noise. For example, a beamforming technique analyzes signals from multiple microphones in real time and enhances sound from a specific direction, thereby dynamically adjusting directivity in accordance with the position of the customer 8 and the position of the sales representative 9. The microphone 301 transmits audio data along with its direction of arrival to the terminal apparatus 10. The microphone 301 may include, for example, pin microphones or wearable microphones worn by the customer 8 and the sales representative 9. An example of a wearable microphone is illustrated in FIG. 54.

The audio data acquired by the microphone 301 is transmitted to the terminal apparatus 10. The microphone 301 may transmit the audio data to the server apparatus 30. The terminal apparatus 10 is used for, for example, a user interface, display on the display of the terminal apparatus 10, and transmission of an instruction to an earphone 305.

The display 60 displays information received by the terminal apparatus 10 from the server apparatus 30. The display 60 preferably has a large size such that the display 60 is visible to the customer 8 and the sales representative 9 located in the space 360. The terminal apparatus 10 may mirror the content displayed on the display of the terminal apparatus 10 to the display 60, or the display 60 may display information different from the content displayed on the display of the terminal apparatus 10. Examples of the display 60 may include an electronic whiteboard and a tablet terminal. In the present embodiment, the display 60 and the microphone 301 may be implemented by a single apparatus.

In FIG. 1, the display 60 is connected to the terminal apparatus 10. Alternatively, when the server apparatus 30 is configured to generate information to be displayed on the display 60, the display 60 may be communicably connected to the server apparatus 30.

The display 60 incorporates the speakers 306. The speakers 306 may be externally attached to the display 60, or may be installed at a location separate from the display 60. The speakers 306 output a voice message transmitted from the terminal apparatus 10. The speakers 306 may be omitted.

The sales representative 9 may wear the earphone 305. Wearing the earphone 305 is effective for receiving instructions from the server apparatus 30 that are intended only for the sales representative 9. The earphone 305 communicates with the terminal apparatus 10 via a wireless standard such as Bluetooth® or Wi-Fi®. The earphone 305 outputs audio based on information generated by the server apparatus 30.

The terminal apparatus 10 is installed with an application to communicate with the server apparatus 30. The application performs processing in accordance with output information from the server apparatus 30. The output information includes, for example, display data for the display 60, display data for the terminal apparatus 10, a voice message for the speakers 306, and a voice message for the earphone 305.

The terminal apparatus 10 receives operations from, for example, the sales representative 9, and transmits information to the server apparatus 30. For example, the terminal apparatus 10 receives an instruction to start execution of an application to activate the information processing system 1, input of information related to the customer 8 that the sales representative 9 conducts a business negotiation with, and an instruction to end the business negotiation. The terminal apparatus 10 may be a general-purpose information processing terminal. Examples of the terminal apparatus 10 may include a personal computer (PC), a tablet terminal, and a smartphone. Other examples of the terminal apparatus 10 may include an electronic whiteboard, augmented reality (AR) goggles, and mixed reality (MR) goggles. The terminal apparatus 10 and the display 60 may be integrated. The terminal apparatus 10 and the microphone 301 may be integrated.

The terminal apparatus 10 may be, for example, a smartphone carried by the sales representative 9. When the sales representative 9 connects the smartphone to the server apparatus 30 and logs in to the server apparatus 30, the smartphone is usable as an installed terminal apparatus 10. In this case, the microphone 301 and the display 60 are preferably connected to the server apparatus 30. The server apparatus 30 transmits display data to the display 60 and the smartphone. Thus, in this case, pre-installation of the terminal apparatus 10 in the space 360 is optional.

The server apparatus 30 includes one or more information processing apparatuses that transmit output information to the space 360. The server apparatus 30 is communicable with the AI system 50. When the space 360 is a business negotiation room, the output information from the server apparatus 30 assists the sales representative 9, and thus the server apparatus 30 may be considered as part of the SFA system 302. The server apparatus 30 communicates with the SFA system 302 as appropriate to acquire customer information from a customer relationship management (CRM) system 303, which is managed by the SFA system 302, and to retrieve information from various storage units 304. Depending on the type of the space 360, the SFA system 302 may be omitted.

The SFA system 302 is a system for enhancing sales efficiency and automating sales activities. The SFA system 302 includes functions such as customer information management, business negotiation management, schedule management, sales forecasting, report creation, and quotation management, and assists a sales department in productivity enhancement and sales expansion.

The customer information management function is implemented by the CRM system 303. The CRM system 303 is used for centralized management of customer information such as company names, persons in charge, and previous interactions, which can be used by each sales representative to grasp customer-based situations. The business negotiation management function records the progress of an ongoing business negotiation and visualizes a current business negotiation status (e.g., pre-negotiation, in-progress, or post-negotiation). The business negotiation management function allows estimation of order acceptance probability and determination of priority of business negotiations, and prevents the omissions of follow-up. The schedule management function registers, for example, a customer's planned store visit, a sales representative's planned visit, and tasks in a calendar system and visualizes the sales representative's schedule. Further, the schedule management function uses a reminder function to notify the sales representative of a business negotiation or follow-up at an appropriate timing. This enables schedule sharing among an entire team. The sales forecasting function analyzes past sales data and forecasts future sales for each sales representative and for each team. The report creation function creates a report based on sales results, such as a daily report, to allow an executive team and managers to check the report in real time. The quotation management function automatically creates a quotation and an invoice.

While some functions of the CRM system 303 are similar to those of the SFA system 302, the CRM system 303 is a system that manages relationships between customers over the long term. The CRM system 303 assists, for example, customer information management, marketing support, and customer support. The CRM system 303 handles overall customer management for departments other than a sales department, whereas the SFA system 302 is specialized for enhancing work efficiency of a sales team. In the present embodiment, the SFA system 302 and the CRM system 303 may be integrated.

The SFA system 302 uses the various storage units 304. The various storage units 304 store, for example, product information, and will be described in detail below.

The AI system 50 is a machine learning model trained to receive a prompt as input and generate a response message corresponding to the prompt. The prompt is an inquiry or an instruction that specifies conditions of a response message to be generated by the machine learning model. It is desirable to refine a prompt to generate an accurate response message from the machine learning model. The prompt may include a statement such as an inquiry, an instruction, or a question, or may be a simple conversation that does not include any of such statements. The prompt input to the AI system 50 may include, for example, text, images, graphics, and audio. The AI system 50 generates text, images, graphics, audio, and the like as response messages based on the prompt. An example of the AI system 50 is a generative AI system using a large language model. The large language model is a natural language processing (NLP) model trained using a large amount of text data. The large language model receives an enormous amount of text as input in advance, and obtains knowledge therefrom through, for example, deep learning or reinforcement learning. The large language model uses this knowledge to provide a response message to an input prompt. An input message that is a prompt input to the large language model may include, for example, a file, an image, a graphic, and audio in addition to text such as an instruction or a question. The AI system 50 that generates the information described above may be referred to as generative AI.

The large language model is used in many NLP tasks, such as generation of a response to a specific question, automatic generation of text, summarization of text, translation, and emotion analysis. The large language model can also be used for various applications such as education, entertainment, customer service, and product development. In the present embodiment, text data converted from audio data is an input message. The server apparatus 30 may include the AI system 50.

Machine learning is a technology for making a computer acquire human-like learning ability. Machine learning refers to a technology in which a computer autonomously generates an algorithm to be used for a determination such as data identification from training data obtained in advance and applies the generated algorithm to new data to make a prediction. The learning method for machine learning may be any of supervised learning, unsupervised learning, semi-supervised learning, reinforcement learning, and deep learning, or may be a combination of two or more thereof. The learning method for machine learning is not limited.

The server apparatus 30 may generate a response message using retrieval-augmented generation (RAG). RAG is a technology that searches for and extracts information from a large number of documents accumulated in a storage unit, such as business documents, regulations, in-house information, and external information, and causes a large language model to generate a response based on the extracted information. By using RAG, the server apparatus 30 provides, to the AI system 50, information acquired from a database that holds accurate information. Thus, the AI system 50 can generate a response message based on facts.

The configuration illustrated in FIG. 1 is an example. In another example, two or more of the server apparatus 30, the AI system 50, the SFA system 302, the CRM system 303, and the various storage units 304 may be integrated. The terminal apparatus 10 may have functions of the server apparatus 30.

### Terminology

A space refers to a location where a plurality of persons have a conversation. The space may be a closed space or an open space. In the embodiments disclosed herein, a business negotiation room is an example of the space. The space may be any location where conversation can be conducted, such as a conference room, a reception room, a lounge, an individual booth, or a workspace.

Space information refers to any information related to a space. Space information 1, which is an example of space information, is information indicating an event performed in the space. Specifically, the space information 1 indicates, for example, participants of the event and a type of the event, such as a business negotiation, a consultation, or a meeting. Space information 2, which is an example of space information, is information indicating the content or purpose of an event performed in the space. Specifically, the space information 2 indicates, for example, what is to be done in the space. Space information 3, which is an example of space information, is information indicating characteristics of the space, such as the name of the space and the use of the space.

A proposal related to the content of audio data refers to a proposal for assisting the purpose of a conversation between persons. When the purpose of the conversation is selling a product, the proposal is a product corresponding to the conversation. A proposal for a person is a proposal presented to the person.

Examples of persons having a conversation in the space include a visitor and a person in charge at the space. While a customer and a sales representative are described as an example in the embodiments disclosed herein, the visitor may be a consumer, a business partner, a user, or a client. The person in charge at the space may be a store clerk, a salesclerk, a salesperson, or a staff member.

An optimal proposal is an optimal proposal generated based on the space information 1, the space information 2, the space information 3, and audio data. The optimal proposal depends on the flow and context of the conversation, and may be, for example, a proposal tailored to the customer. The content of the proposal may be a product or service handled by the sales representative. The content of the proposal may be advice. For example, the server apparatus 30 proposes advice for solving problems by utilizing specialized knowledge to a customer who visits for various types of consultations such as legal, tax, medical, counseling, professional or school relationships, housing and real estate, family (spousal, childcare, nursing, etc.), money and asset management (debt, investment, insurance, etc.), traffic accidents, IT/Internet (security, programming, online issues, smartphone selection, etc.), travel (recommended travel destinations, planning, etc.), fashion, beauty (clothing choice, makeup, hairstyle, etc.), plastic surgery, cooking and nutrition (recipes, dietary enhancement, etc.), skill and career development, educational and professional advancement, pets (care, training, health management, etc.), self-development and motivation (goal-setting, motivation maintenance, etc.), fortune-telling, and other personal issues.

A predicted proposal is a proposal of a product or service that has not been explicitly mentioned by the customer but is inferred to be a possible purchase based on the previous utterances made by the customer. For example, when the customer mentions “moving”, a proposal for a moving company is considered an optimal proposal, whereas a proposal for furniture based on a floor plan associated with the move is considered a predicted proposal.

### Example Hardware Configuration

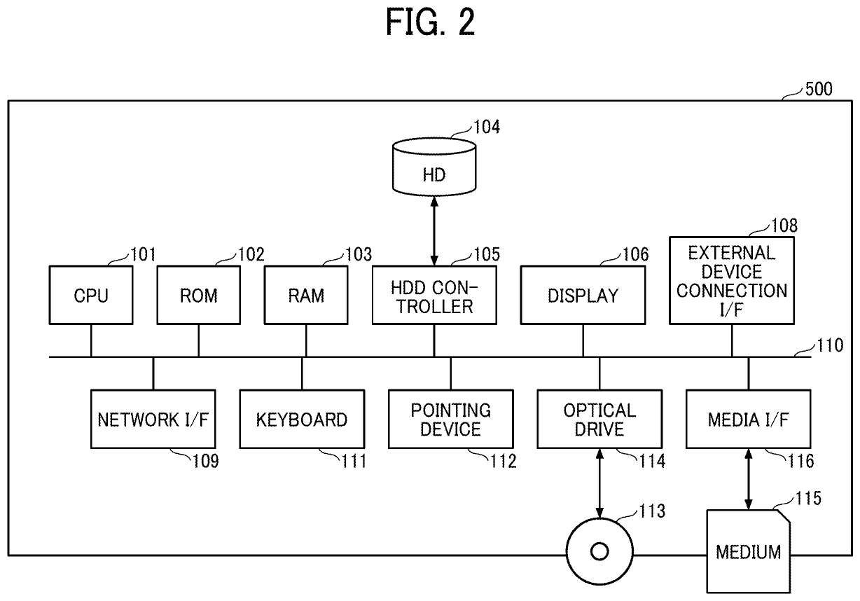

FIG. 2 is a diagram illustrating an example hardware configuration of the server apparatus 30 and the terminal apparatus 10 according to an embodiment of the present disclosure. As illustrated in FIG. 2, the server apparatus 30 and the terminal apparatus 10 are implemented by a computer 500. The computer 500 includes a central processing unit (CPU) 101, a read-only memory (ROM) 102, a random-access memory (RAM) 103, a hard disk (HD) 104, a hard disk drive (HDD) controller 105, a display 106, an external device connection interface (I/F) 108, a network I/F 109, a bus line 110, a keyboard 111, a pointing device 112, an optical drive 114, and a media I/F 116.

The CPU 101 controls the overall operation of the computer 500. The ROM 102 stores a program used for booting the CPU 101, such as an initial program loader (IPL). The RAM 103 is used as a work area for the CPU 101. The HD 104 stores various data such as a program. The HDD controller 105 controls reading and writing of various data from and to the HD 104 under the control of the CPU 101. The display 106 displays various types of information, such as a cursor, a menu, a window, text, or an image. The external device connection I/F 108 is an interface for connecting to various external devices. Examples of the external devices include, but are not limited to, a universal serial bus (USB) memory and a printer. The network I/F 109 is an interface for performing data communication using a communication network. The bus line 110 is, for example, an address bus or a data bus that electrically connects the components illustrated in FIG. 2, such as the CPU 101, to one another.

The keyboard 111 is an example of an input device provided with a plurality of keys for allowing a user to input characters, numerals, various instructions, and the like. The pointing device 112 is an example of an input device that allows selection or execution of various instructions, selection of a processing target, and movement of a cursor. The optical drive 114 controls reading and writing of various data from and to a removable optical storage medium 113. Examples of the optical storage medium 113 include, but are not limited to, a compact disc (CD), a digital versatile disc (DVD), and a Blu-ray® disc. The media I/F 116 controls reading and writing of data from and to a recording medium 115 such as flash memory.

### Functions

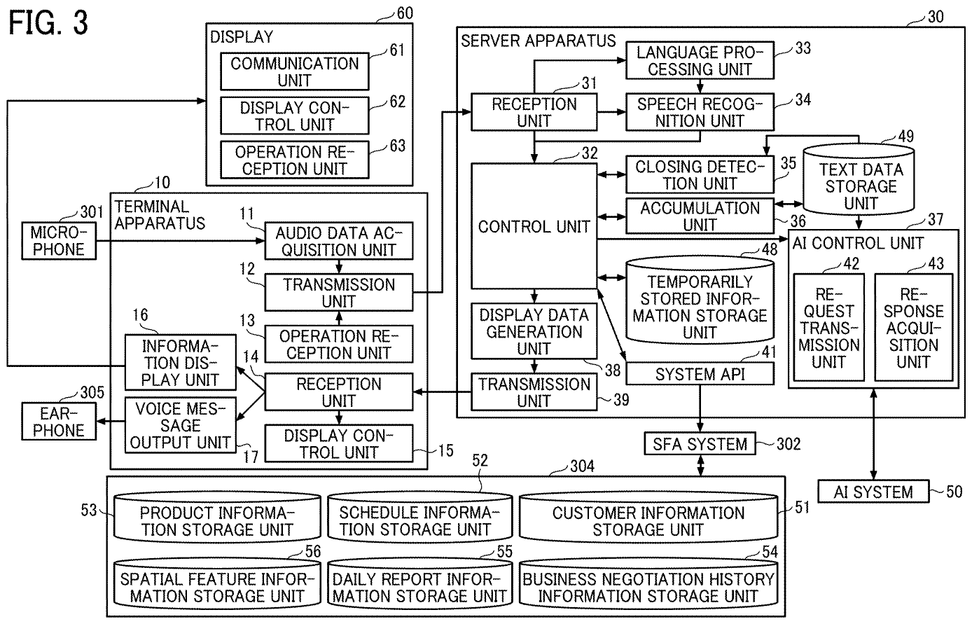

FIG. 3 is a diagram illustrating an example functional configuration of the information processing system 1 according to the present embodiment.

### Terminal Apparatus 10

The terminal apparatus 10 includes an audio data acquisition unit 11, a transmission unit 12, an operation reception unit 13, a reception unit 14, a display control unit 15, an information display unit 16, and a voice message output unit 17. Each unit is implemented by processing executed by the CPU 101 of the terminal apparatus 10 in accordance with a program installed in the terminal apparatus 10.

The audio data acquisition unit 11 acquires audio data from the microphone 301. The audio data acquisition unit 11 performs analog-to-digital (A/D) conversion on analog audio data to obtain digital audio data. The audio data includes the voices of the customer 8 and the sales representative 9 within the space 360 (see FIG. 1). The A/D conversion may be performed by the microphone 301.

The transmission unit 12 transmits audio data to the server apparatus 30 in real time or transmits audio data accumulated for each predetermined time period. The transmission unit 12 is an example of a second transmission unit. The transmission unit 12 also transmits operation information of the sales representative 9 to the server apparatus 30.

The operation reception unit 13 receives an operation performed by the sales representative 9 on the terminal apparatus 10 (i.e., an application).

The reception unit 14 receives output information from the server apparatus 30. The reception unit 14 is an example of a second reception unit. The output information is generated by the server apparatus 30 in response to an output information request transmitted to the server apparatus 30 together with the audio data, by analyzing the audio data. Transmission of the audio data and generation of the output information do not necessarily have a one-to-one correspondence.

The display control unit 15 controls the display 106 of the terminal apparatus 10 to display, for example, a screen generated by the application. The display control unit 15 causes the screen to be displayed based on display data for the terminal apparatus 10 received from the server apparatus 30.

The information display unit 16 causes the display 60 to display a screen based on display data for the display 60 received from the server apparatus 30. When the output information includes a voice message for the speakers 306, the information display unit 16 outputs the voice message to the speakers 306. When the display 60 is an information processing apparatus rather than a simple monitor, the display 60 performs display processing.

The voice message output unit 17 outputs, to the earphone 305, a voice message included in output information for the earphone 305 received from the server apparatus 30.

A program executed by the terminal apparatus 10 may be a native application or a Web application. The Web application is an application in which a program on a Web server and a program on a Web browser cooperate to perform processing, and is an application that functions without being installed on the terminal apparatus 10. The Web application is downloaded from the server apparatus 30. The native application is an application installed in and used on the terminal apparatus 10.

### Server Apparatus 30

In FIG. 3, the server apparatus 30 includes several functional units and several storage units. FIG. 3 illustrates functions used for generating output information, and functions other than those illustrated in FIG. 3 may be included in the server apparatus 30. Some connections between functional units are omitted, and information may be exchanged between functional units that are not connected.

The server apparatus 30 includes, as functional units, a reception unit 31, a control unit 32, a language processing unit 33, a speech recognition unit 34, a closing detection unit 35, an accumulation unit 36, an AI control unit 37, a display data generation unit 38, a transmission unit 39, and a system application programming interface (API) 41. The server apparatus 30 further includes a temporarily stored information storage unit 48 and a text data storage unit 49. The server apparatus 30 uses information stored in the various storage units 304 via the SFA system 302. In FIG. 3, the CRM system 303 is omitted for simplicity.

Each of the functional units of the server apparatus 30 is implemented by the CPU 101 executing one or more programs installed in the server apparatus 30. The temporarily stored information storage unit 48, the text data storage unit 49, and the various storage units 304 are implementable by using, for example, the HD 104 or a storage device connectable to the server apparatus 30 via a network.

The reception unit 31 receives audio data captured within the space. The reception unit 31 is an example of a first reception unit. The reception unit 31 also receives operation information input by the sales representative 9 to the terminal apparatus 10. More specifically, input by the sales representative 9 is performed on the terminal apparatus 10. Thus, the reception unit 31 receives, from the terminal apparatus 10, audio data and operation information received by the terminal apparatus 10. The reception unit 31 outputs the audio data to the language processing unit 33 and the speech recognition unit 34, and outputs the operation information to the control unit 32.

The language processing unit 33 uses existing speaker diarization to identify a speaker by using an estimation result of “when and who spoke” from the audio data. The speaker diarization includes, for example, the following methods. The language processing unit 33 extracts mel-frequency cepstral coefficients (MFCCs) from the audio data. The MFCCs, which are vectors, are input to a pretrained deep neural network (DNN), and speaker features (x-vectors) are output accordingly. The speaker features (x-vectors) are feature vectors of a speaker. The language processing unit 33 clusters speakers by a clustering method such as k-means, an expectation-maximization (EM) algorithm, or spectral clustering. This method distinguishes speakers, but has difficulty in identifying an individual speaker. One method for identifying an individual speaker is that, for example, the AI system 50 determines whether the speaker is a sales representative or a customer, based on the conversation.

For example, a person stating “How about XX?” is a sales representative, and a person stating “The budget is about XX” is a customer. When the space 360 is a conference room, identifying an individual speaker is of low priority; however, a person who issues an instruction such as “Please do XX” can be identified as a facilitator or a supervisor.

For example, when the terminal apparatus 10 authenticates a customer and a sales representative by an existing method when the customer and the sales representative use a space, and requests some utterance at that time, the speaker features (x-vectors) and speaker labels (e.g., person A as Mr. Sato and person B as Mr. Suzuki) can be linked with each other.

When the microphone 301 has directivity, the language processing unit 33 distinguishes speakers by a direction in which audio data is acquired. That is, the microphone 301 transmits the audio data along with the direction in which the audio data is acquired to the terminal apparatus 10. This method also distinguishes speakers, but has difficulty in identifying an individual speaker; however, for example, when a direction in which a customer sits and a direction in which a sales representative sits are fixed, it is possible to identify an individual speaker. The terminal apparatus 10 may include the language processing unit 33. In that case, the transmission unit 12 of the terminal apparatus 10 transmits, instead of the audio data, a result of processing performed by the language processing unit 33 to the server apparatus 30.

The speech recognition unit 34 executes speech recognition processing to perform speech recognition on the audio data. For example, the speech recognition unit 34 converts uttered speech of a customer and uttered speech of a sales representative into text data by speech recognition processing. Further, the speech recognition unit 34 acquires speaker information from the language processing unit 33 and associates a speaker indicated by the speaker information with the text data. Thus, the speech recognition unit 34 assigns information such as “person A” and “person B” to the text data. In other words, the speech recognition unit 34 assigns speaker labels to the text data. Further, the speech recognition unit 34 associates the text data with an absolute time or an elapsed time from the start of the business negotiation. The terminal apparatus 10 may include the speech recognition unit 34. In that case, the transmission unit 12 of the terminal apparatus 10 transmits, instead of the audio data, a result of processing performed by the speech recognition unit 34 to the server apparatus 30.

The control unit 32 performs overall control related to generation of output information. The control unit 32 acquires, from the speech recognition unit 34, text data with which the speaker and the utterance time are associated. The control unit 32 controls the display data generation unit 38 to generate output information by using an analysis result of the text data by the AI system 50. In the present embodiment, the output information indicates, for example, display of information or generation of display data. The output information may be audio output of information from a speaker or an earphone.

The control unit 32 determines the situation, based on an analysis result of text data by the AI system 50 and operation information, and performs the following processing:
opening processing;
proposal processing for a customer;
anticipatory need-based proposal processing for a customer;
closing processing;
customer information registration processing; and
registration of data such as a daily report and a business negotiation history.

In some cases, the control unit 32 acquires, from the reception unit 31, operation information received by the terminal apparatus 10. The operation information may represent an operation performed on an application or may be an input message.

When the operation information represents an operation performed on an application, the control unit 32 executes processing corresponding to the operation. When the operation information is an input message, the control unit 32 may process the input message similarly to the text data.

In response to receiving the text data, the control unit 32 transmits the text data to the accumulation unit 36. The accumulation unit 36 stores the text data in the text data storage unit 49 in chronological order. Thus, as the conversation performed in the space progresses, the amount of accumulated text data increases. When text data is accumulated in a predetermined amount or for a predetermined duration, the accumulation unit 36 may create a summary.

The accumulated text data is also used for registration of customer information. Thus, the control unit 32 can automatically register attributes of a customer based on the content of a conversation. The customer information can include, for example, a name, an age, a gender, a nationality, a place of residence, an occupation, an income, a family structure, an educational background, a purchase history, and a website visit history, and a large amount of information can be obtained based on the content of the conversation.

The closing detection unit 35 detects that the business negotiation is approaching its end, based on the text data in the text data storage unit 49. The closing detection unit 35 notifies the control unit 32 that closing has started. The control unit 32 requests the display data generation unit 38 to display a closing screen including information stored in the temporarily stored information storage unit 48. The closing of the business negotiation may be detected by the AI system 50 under the control of the control unit 32. Such detection may be performed by the control unit 32 or the closing detection unit 35 based on an end time in schedule information and the current time.

The AI control unit 37 is an interface with the AI system 50. The AI control unit 37 generates prompts by inserting accumulated text data into system prompts to cause the AI system 50 to extract requests, to cause the AI system 50 to provide an optimal proposal for requests, to cause the AI system 50 to provide a predicted proposal for requests, to cause the AI system 50 to extract decisions, to cause the AI system 50 to extract an action list, to cause the AI system 50 to extract customer information, and to cause the AI system 50 to detect closing. Details of the optimal proposal and the predicted proposal will be described below. Any text data is associated with a speaker and an utterance time. The AI control unit 37 acquires a response message generated by the AI system 50. The response message includes information generated for a request.

For these processes, the AI control unit 37 includes a request transmission unit 42 that generates a prompt and transmits a request to the AI system 50, and a response acquisition unit 43 that acquires a response message generated by the AI system 50.

Details of the prompt will be described with reference to sequence diagrams. A simple example of a system prompt is as follows.
<Example of system prompt>
Please create { . . . } using the following information.
{Accumulated text data}
{Data in the various storage units 304}
{Table item names}
<End of example of system prompt>

Thus, the system prompt defines a section where a specific request is inserted, a section where text data is inserted, and data stored in the various storage units 304. In this case, the request transmission unit 42 of the AI control unit 37 generates a prompt by describing a specific request in { . . . } of the system prompt and inserting text data accumulated by the accumulation unit 36 into the {Accumulated text data} section. In {Data in the various storage units 304}, for example, customer information, product information, or schedule information is set as appropriate. In {Table item names}, item names of each table are set. In { . . . }, an appropriate message corresponding to a request such as a proposal may be set in advance. In response to the prompt generated by the request transmission unit 42 being input to the AI system 50, the AI system 50 generates response messages, such as requests, an optimal proposal, a predicted proposal, decisions, an action list, customer information, and closing detection, from the accumulated text data.

When a control procedure includes a plurality of phases, a system prompt may be defined in which a section for inserting an intermediate response obtained in the preceding phase (e.g., an intermediate response obtained in any phase from the first phase to the (K−1)-th phase with respect to the K-th phase) is explicitly specified for a given phase.

The control unit 32 stores the requests, the optimal proposal, the predicted proposal, the decisions, and the action list, which are acquired by the AI control unit 37 from the AI system 50, in the temporarily stored information storage unit 48. The temporarily stored information storage unit 48 is used to display a closing screen or review a business negotiation.

The control unit 32 also transmits the customer information, which is extracted by the AI system 50 from the text data, to the SFA system 302. The SFA system 302 registers the customer information in the CRM system 303.

The control unit 32 passes the response message acquired from the AI control unit 37 to the display data generation unit 38, together with an instruction of a display destination indicating whether the response message is to be displayed on the terminal apparatus 10 or the display 60. The control unit 32 also passes the response message acquired from the AI control unit 37 to the display data generation unit 38, designating the earphone 305 as the output destination. The information described above to be transmitted from the server apparatus 30 to the terminal apparatus 10 may be collectively referred to as “output information”.

The system API 41 is an interface with the SFA system 302 for requesting information from the SFA system 302 and acquiring information from the SFA system 302 by calling an API published by the SFA system 302. When the server apparatus 30 includes the various storage units 304 managed by the SFA system 302, or when the various storage units 304 reside on a network with which the server apparatus 30 is directly communicable, the system API 41 may be omitted.

When the output information is display data, the display data generation unit 38 generates display data for each display destination. If the display destinations differ, content may differ; however, a generation method may be the same. The display data for the Web application is, for example, HyperText Markup Language (HTML), Cascading Style Sheets (CSS), JavaScript®, JavaScript Object Notation (JSON), or Extensible Markup Language (XML). The display data for the native application is, for example, JSON or XML.

When the output information is a voice message, the display data generation unit 38 may convert the voice message into audio data in a format such as WAV or MP3. This conversion may be performed by the terminal apparatus 10.

The transmission unit 39 transmits the output information to the terminal apparatus 10. The transmission unit 39 is an example of a first transmission unit. The output information includes, for example, a proposal generated by the AI system 50 for a customer in accordance with the content of a conversation. The output information includes, for example, a voice message generated by the AI system 50 for a sales representative in accordance with the content of the conversation. The information display unit 16 and the display control unit 15 of the terminal apparatus 10 display the proposal at a timing appropriate for the content of the conversation. When the output information is a voice message, the voice message output unit 17 of the terminal apparatus 10 outputs an instruction or a warning to a sales representative through the earphone 305 at a timing appropriate for the content of the conversation.

### Text Data Storage Unit 49

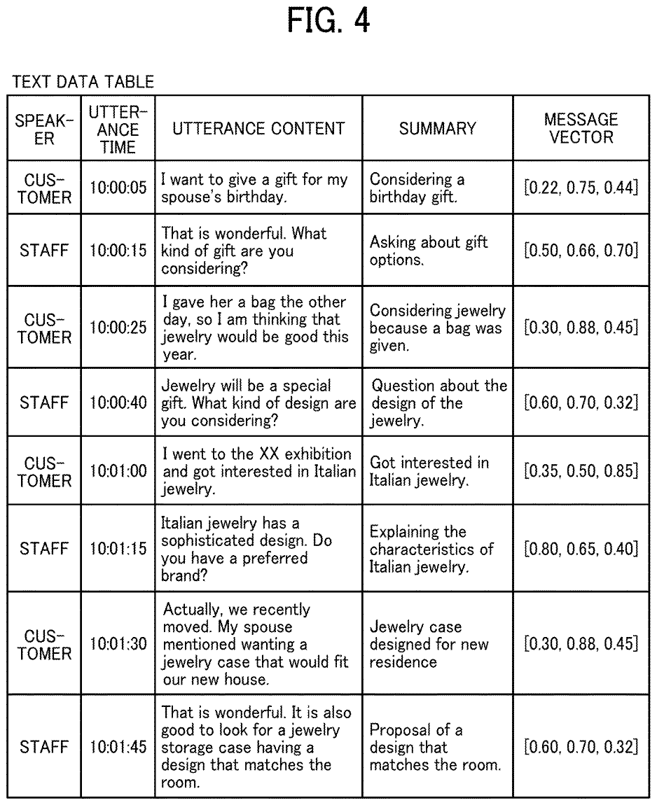

The various storage units 304 included in or referred to by the server apparatus 30 will be described with reference to, for example, FIG. 4. FIG. 4 is a diagram illustrating an example of a text data table stored in the text data storage unit 49. The text data storage unit 49 stores text data and a summary of a business negotiation performed in the space. The number of records in the text data storage unit 49 increases as the business negotiation progresses. The text data table illustrated in FIG. 4 is generated based on a business negotiation at a department store.

The text data storage unit 49 stores a speaker, an utterance time, utterance content, a summary, and a message vector.

The “speaker” field represents speakers identified by the language processing unit 33. In FIG. 4, specific individuals are identified as speakers. Speakers may be distinguished using generic names such as speaker 1 or speaker 2.

The “utterance time” field represents a time at which the customer or the sales representative made each utterance. The utterance time may be Japan time or may be an elapsed time from the start of the business negotiation.

The “utterance content” field represents text data converted from audio data of the customer and the sales representative.

The “summary” field represents short overviews of the argument and key points of utterance content, summarized by the AI system 50. In FIG. 4, a summary is created for each sentence. The granularity of text data from which the summary is created may be adjusted as appropriate. The utterance content may be divided into a predetermined length to generate chunks. Thus, even a long original utterance can be handled.

The “message vector” field represents a semantic vector obtained by converting each utterance content or summary into a distributed representation.

The distributed representation represents text data in the form of a fixed-length vector. The conversion into the distributed representation is performed by an existing embedding model. While Bidirectional Encoder Representations from Transformers (BERT®), Document to Vector (Doc2Vec), and the like are known as examples of embedding models, any method may be employed to convert the input message into a distributed representation.

When the control unit 32 passes a message vector to the system API 41 and causes the system API 41 to search for specific product information from a product information table, product information related to the conversation is acquired. Thus, even if the product information table is enormous, the size of product information to be transmitted to the AI system 50 can be reduced. In this case, in the SFA system 302, the product information table is divided into chunks in advance, and chunk vectors are registered. The SFA system 302 calculates similarity between a message vector generated from real-time text data and a chunk vector stored in the various storage units 304, and identifies a chunk, such as product information, corresponding to a chunk vector having similarity greater than or equal to a predetermined value.

What the sales representative desires to propose is a proposal of a product or the like that can be inferred to have a high probability of being purchased because the product or the like is related to the customer's utterance. Thus, transmission of product information related to the customer's utterance to the AI system 50 is expected to enhance the accuracy of products proposed by the AI system 50. Thus, RAG allows the AI to be provided with related product information obtained as a result of search and to propose products from among the search results.

The customer's utterance is as follows.
“I want to give a gift for my spouse's birthday.
I gave her a bag the other day, so I am thinking that jewelry would be good this year.
I went to the XX exhibition and got interested in Italian jewelry.
Actually, we recently moved. My spouse mentioned wanting a jewelry case that would fit our new house”.

### Temporarily Stored Information Storage Unit 48

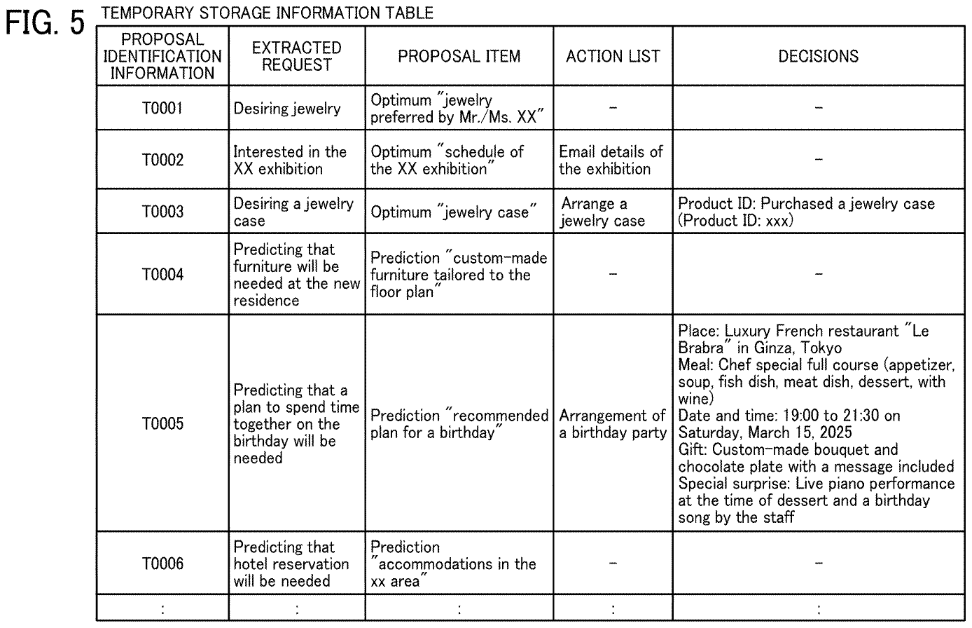

FIG. 5 is a diagram illustrating an example of a temporarily stored information table registered in the temporarily stored information storage unit 48. The temporarily stored information table stores customer requests, which are special notes extracted from a conversation of a business negotiation. The temporarily stored information table is used to review the business negotiation. Sharing the temporarily stored information between the sales representative and the customer at the closing of the business negotiation facilitates a review of the business negotiation without omission.

The “proposal identification information” field represents identification information of proposals displayed on the display 60 and proposed by the server apparatus 30 to the customer.

The “extracted request” field represents summaries of customer requests extracted by the AI system 50 from conversation content.

The “proposal item” field represents optimal proposals or predicted proposals proposed by the AI system 50 for the items in the “extracted request” field.

The “action list” field represents action lists extracted by the AI system 50 from conversation content or action lists entered by the sales representative. The AI system 50 recognizes audio data of an utterance made by a customer, such as “Could you e-mail details of the exhibition?”, and extracts a follow-up task for the extracted request “interested in the exhibition” as an action list item associated with the request.

The “decisions” field represents decisions extracted by the AI system 50 from conversation content. In the example illustrated in FIG. 5, the AI system 50 extracts items agreed upon or decided by the customer in the conversation, such as a product, a location, a meal, a date and time, and a gift, and associates the extracted items with the request. For example, the sales representative stated, “We will go ahead and finalize the reservations and other details based on this plan. Would that be acceptable to you?”, and the customer stated, “Yes, please do. Thank you”. The AI system 50 determines such a conversation to be a decision regarding the plan, and extracts the plan as the decision. A purchased product is also recorded as a decision. For example, the customer stated, “I will buy a jewelry case of XXX,” and the sales representative stated, “Thank you”. The AI system 50 determines such a conversation to be a decision regarding the purchase. Then, the AI system 50 extracts identification information of the product and a purchased quantity as the decision.

### Customer Information Storage Unit 51

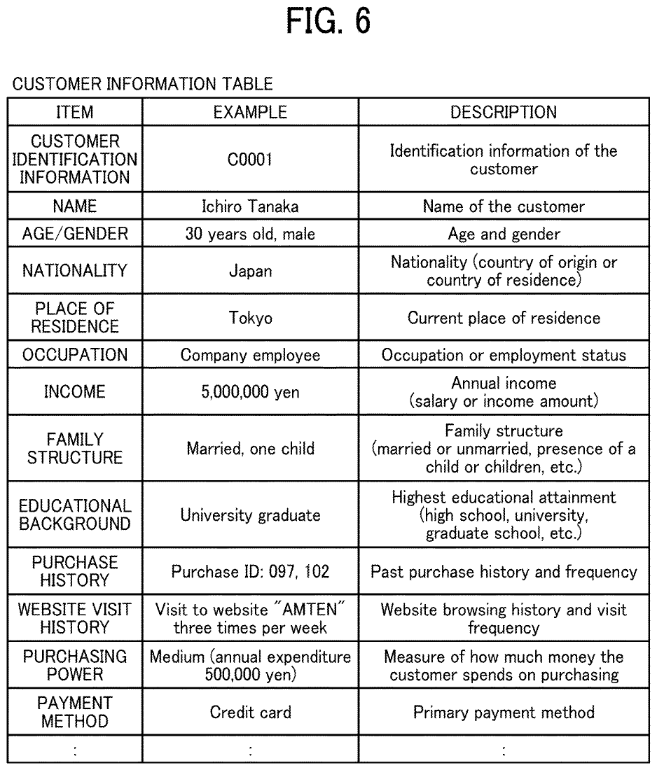

FIG. 6 is a diagram illustrating an example of a customer information table registered in a customer information storage unit 51. The customer information storage unit 51 is included in the various storage units 304. The customer information table illustrated in FIG. 6 is an example, and may include other items of customer information. In FIG. 6, all items are registered. Which items of customer information are extracted can vary depending on the content of a conversation and an instruction or a prompt to the AI system 50.

The “customer identification information” item represents identification information that uniquely identifies each customer.

The “name” item represents the name of the customer.

The “age/gender” item represents the age (or age group) and gender of the customer.

The “nationality” item represents the country of origin or country of residence of the customer.

The “place of residence” item represents, for example, the current address of the customer.

The “occupation” item represents professional information, such as the occupation or employment status of the customer.

The “income” item represents the approximate annual income of the customer, including salary and supplemental income.

The “family structure” item represents, for example, marital status (married or unmarried), parental status (presence of a child or children), and household composition, such as living with relatives or apart from a spouse.

The “educational background” item represents, for example, the highest educational attainment of the customer (high school, university, or graduate school), school names, and certifications.

The “purchase history” item represents, for example, products and services purchased by the customer in the past at the company or other companies.

The “website visit history” item represents e-commerce (EC) sites, information sites, and other websites that the customer frequently uses.

The “purchasing power” item represents the approximate amount of money that the customer can use for purchasing products and services.

The “payment method” item represents a primary payment method, including cash, credit cards, and bank transfers.

### Schedule Information Storage Unit 52

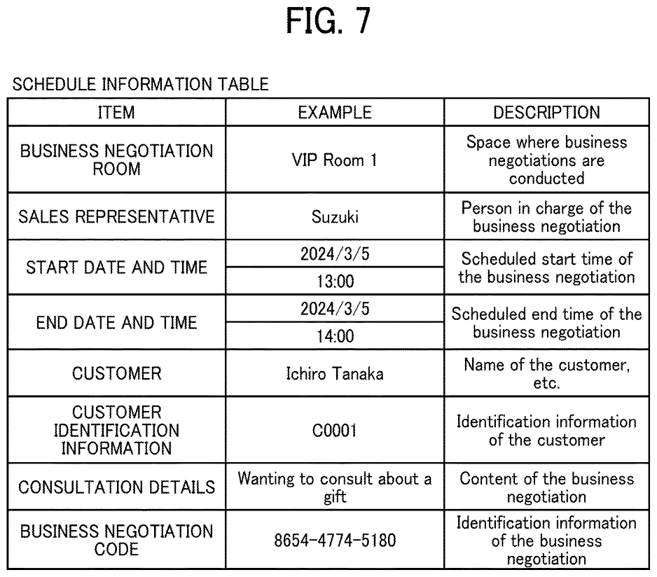

FIG. 7 is a diagram illustrating an example of schedule information registered in a schedule information storage unit 52. The schedule information storage unit 52 is included in the various storage units 304. The schedule information storage unit 52 stores, for example, a business negotiation schedule that is input at the time of reservation of a business negotiation room. The schedule information may be entered on a business negotiation space settings screen 210 described below.

The “business negotiation room” item represents the name of a room or a space where each business negotiation is performed.

The “sales representative” item represents the name of a sales representative in charge of the business negotiation.

The “start date and time” item represents a scheduled date and time at which the business negotiation is to start.

The “end date and time” item represents a scheduled date and time at which the business negotiation is to end.

The “customer” item represents the name of a customer or a counterparty company involved in the business negotiation.

The “customer identification information” item represents identification information that identifies the customer.

The “consultation details” item represents the agenda or detailed content of the business negotiation. A field specifying the purpose of the conversation (e.g., business negotiation, consultation, or meeting) may further be included.

The “business negotiation code” item represents unique identification information assigned to each business negotiation.

### Product Information Storage Unit 53

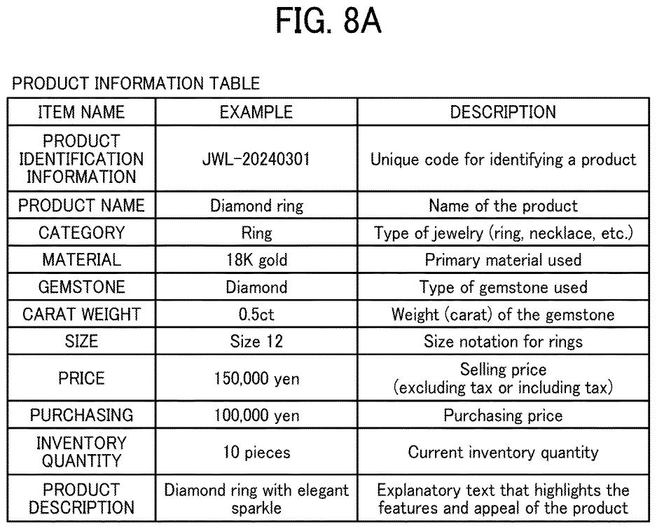

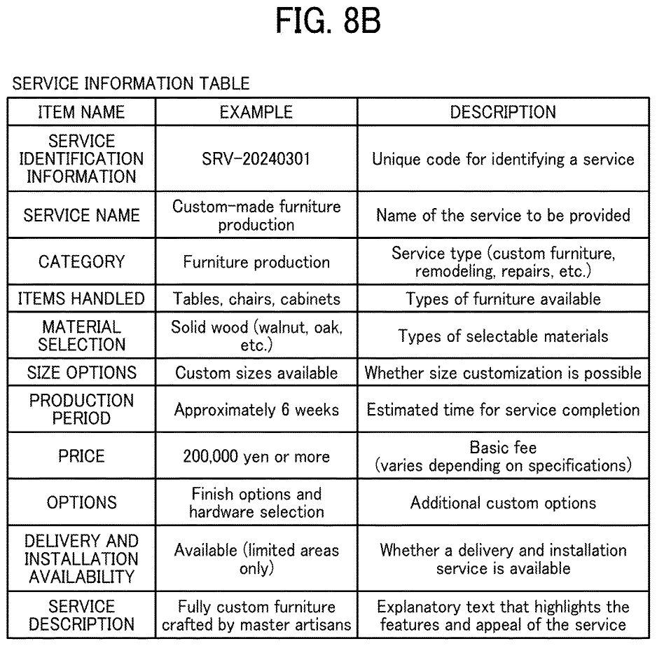

FIG. 8A is a diagram illustrating an example of product information registered in a product information storage unit 53. The product information storage unit 53 is included in the various storage units 304. FIG. 8A illustrates an example in a case where a product is jewelry.

The “product identification information” item represents unique identification information that identifies each product.

The “product name” item represents a general name of the product, such as a brand name or a name of the product.

The “category” item represents a type of jewelry, such as a ring or a necklace.

The “material” item represents a primary material used.

The “gemstone” item represents a type of a gemstone used.

The “carat weight” item represents, for example, the weight, or carat, or grade of a gemstone.

The “size” item represents the dimensions of the jewelry, representing the ring size for rings and the length for necklaces.

The “price” item represents the store price of the product.

The “purchasing” item represents the purchase price of the product.

The “inventory quantity” item represents the current inventory quantity of the product.

The “product description” item represents explanatory text that highlights the features and appeal of the product.

As illustrated in FIG. 8B, the server apparatus 30 stores service information as well as product information. A service is an example of a product. As illustrated in FIG. 8B, service information may be stored distinctly from tangible products. FIG. 8B is a diagram illustrating an example of service information registered in the product information storage unit 53. The server apparatus 30 may propose services similarly to products. The product information storage unit 53 stores information for each product and for each service as illustrated in FIG. 8A and FIG. 8B, respectively, and stores a plurality of products and services. In the present example, services and products are not distinguished, and are collectively described as products in the following description.

### Business Negotiation History Information Storage Unit 54

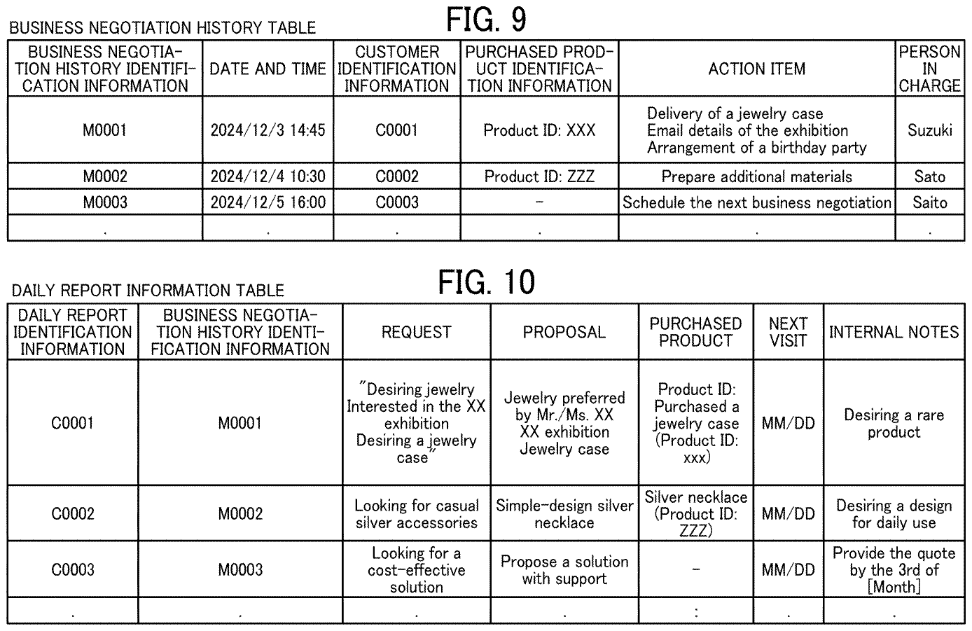

FIG. 9 is a diagram illustrating an example of a business negotiation history table registered in a business negotiation history information storage unit 54. The business negotiation history table stores past business negotiation histories.

The “business negotiation history identification information” field represents a unique identification number assigned for each business negotiation, and is used to manage past business negotiations. The business negotiation history identification information may correspond to a business negotiation code in the schedule information.

The “date and time” field represents a date and time at which each business negotiation was performed, and is used for follow-up.

The “customer identification information” field represents identification information that identifies each customer, and is used to manage past purchase history and correspondence history.

The “purchased product identification information” field represents identification information of a product purchased by each customer or a product in which the customer has interest, and is used to manage inventory or refer to proposal history.

The “action item” field represents a specific action to be taken by a sales representative after each business negotiation.

The “person in charge” field represents the name or identification information of a sales representative in charge of each business negotiation, and is used to clarify responsibility and enhance follow-up efficiency.

As will be described below, the server apparatus 30 automatically generates a business negotiation history from text data of a conversation.

### Daily Report Information Storage Unit 55

FIG. 10 is a diagram illustrating an example of a daily report information table registered in a daily report information storage unit 55. The daily report information table stores daily reports of a sales representative who performed customer service.

The “daily report identification information” field represents identification information that uniquely identifies each daily report.

The “business negotiation history identification information” field is the same as the “business negotiation history identification information” field of the business negotiation history table, and is used to link a daily report with each business negotiation.

The “request” field represents records of customer inquiries and consultations to help organize correspondence history and enhance service quality.

The “purchased product” field represents information on a product whose purchase was finalized during each business negotiation.

The “next visit” field represents an appointment for the next business negotiation.

The “internal notes” field represents notes used to record special remarks and precautions during service, intended for use in future correspondence and sales proposals. The “internal notes” field also contains handover information for the next correspondence.

As described below, a daily report is automatically generated by the server apparatus 30 based on text data of a conversation.

### Spatial Feature Information Storage Unit 56

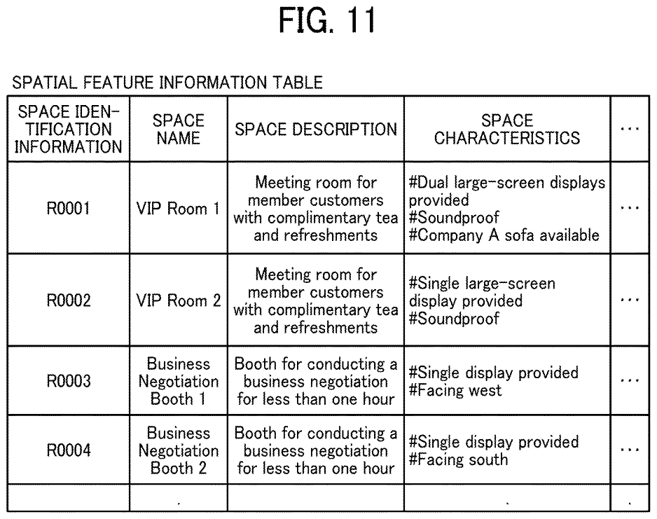

FIG. 11 is a diagram illustrating an example of a spatial feature information table registered in a spatial feature information storage unit 56. The spatial feature information table stores descriptions related to a space for performing a business negotiation. Spatial feature information provided by the spatial feature information table illustrated in FIG. 11 corresponds to “space information 3” described below. The spatial feature information is transmitted to the AI system 50, as described in detail below. The spatial feature information is transmitted to the AI system 50, thus allowing the AI system 50 to generate and respond with a proposal and a screen based on the spatial feature information.

The “space identification information” field represents identification information that uniquely identifies each space, and is used for reservation or management.

The “space name” field records the names of business negotiation areas, including room names and booth names.

The “space description” field describes the intended use of each space and a type of business negotiation for which the space is suitable.

The “space characteristics” field describes the characteristics of each space, such as size, capacity, soundproofing, equipment (monitors, whiteboards, etc.), and furniture.

### Display 60

The functions of the display 60 will be described in a case where the display 60 is not a simple monitor, but rather an information processing terminal such as a PC, a tablet terminal, or an electronic whiteboard.

The display 60 includes a communication unit 61, a display control unit 62, and an operation reception unit 63. Each unit is implemented by processing executed by a CPU of the display 60 in accordance with a program installed in the display 60.

The communication unit 61 controls communication with the server apparatus 30 or the terminal apparatus 10.

The display control unit 62 controls display of a screen based on display data received from the server apparatus 30 or the terminal apparatus 10.

The operation reception unit 63 receives user operations on the display 60.

### Overall Flow

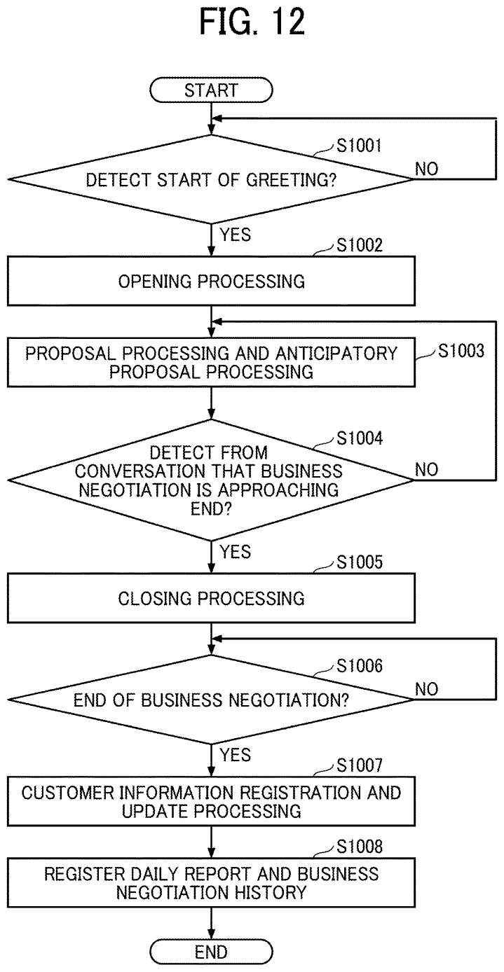

An overall flow of control performed by the control unit 32 will be described with reference to FIG. 12. FIG. 12 is a flowchart illustrating an example of a flow of control performed by the control unit 32 for a business negotiation. The process illustrated in FIG. 12 starts when, for example, a sales representative activates the terminal apparatus 10 and inputs an instruction to start operations through a predetermined application.

In step S1001, the control unit 32 determines whether the sales representative has started greeting a customer. Start of greeting is detected by analysis of audio data acquired by the microphone 301 or by an operation on the terminal apparatus 10 by the sales representative.

In response to detection of start of greeting (YES in step S1001), in step S1002, the control unit 32 performs opening processing. The opening processing is, for example, identifying the customer and displaying an opening screen on the display 60.

When the opening processing is completed, in step S1003, the control unit 32 performs proposal processing and anticipatory proposal processing. The transition from the end of the opening processing to the proposal processing and the anticipatory proposal processing is performed without awareness by the customer and the sales representative.

During the proposal processing and the anticipatory proposal processing, in step S1004, the control unit 32 determines, from the conversation, whether the business negotiation is approaching its end. The control unit 32 performs this determination in order to display a closing screen (e.g., a summary of the business negotiation) at an appropriate timing in the subsequent closing processing. The detection of the business negotiation approaching the end is based on, for example, the elapsed time and verbal signs in the conversation.

If it is detected that the business negotiation is approaching its end (YES in step S1004), in step S1005, the control unit 32 executes closing processing. The control unit 32 collectively displays, for example, requests received during the business negotiation, proposals from the sales representative, decisions, and an action list.

The closing processing allows the customer and the sales representative to review the business negotiation. Thereafter, the customer leaves the business negotiation room, and the sales representative sees the customer off. The sales representative operates the terminal apparatus 10 in response to the end of the business negotiation. In step S1006, the control unit 32 determines whether an operation of ending the business negotiation has been received.

If an operation of ending the business negotiation is not received (NO in step S1006), the operation returns to step S1003.

If an operation of ending the business negotiation is received (YES in step S1006), in step S1007, the control unit 32 executes customer information registration and update processing. The customer information registration and update processing is processing for automatically registering customer information based on text data obtained in the business negotiation and enhancing the customer information. The customer information registration and update processing may be performed during the business negotiation in parallel with the processing of steps S1001 to S1005.

If the operation of ending the business negotiation is received (YES in step S1006), after performing S1007, in step S1008, the control unit 32 executes processing for registering a daily report and a business negotiation history. The information processing system 1 assists the sales representative in creating the daily report and the business negotiation history. The operation of FIG. 12 then ends.

The processing operations performed by the control unit 32 described with reference to FIG. 12 are described in detail below.

### Opening Processing

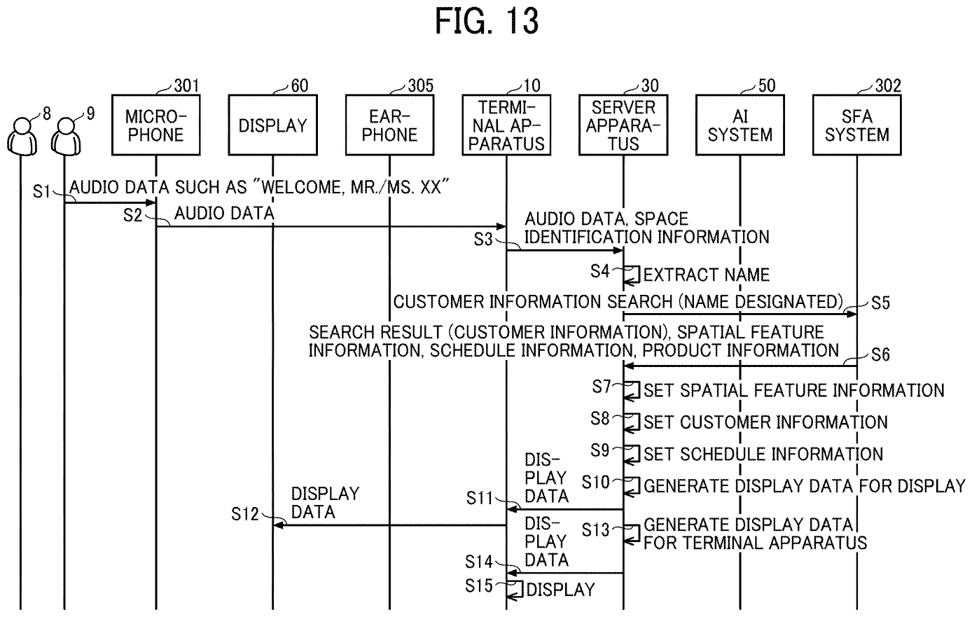

The opening processing performed when the sales representative 9 starts greeting the customer 8 will be described with reference to FIG. 13. The opening processing allows, for example, a welcome message to be displayed on the display 60 when the sales representative 9 starts greeting the customer 8. FIG. 13 is a sequence diagram illustrating the opening processing and operations when the customer 8 visits.

The sales representative 9 operates the terminal apparatus 10 to activate the information processing system 1, and the microphone 301 continuously captures audio. First, the server apparatus 30 performs processing for identifying the customer 8. This is because understanding customer information such as past purchase history and family structure is effective when the customer 8 is a repeat customer. Examples of methods for identifying a customer include a method in which a sales representative specifies a business negotiation from schedule information, a method in which a customer's name and other information are acquired from a conversation, and a method in which a sales representative directly inputs information on a customer. Preferably, the display 60 displays a message indicating welcome before the customer 8 enters the room. However, in a case where such a message is displayed after the customer 8 enters the room, it is desirable to display, for example, a message at a timing when the customer 8 is identified. FIG. 13 illustrates a case where the customer 8 is identified based on audio data.

After meeting the customer 8 at the business negotiation room, in step S1, the sales representative 9 starts a conversation such as a greeting. The microphone 301 acquires audio data of utterances made by the sales representative 9 and the customer 8. For example, the microphone 301 acquires audio data of an utterance made by the sales representative 9, such as “Welcome, Mr./Ms. XX”. In addition, the microphone 301 may acquire audio data of an utterance made by the customer 8, such as “I am XX. Thank you for having me today”.

In step S2, the microphone 301 transmits the audio data to the terminal apparatus 10 in real time.

In response to the audio data acquisition unit 11 of the terminal apparatus 10 acquiring the audio data, in step S3, the transmission unit 12 transmits the audio data and space identification information to the server apparatus 30 in real time. The space identification information indicates a space in which the business negotiation is performed, such as “VIP room 1”, and is used by the server apparatus 30 to identify, for example, equipment of the space. The space identification information is set in advance in the terminal apparatus 10 or is input by the sales representative 9.

In response to the reception unit 31 of the server apparatus 30 receiving the audio data and the space identification information, in step S4, the reception unit 31 first requests the speech recognition unit 34 to convert the audio data into text data. The speech recognition unit 34 converts the audio data into text data and passes the text data to the control unit 32. When the customer 8 is not yet identified, the control unit 32 causes the language processing unit 33 to perform morphological analysis. The language processing unit 33 extracts a name as a proper noun based on the text data.

Since the customer 8 is not yet identified, in step S5, the control unit 32 requests the system API 41 to perform customer information search using the designated name. The system API 41 requests the SFA system 302 to perform customer information search by designating the name. The system API 41 may also request, for example, product information, space information 1, space information 2, space information 3, and schedule information from the SFA system 302. Such information is used for subsequent processing.

In step S6, the SFA system 302 receives, from the CRM system 303, a search result of a customer searched by name. For example, customers having the same name can possibly be registered. Thus, the SFA system 302 may return, to the server apparatus 30, a list of all customers having the same name to avoid omission. When the audio data includes the name of the sales representative 9, customers having the same name as the sales representative 9 also match the search. Thus, the control unit 32 may acquire schedule information of the business negotiation room on the day from the SFA system 302 in advance and exclude the name of the sales representative 9 from the search. The control unit 32 acquires, from the SFA system 302, spatial feature information associated with the space identification information and schedule information in which a customer matching the name is registered. The control unit 32 also acquires product information from the SFA system 302. When the product information table to be referred to is large, narrowing down products based on past “purchase history” and “content” of customer information registered in the schedule information reduces the size of the product information.

In response to the server apparatus 30 acquiring the spatial feature information, in step S7, the control unit 32 stores the spatial feature information. Further, the display data generation unit 38 sets the spatial feature information on a business negotiation space settings screen described below.

In step S8, the control unit 32 stores the customer information. Further, the display data generation unit 38 sets the customer information on the business negotiation space settings screen.

In step S9, the control unit 32 stores the schedule information. The display data generation unit 38 sets the schedule information on the business negotiation space settings screen.

Since information to be used for a proposal has been acquired, in step S10, the control unit 32 causes the display data generation unit 38 to generate display data for the display 60 and display data for the terminal apparatus 10. First, the control unit 32 instructs the display data generation unit 38 to generate display data for the display 60 to display, for example, a welcome message. The display data generation unit 38 generates display data for the display 60. When the display 60 is equipped with the speakers 306, the display data generation unit 38 may generate voice message output information including music or audio.

In step S11, the transmission unit 39 of the server apparatus 30 transmits information on the display destination (i.e., the display 60) and the display data to the terminal apparatus 10.

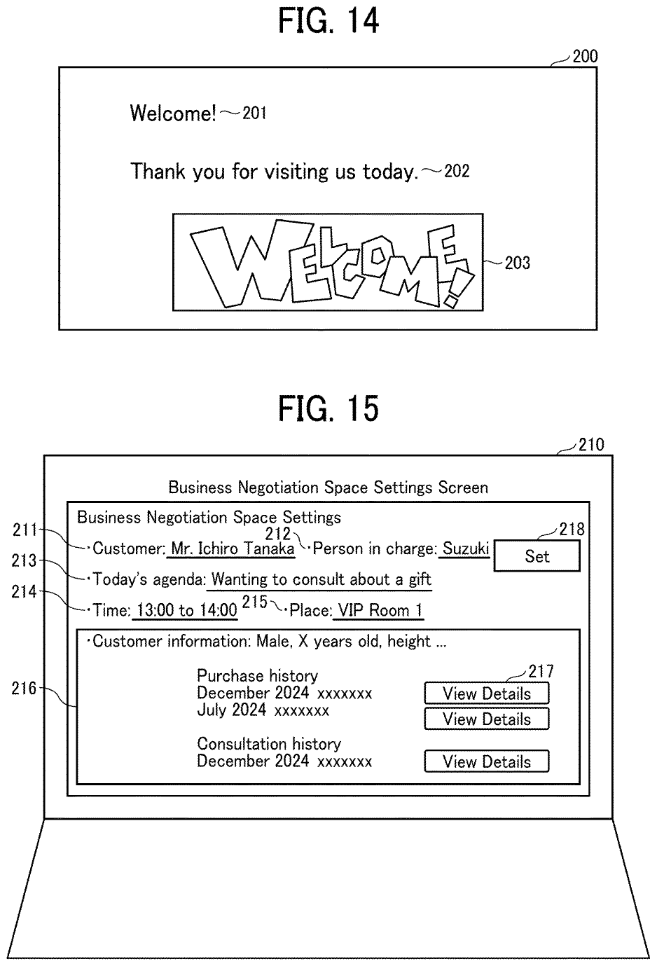

In step S12, the reception unit 14 of the terminal apparatus 10 receives the display data, and passes the display data to the information display unit 16 based on the information on the display destination (i.e., the display 60). The information display unit 16 transmits the display data to the display 60 so that the display 60 displays a welcome message screen (see FIG. 14) based on the display data.

In step S13, the control unit 32 causes the display data generation unit 38 to generate display data of a business negotiation space settings screen on which the spatial feature information, the customer information, and the schedule information are set, to display the business negotiation space settings screen on the terminal apparatus 10. The display data generation unit 38 generates the display data of the business negotiation space settings screen.

In FIG. 13, the terminal apparatus 10 and the display 60 display different screens. The display data generation unit 38 may generate the same display data for both the terminal apparatus 10 and the display 60, or may generate different display data for the terminal apparatus 10 and the display 60.

In a case where the same display data is generated:

An optimal proposal and a predicted proposal (confidential information described below is not displayed on the display 60)

Closing processing

In a case where different display data are generated:

Opening processing

A daily report screen (only the terminal apparatus 10)

In step S14, the transmission unit 39 of the server apparatus 30 transmits information on the display destination (i.e., the terminal apparatus 10) and the display data to the terminal apparatus 10.

In step S15, the reception unit 14 of the terminal apparatus 10 receives the display data, and passes the display data to the display control unit 15 based on the information on the display destination (i.e., the terminal apparatus 10). The display control unit 15 causes the terminal apparatus 10 to display the business negotiation space settings screen (see FIG. 15) based on the display data. The system API 41 may complete setting of the spatial feature information, the customer information, and the schedule information acquired in steps S7 to S9 and pass the spatial feature information, the customer information, and the schedule information to the control unit 32 without executing the processing of steps S13 to S15, that is, without displaying a business negotiation space settings screen 210 described below.

FIG. 14 illustrates an example of a welcome message screen 200 displayed on the display 60. As illustrated in FIG. 14, the welcome message screen 200 displays a customer name field 201 and a welcome message 202. The customer name 201 may be any of a customer name registered in the customer information, a name in the schedule information, and a name acquired from an utterance. By seeing their own name, the customer can confirm that the customer is in the correct room and feel reassured that the customer is welcomed. The welcome message screen 200 may display an illustration 203 and a video. The illustration 203 and the video may depict products or the like planned to be proposed in today's business negotiation based on the “consultation details” item of the schedule information.

FIG. 15 illustrates the business negotiation space settings screen 210 displayed on the terminal apparatus 10. Items contained in the business negotiation space settings screen 210 will be described.

A “customer” field 211 represents a customer name registered in the customer information.

A “person in charge” field 212 represents the name of a sales representative in charge of the business negotiation. The name is a sales representative name registered in the schedule information. The “customer” field 211 and the “person in charge” field 212 may be referred to as “space information 1”. The space information 1 is information indicating an event performed in the space. Specifically, the space information 1 indicates, for example, participants of the event and a type of the event, such as a business negotiation, a consultation, or a meeting. A field specifying the purpose of the conversation (e.g., business negotiation, consultation, or meeting) may further be provided together with the “customer” field 211 and the “person in charge” field 212.

A “today's agenda” field 213 represents consultation details of the business negotiation registered in the schedule information. The “today's agenda” field 213 may be referred to as “space information 2”. The space information 2 is information indicating the content or purpose of an event performed in the space. Specifically, the space information 2 indicates, for example, what is to be done in the space.

A “time” field 214 represents a start time and an end time of the business negotiation registered in the schedule information.

A “location” field 215 represents a business negotiation room name registered in the schedule information or a space name of a space identified by the space identification information. The “location” field 215 may be referred to as “space information 3”. The space information 3 is information indicating characteristics of the space. Specifically, the space information 3 indicates, for example, the type of the space, such as a VIP room for accommodating gold cardholders, and the size of the installed display in inches.

A “customer information” field 216 presents customer information. In the customer information, a purchase history list and a “View Details” button 217 are displayed. Pressing the “View Details” button 217 displays, for example, products purchased in the past, prices, dates, and sales representatives.

When a setting button 218 is pressed, information input on the business negotiation space settings screen 210 is transmitted to the server apparatus 30.

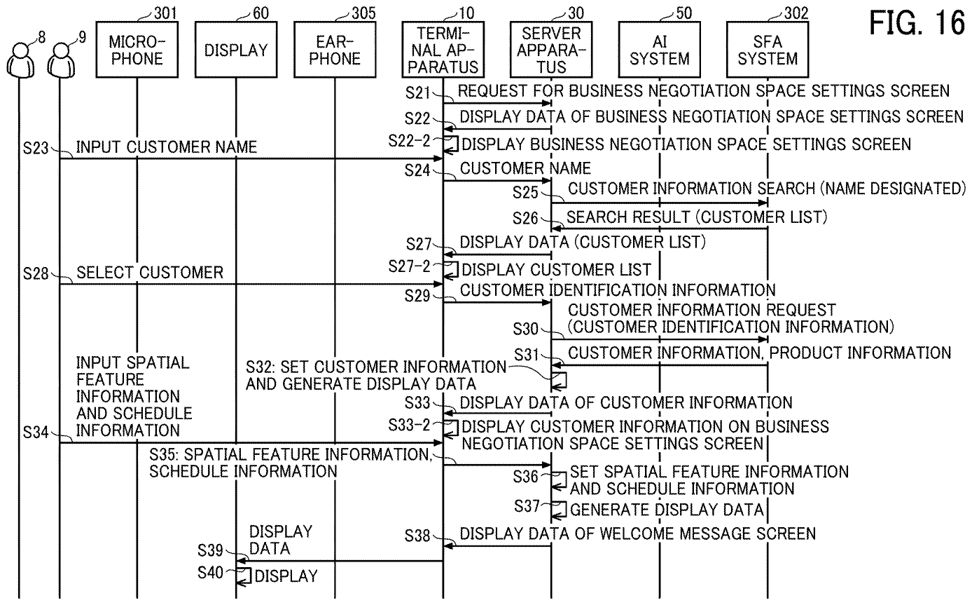

The AI system 50 generates a response message using, for example, the space information 1, the space information 2, and the space information 3. As a result, the accuracy of information to be proposed can be enhanced. As described with reference to FIG. 16, the space information 1, the space information 2, and the space information 3 may be input by a sales representative.

Space information 1: The AI system 50 understands the context of the use case of the space by using information indicating an event performed in the space.

Space information 2: The AI system 50 understands the context information of the event by using information indicating the content or purpose of the event performed in the space.

Space information 3: The AI system 50 generates output suitable for the space by using information indicating characteristics of the space. For example, the AI system 50 proposes high-end luxury products in a VIP room, or narrows down the number of products to be proposed when a small display is installed in the space, as the number of products that can be displayed is limited.

### Other Example of Opening Processing

Another example of the opening processing will be described with reference to FIG. 16. FIG. 16 is a sequence diagram illustrating the opening processing and operations when the customer 8 visits. FIG. 16 illustrates a case where the customer 8 is identified based on input from the sales representative 9. The server apparatus 30 performs processing for identifying the customer 8 based on the input space information 1, space information 2, and space information 3. This is because understanding customer information such as past purchase history and family structure is effective when the customer 8 is a repeat customer.

In step S21, the sales representative 9 operates the terminal apparatus 10 to activate the information processing system 1. In response to the operation by the sales representative 9, the transmission unit 12 of the terminal apparatus 10 requests the server apparatus 30 for a business negotiation space settings screen.

In step S22, the reception unit 31 of the server apparatus 30 receives the request, and the control unit 32 causes the display data generation unit 38 to generate display data of the business negotiation space settings screen. The business negotiation space settings screen is displayed only on the terminal apparatus 10. The display data generation unit 38 generates display data of the business negotiation space settings screen, and the transmission unit 39 transmits the display data of the business negotiation space settings screen to the terminal apparatus 10 together with information on the display destination (i.e., the terminal apparatus 10).

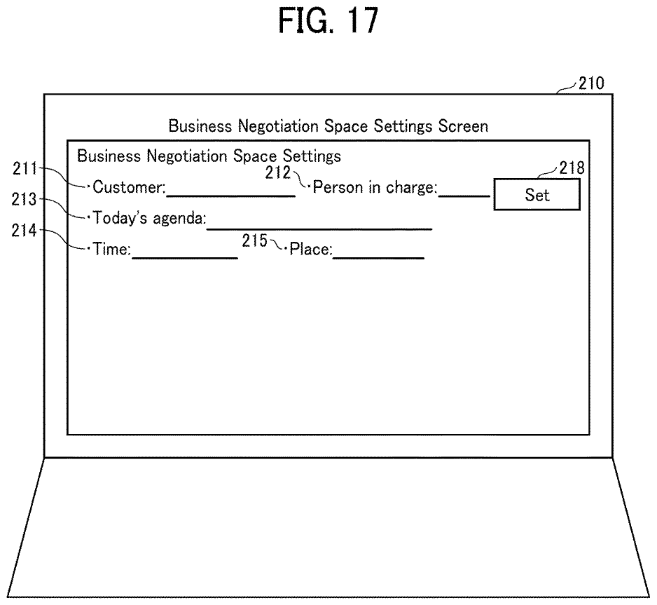

In step S22-2, the reception unit 14 of the terminal apparatus 10 receives the display data, and passes the display data to the display control unit 15 based on the information on the display destination (i.e., the terminal apparatus 10). The display control unit 15 causes the terminal apparatus 10 to display the business negotiation space settings screen based on the display data. At this point in time, a blank form screen (see FIG. 17) is displayed.

In step S23, the sales representative 9 inputs, to the business negotiation space settings screen, the name of a customer with whom the sales representative 9 is to perform a business negotiation. The sales representative 9 may input other items of the business negotiation space settings screen. The operation reception unit 13 receives the input.

In step S24, the transmission unit 12 of the terminal apparatus 10 transmits the input customer name to the server apparatus 30.

In step S25, the reception unit 31 of the server apparatus 30 receives the customer name as operation information, and then passes the name to the control unit 32. Since the customer 8 is not yet identified, the control unit 32 requests the system API 41 to perform customer information search using the designated name. The system API 41 requests the SFA system 302 to perform customer information search by designating the name.

In step S26, the SFA system 302 receives, from the CRM system 303, a search result of a customer searched by name. For example, customers having the same name can possibly be registered. Thus, the SFA system 302 may return, to the server apparatus 30, a list of all customers having the same name to avoid omission.

In response to the system API 41 of the server apparatus 30 acquiring a list of customers matching the search, in step S27, the control unit 32 determines to display the list on the terminal apparatus 10 for selection by the sales representative 9. The control unit 32 designates the terminal apparatus 10 as the display destination and causes the display data generation unit 38 to generate display data of the customer list. The customer list is displayed only on the terminal apparatus 10. The display data generation unit 38 generates display data of the customer list, and the transmission unit 39 transmits the display data of the customer list to the terminal apparatus 10 together with information on the display destination (i.e., the terminal apparatus 10). When the server apparatus 30 acquires schedule information in advance, the customer list (for example, the customer list similar to the customer list 221) can be displayed together with the schedule information.

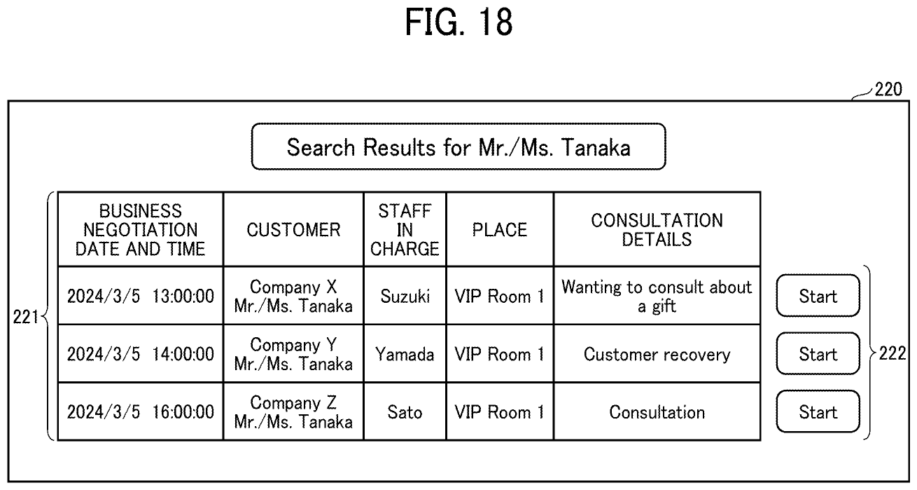

In step S27-2, the reception unit 14 of the terminal apparatus 10 receives the display data, and passes the display data to the display control unit 15 based on the information on the display destination (i.e., the terminal apparatus 10). The display control unit 15 causes the terminal apparatus 10 to display the customer list (see FIG. 18) based on the display data.

In step S28, the sales representative 9 selects, from the customer list, a customer with whom the sales representative 9 is to perform a business negotiation. The operation reception unit 13 receives the selection.

In step S29, the transmission unit 12 of the terminal apparatus 10 transmits selected customer identification information to the server apparatus 30.

In step S30, the reception unit 31 of the server apparatus 30 receives the customer identification information as operation information, and passes the customer identification information to the control unit 32. Since the customer 8 has been identified, the control unit 32 requests the system API 41 to perform customer information search using the designated customer identification information. The system API 41 requests the SFA system 302 to acquire customer information using the designated customer identification information. The system API 41 may also request, for example, product information, spatial feature information, and schedule information from the SFA system 302. Such information is used for, for example, optimal proposal processing and predicted proposal processing, as described below.

In step S31, the SFA system 302 receives, from the CRM system 303, customer information identified by the customer identification information. The SFA system 302 returns the customer information to the server apparatus 30. The control unit 32 may also acquire product information from the SFA system 302.

In response to the system API 41 acquiring the customer information, in step S32, the system API 41 passes the customer information to the control unit 32. In response to acquiring the customer information, the control unit 32 stores the customer information. The control unit 32 stores the product information.

The control unit 32 designates the terminal apparatus 10 as the display destination and causes the display data generation unit 38 to generate display data of the customer information. The display data generation unit 38 may generate display data of a business negotiation setting screen on which the customer information is set.

In step S33, the transmission unit 39 of the server apparatus 30 transmits information on the display destination (i.e., the terminal apparatus 10) and the display data to the terminal apparatus 10.

In step S33-2, the reception unit 14 of the terminal apparatus 10 receives the display data, and passes the display data to the display control unit 15 based on the information on the display destination (i.e., the terminal apparatus 10). The display control unit 15 causes the customer information to be displayed on the business negotiation space settings screen based on the display data.

In step S34, the sales representative 9 inputs, to the business negotiation space settings screen (see FIG. 15), spatial feature information and schedule information of a space in which a business negotiation is to be performed. The operation reception unit 13 receives the input. The schedule information may be automatically set by customer selection. The spatial feature information may also be automatically set by identifying schedule information or identifying space identification information set in the terminal apparatus 10.

In step S35, the transmission unit 12 of the terminal apparatus 10 transmits the input spatial feature information and schedule information to the server apparatus 30.

In step S36, the reception unit 31 of the server apparatus 30 receives the spatial feature information and the schedule information as operation information, and passes the spatial feature information and the schedule information to the control unit 32. The control unit 32 stores the spatial feature information and the schedule information.

Since the customer 8 has been identified, in step S37, the control unit 32 designates the display 60 as the display destination and causes the display data generation unit 38 to generate display data of a welcome message screen. The control unit 32 instructs the display data generation unit 38 to generate display data for the display 60 to display, for example, a welcome message. The display data generation unit 38 generates display data of a welcome message screen to be displayed on the display 60.

In step S38, the transmission unit 39 of the server apparatus 30 transmits information on the display destination (i.e., the display 60) and the display data to the terminal apparatus 10.

In steps S39 and S40, the reception unit 14 of the terminal apparatus 10 receives the display data, and passes the display data to the information display unit 16 based on the information on the display destination (i.e., the display 60). The information display unit 16 causes the display 60 to display the welcome message screen (see FIG. 14) based on the display data.

FIG. 17 illustrates the business negotiation space settings screen 210 displayed on the terminal apparatus 10 in step S22-2. The business negotiation space settings screen 210 illustrated in FIG. 17 is the same as that of FIG. 15, except that input fields on the business negotiation space settings screen 210 are not completed in step S22-2. The sales representative 9 inputs a customer name and other items through the business negotiation space settings screen 210.

FIG. 18 illustrates a customer list screen 220 displayed in step S27-2. A button is displayed near the “customer” field 211, which is an item on the business negotiation space settings screen 210, to display a popup for customer search. For example, when the sales representative enters the name “Tanaka” in the popup, the customer list screen 220 is displayed, and presents a customer list 221 containing customers matching the name “Tanaka”. The customer list 221 illustrated in FIG. 18 has schedule information integrated therein, and thus data registered in the schedule information, such as sales representatives, locations, and consultation details, are also displayed.

The sales representative verifies the associated business negotiation date and time, customer, location, and consultation details. Once a business negotiation that is scheduled in VIP room 1 is confirmed, the sales representative presses a start button 222. When the start button 222 is pressed, the associated customer is selected. Based on pressing of the start button 222, the business negotiation space settings screen 210 may be displayed again. Specifically, the business negotiation space settings screen 210 as illustrated in FIG. 15 may be displayed with the customer information and the schedule information of the selected customer reflected and the input fields completed.

The business negotiation space settings screen 210 obtained after the spatial feature information and the schedule information are input in step S34 may be the same as that of FIG. 15. The welcome message screen displayed in step S40 may be the same as that of FIG. 14.

As described above, the server apparatus 30 according to the present embodiment can display a welcome message and the business negotiation space settings screen 210 by several methods.

### Display of Proposal Based on Audio Data

In parallel with identification of a customer, the customer and the sales representative start a business negotiation. Processing until the server apparatus 30 displays a proposal based on a conversation between the customer and the sales representative will be described.

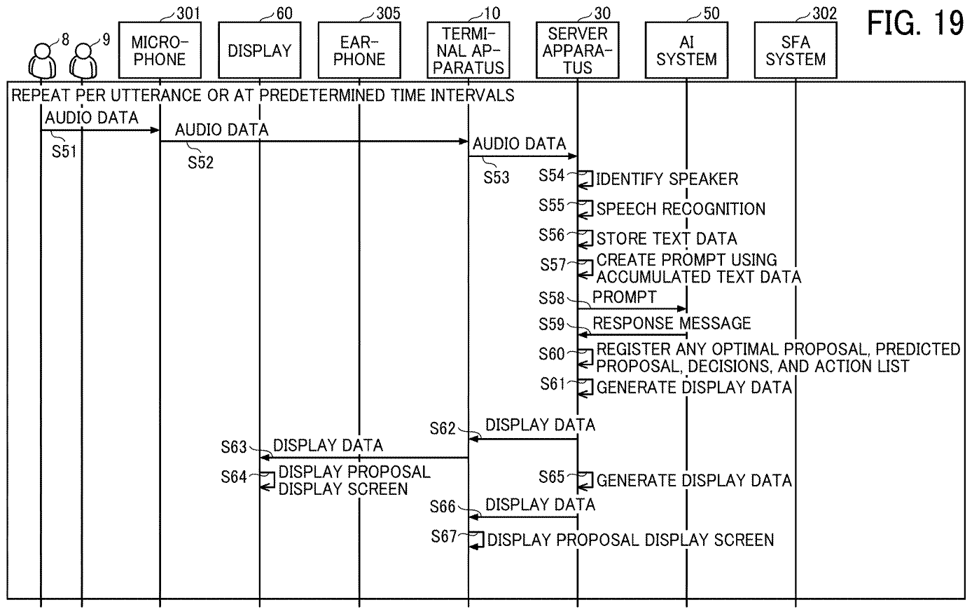

FIG. 19 is a sequence diagram illustrating processing performed by the server apparatus 30 to display a proposal based on audio data acquired from the space 360, the space information 1, the space information 2, and the space information 3.

In step S51, the customer 8 and the sales representative 9 start a conversation. The microphone 301 acquires audio data of utterances made by the sales representative 9 and the customer 8.

In step S52, the microphone 301 transmits audio data to the terminal apparatus 10 in real time or at intervals of a predetermined time period.

In response to the audio data acquisition unit 11 of the terminal apparatus 10 acquiring the audio data, in step S53, the transmission unit 12 transmits the audio data to the server apparatus 30 in real time or at intervals of a predetermined time period.

In response to receiving the audio data, in step S54, the reception unit 31 of the server apparatus 30 passes the audio data to the language processing unit 33 and the speech recognition unit 34. The language processing unit 33 performs speaker diarization and identifies a speaker with suitable granularity such as for each segment of audio data, for each sentence, or for each word.

In step S55, the speech recognition unit 34 converts the audio data into text data. The speech recognition unit 34 acquires information on the speaker from the language processing unit 33 and associates the speaker with the text data. The speech recognition unit 34 passes the text data to the control unit 32. The processing of step S54 and the processing of step S55 may be performed in either order.

In step S56, the control unit 32 requests the accumulation unit 36 to accumulate the text data, and the accumulation unit 36 accumulates the text data in the text data storage unit 49.

In step S57, the control unit 32 requests the AI control unit 37 to generate a prompt using the accumulated text data each time a certain amount of text data is accumulated or at intervals of a predetermined time (e.g., a time taken for the conversation to progress, such as 60 seconds). This prompt is a prompt for requesting generation of, for example, an optimal proposal and a predicted proposal. The optimal proposal is an example of a first proposal, and the predicted proposal is an example of a second proposal.

The request transmission unit 42 of the AI control unit 37 generates prompts for instructing the AI system 50 to generate an optimal proposal, a predicted proposal, decisions, and an action list, based on the accumulated text data and a system prompt prepared in advance. The prompt for an optimal proposal is a prompt for requesting proposal of an optimal product for the previous utterances made by the customer 8. That is, the prompt is a prompt for instructing the AI system 50 to make a proposal based on utterances made by the customer 8. The prompt for a predicted proposal is a prompt for requesting proposal of a product that has not been explicitly mentioned by the customer 8 but is predicted to be a possible purchase based on the previous utterances made by the customer 8. That is, the prompt is a prompt for instructing the AI system 50 to make a proposal suitable for the customer 8 other than a proposal corresponding to requests explicitly mentioned by the customer 8. The prompt for decisions is a prompt for requesting extraction of decisions inferred from the previous utterances made by the customer 8 and the sales representative 9. The prompt for an action list is a prompt for requesting extraction of an action list inferred from the previous utterances made by the customer 8 and the sales representative 9. These prompts may be transmitted to the AI system 50 in multiple parts.

A simple example of the system prompt is as follows. This prompt may be transmitted to the AI system 50 in multiple parts.
<Example of system prompt> Participants of the business negotiation are as follows.
{Customer name, sales representative name} Customer requests registered in advance are as follows.
{Consultation details} A location at which the business negotiation is performed is as follows.
{Business negotiation room} Customer information is as follows.
{Customer information} A list of products that can be proposed is as follows.
{Product information} Please select and propose a product or service optimal for the customer based on the following conversation.
Please anticipate, select, and propose products or services that the customer is highly likely to desire in the future based on the following conversation.
Furthermore, if the dialogue of this business negotiation includes decisions, please indicate the decisions.
Furthermore, if the dialogue of this business negotiation includes an action list, please indicate the action list.
The following dialogue is a dialogue in a certain space.
This space is a space in the situation of {Customer name, sales representative name} and {Consultation details}. In consideration of the space in the situation of {Customer name, sales representative name} and {Consultation details}, please propose an optimal product for Mr./Ms. XX (customer). Furthermore, this space has a feature of {Business negotiation room}. Please propose a product optimal for display in such a space.
{Conversation text data} Furthermore, the decisions made in the business negotiation so far are as follows.
{Decisions} Furthermore, the action list from the business negotiation so far is as follows.
{Action list}
<End of example of system prompt>

In this case, the AI control unit 37 creates a prompt by inserting information input by the sales representative 9 and information retrieved from each storage unit into the {***} portions of the system prompt.

The {Customer name, sales representative name} are defined as follows:

{Mr. Ichiro Tanaka with customer identification information C0001, Sales representative: Suzuki} This information is manually entered by the sales representative 9 or retrieved from the customer information or the schedule information. This information is space information 1. Additionally, other information associated with “Ichiro Tanaka” in the customer information storage unit 51 may be included.

The {Consultation details} is defined as follows:

{“I would like to consult about a gift.”} This information is manually entered by the sales representative 9 or retrieved from the schedule information. This information is space information 2.

The {Business negotiation room} is defined as follows:

{VIP room 1} This information is manually entered by the sales representative 9 or is stored as schedule information or spatial feature information. This information is space information 3. In addition to the space name “VIP room 1” described above, a space description and space characteristics stored as spatial feature information serving as characteristics of the space may also be included.

The {Customer information}, {Product information}, and {Conversation text data} are contents of the customer information storage unit 51, the product information storage unit 53, and the text data storage unit 49, respectively. For example, the customer information includes at least one of an age group, a gender, and a purchase history. The {Conversation text data} increases in length as the duration of the dialogue increases. The {Decisions} and {Action list} are contents of the “decisions” item and the “action list” item of the temporarily stored information storage unit 48, respectively.

In step S58, the AI control unit 37 inputs the prompt generated as described above to the AI system 50.

The following is a supplement regarding prompt generation using RAG. The control unit 32 may perform the processing for RAG. When RAG is implemented, the control unit 32 converts the acquired text data into a vector that represents the meaning of the text data using multidimensional numerical values (hereinafter referred to as a “message vector”). Such a semantic vector may be referred to as a distributed representation. Converting the original text into a distributed representation allows the meaning and content of the original text to be expressed numerically, enabling comparison using vector data. In search and comparison using text data of related art, when even one character differs, the text data does not match the search, or when even one character matches the search, the text data matches the search. In contrast, comparison using the vector data allows for information retrieval based on the degree of similarity in meaning or content of the original text. Since a distributed representation is vector data, the original text can be represented as a point in a vector space. The similarity of the vector data can be calculated by an existing method such as cosine similarity.

The control unit 32 uses the generated message vector to extract product information having relatively high relevance to the message vector from among the product information stored in the product information storage unit 53. The product information stored in the product information storage unit 53 is divided into chunks in advance, and chunk vectors obtained by converting the chunks into distributed representations are also stored. A chunk from which a chunk vector similar to the message vector is derived may be referred to as a “similar chunk”. The control unit 32 retrieves, as a search result, the original product information of the similar chunk from the product information storage unit 53.

The AI control unit 37 generates a prompt by inserting product information identified by the search into the system prompt. Thus, product information to be transmitted to the AI system 50 can be narrowed down. The prompt may include a statement (instruction) that proposes only products in stock. The prompt may include a statement (instruction) that proposes only products matching a budget. The prompt may include a statement (instruction) that proposes only products that do not exist online (i.e., non-searchable products). The prompt may include a statement (instruction) that proposes superiority over similar products that exist online. The prompt may include a statement (instruction) that paraphrases technical terms into words easy for the customer 8 to understand.

In step S59, the AI system 50 generates a response message including an optimal proposal, a predicted proposal, decisions, and an action list, based on trained parameters. Not all of the optimal proposal, the predicted proposal, the decisions, and the action list may be included in the response message. The AI system 50 transmits the response message to the AI control unit 37. The response acquisition unit 43 of the AI control unit 37 acquires the response from the AI system 50. Depending on a control procedure, the first response is not a final response, and a final response message is obtained by repeatedly performing the processing of steps S58 and S59 a plurality of times. The AI control unit 37 transmits the generated response message to the control unit 32. The response message is transmitted in a format in which the server apparatus 30 can recognize the optimal proposal, the predicted proposal, the decisions, and the action list. The optimal proposal and the predicted proposal are associated with topics extracted from the conversation and are transmitted.

In step S60, when the response message includes an optimal proposal, a predicted proposal, decisions, and an action list, the control unit 32 registers the optimal proposal, the predicted proposal, the decisions, and the action list in the temporarily stored information storage unit 48. Specifically, the control unit 32 identifies, among the product information included in the prompt, product information of a product included as a product to be proposed in the optimal proposal and the predicted proposal in the response message, and registers the identified product information in the temporarily stored information storage unit 48. At that time, the control unit 32 may refer to the product information table (see FIG. 8) and register, in the temporarily stored information storage unit 48, product information retrieved from the product information table. The response message may include product identification information that identifies the product. When the response message includes decisions and action items, the control unit 32 identifies the decisions and the action items and registers the decisions and the action items in the temporarily stored information storage unit 48.

In step S61, the control unit 32 causes the terminal apparatus 10 and the display 60 to display the same proposal. In other words, mirroring is enabled between the terminal apparatus 10 and the display 60. Alternatively, the proposal may be displayed on one of the display 60 and the terminal apparatus 10. The sales representative 9 may specify the display destination. First, the control unit 32 designates the display 60 as the display destination and requests the display data generation unit 38 to generate display data including an optimal proposal and a predicted proposal. The display data generation unit 38 generates display data of a proposal display screen to be displayed on the display 60 to present the optimal proposal and the predicted proposal. In a case where the terminal apparatus 10 and the display 60 display the same proposal display screen, that is, in a case where mirroring is enabled between the terminal apparatus 10 and the display 60, the information display unit 16 of the terminal apparatus 10 may control the display 60 to display the proposal display screen. In this case, the control unit 32 requests the display data generation unit 38 to generate display data for displaying a proposal display screen that is a screen to be displayed on the terminal apparatus 10 and is also a screen to be displayed on the display 60, and the display data generation unit 38 generates display data for displaying such a proposal display screen. In a case where the terminal apparatus 10 and the display 60 display different proposal display screens, the information display unit 16 of the terminal apparatus 10 may control the display 60 to display a screen different from a screen displayed on the terminal apparatus 10.

In step S62, the transmission unit 39 of the server apparatus 30 transmits the generated display data and information on the display destination (i.e., the display 60) to the terminal apparatus 10. The information on the display destination may be omitted. In the foregoing description, by way of example but not limitation, the display data generation unit 38 of the server apparatus 30 generates display data in step S61. The transmission unit 39 of the server apparatus 30 may transmit the optimal proposal and the predicted proposal received from the AI system 50 to the terminal apparatus 10, and the information display unit 16 of the terminal apparatus 10 may generate display data.

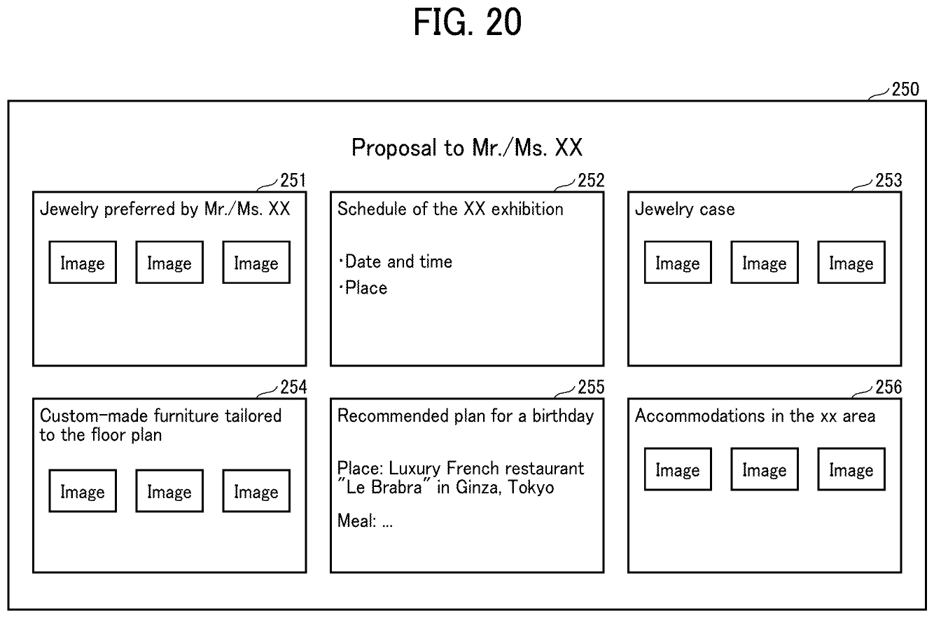

In steps S63 and S64, the reception unit 14 of the terminal apparatus 10 receives the display data, and passes the display data to the information display unit 16 based on the information on the display destination (i.e., the display 60). Processing for displaying content on the display 60 may be performed based on the settings of the terminal apparatus 10, without using information on the display destination. For example, the information display unit 16 of the terminal apparatus 10 may open a Web browser window and control the window to be displayed on the display 60 according to the settings. Alternatively, control is performed similarly by using an application installed in the terminal apparatus 10. At that time, the terminal apparatus 10 is connected to the display 60 via a High-Definition Multimedia Interface (HDMI®) cable or a Video Graphics Array (VGA) cable, allowing the display 60 to display content. This technique involves converting display data generated by a graphics processing unit (GPU) of the terminal apparatus 10 into a signal and outputting the signal to another display via HDMI® or VGA, and is a standard feature on most general terminals. The information display unit 16 causes the display 60 to display the proposal display screen (see FIG. 20) based on the display data.

In step S65, the control unit 32 designates the terminal apparatus 10 as the display destination and requests the display data generation unit 38 to generate display data including an optimal proposal and a predicted proposal. The display data generation unit 38 generates display data of a proposal display screen to be displayed on the terminal apparatus 10 to present the optimal proposal and the predicted proposal. A voice message for the speakers 306 may be transmitted to the terminal apparatus 10 together with the display data. For example, along with the voice message, alerting music may be output from the speakers 306 in synchronization with the display of the proposal.

In step S66, the transmission unit 39 of the server apparatus 30 transmits the generated display data and information on the display destination (i.e., the terminal apparatus 10) to the terminal apparatus 10.

In step S67, the reception unit 14 of the terminal apparatus 10 receives the display data, and passes the display data to the display control unit 15 based on the information on the display destination (i.e., the terminal apparatus 10). The display control unit 15 causes the terminal apparatus 10 to display the proposal display screen based on the display data. The proposal display screen may be the same as that of FIG. 20. The server apparatus 30 may generate a voice message and transmit the voice message to the earphone 305. The audio of the transmitted voice message is played back via a speaker of the earphone 305.

### Display Examples of Proposal Display Screens Displayed on Display 60

FIG. 20 illustrates a proposal display screen (1) 250 displayed on the display 60 by the server apparatus 30. The proposal display screen (1) 250 includes areas 251 to 256 that display six proposals generated by the AI system 50. The display 60 displays proposals for respective areas, thereby displaying a plurality of proposals on a single screen and displaying an optimal proposal and a predicted proposal on a single screen.

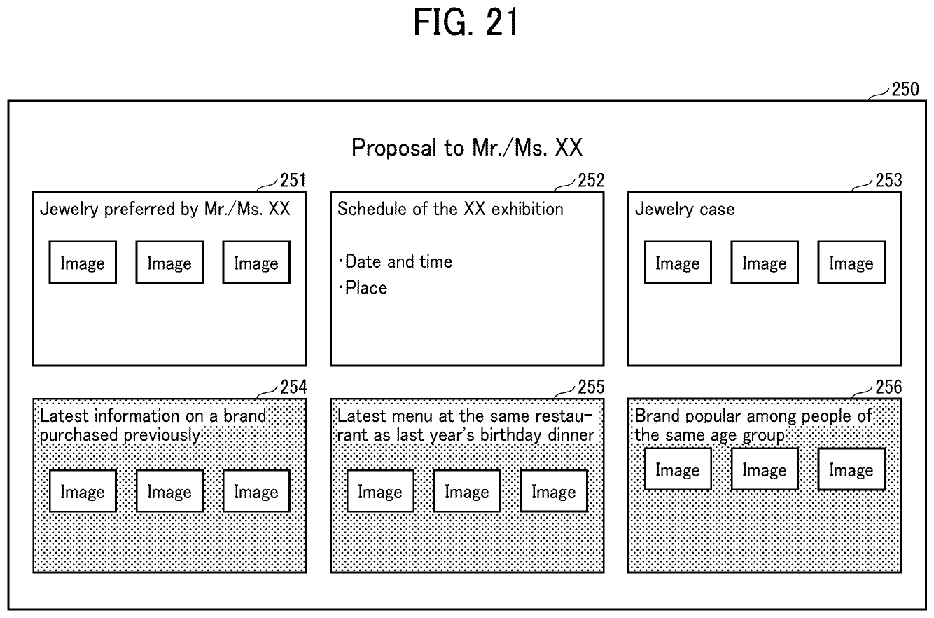

The screen configuration illustrated in FIG. 20 is an example. The proposal display screen (1) 250 constantly displays the six areas 251 to 256. The proposal display screen (1) 250 is a screen for making proposals for each topic of an utterance. In a business negotiation, various topics such as subjects, requests, customer issues, and products are discussed. In an embodiment of the present disclosure, product proposals corresponding to those topics are displayed while visually summarizing the topics. Even if the subject changes during the business negotiation, making proposals for each topic ensures that no customer requests are overlooked. Furthermore, automatically making proposals for a topic allows for introduction of unexpected products. Furthermore, displaying proposals for each topic visualizes the business negotiation, and enables additional proposals to be made beyond proposals from the sales representative. The number of areas is an example. In an initial stage of the conversation, not all of the areas 251 to 256 may display proposals. As the conversation progresses and more information is obtained from the conversation, the areas 251 to 256 are gradually populated. Alternatively, as described below with reference to FIG. 21, when the number of proposals based on the conversation is less than six, the server apparatus 30 may request the AI system 50 to propose products only from customer information and constantly cause some proposals to be displayed in the six areas 251 to 256.

When a next proposal is generated while some proposals are displayed in the six areas 251 to 256, the oldest proposals are overwritten. The AI system 50 determines similarity between existing proposals and a newly generated proposal, and designates any similar proposal among the existing proposals to link the existing proposal to the newly generated proposal. The server apparatus 30 transmits the new proposal linked to the existing proposal to the terminal apparatus 10. Thus, the terminal apparatus 10 can display similar proposals in the same area. The customer can view similar proposals in the same area.

As an example, the areas 251 to 253 illustrated in FIG. 20 present optimal proposals generated by the AI system 50 based on the conversation information and the customer information. In a business negotiation use case, the optimal proposals are recommended products. The term “optimal proposal” refers to a proposal of a product or service for fulfilling a request explicitly desired by a customer in their utterance.

A proposal of a product or service requested by a customer in their utterance is also an optimal proposal. As an example, the areas 254 to 256 illustrated in FIG. 20 present predicted proposals predicted (inferred) by the AI system 50 from text data accumulated by the conversation, although such proposals are not directly requested by the customer in their utterance. The predicted proposal refers to a proposal anticipating a product that has a high probability of being desired in the future although not directly mentioned in the conversation. The predicted proposal may also be considered a proposal of a product or service not requested by the customer in their utterance. The predicted proposal may also be considered a proposal suitable for the customer other than a proposal corresponding to a request mentioned by the customer. The number of optimal proposals and the number of predicted proposals may be determined by proposals of the AI system 50, or may be determined by the sales representative and set in the terminal apparatus 10.

(1) The area 251 displays the topic “Jewelry preferred by Mr./Ms. XX” and photographs of jewelry, which is a proposed product. This proposal is an optimal proposal proposed by the AI system 50 by analyzing, as a customer request (topic), an utterance made by the customer, such as “I am thinking that jewelry would be good this year”. The server apparatus 30 acquires photographs of a product of the proposed optimal proposal from the product information, and transmits the photographs to the terminal apparatus 10. It is inferred which utterance of the customer has been used by the AI system 50 to generate an optimal proposal and a predicted proposal, including the following proposals.

(2) The area 252 displays the topic “XX exhibition” and, as a proposal, the date and time and the location of the exhibition. This proposal is an optimal proposal proposed by the AI system 50 by analyzing, as a topic, an utterance made by the customer, such as “I went to the XX exhibition and got interested in Italian jewelry”. A search is performed using the keyword “XX”. Thus, the optimal proposal and the predicted proposal may present information searched on the Internet, as well as products or services stored in a storage unit. In this case, a prompt including an instruction to search for information that meets the request of the customer is transmitted to the AI system 50. The AI system 50 communicates with a search server to search for information, and transmits a response to the server apparatus 30.

(3) The area 253 displays the topic “Jewelry Case” and photographs of a jewelry case, which is a proposed product. This proposal is an optimal proposal proposed by the AI system 50 by analyzing an utterance made by the customer, such as “My spouse mentioned wanting a jewelry case that would fit our new house”. The server apparatus 30 acquires photographs of a product of the proposed optimal proposal from the product information, and transmits the photographs to the terminal apparatus 10.

Thus, rather than simply proposing a product based on a conversation, the server apparatus 30 causes the AI system 50 to recognize the situation within a space and propose a product or service. Thus, an appropriate product can be proposed.

(4) The area 254 displays the topic “custom-made furniture tailored to the floor plan” and photographs of furniture related to the proposal. This proposal is a predicted proposal proposed by the AI system 50 by analyzing, as a topic, an utterance made by the customer 8, such as “Actually, we recently moved”, and anticipating a product that has a high probability of being desired in the future. That is, since the customer has moved, the AI system 50 anticipates that furniture based on the floor plan will be needed in the near future.

Since the AI system 50 does not know the floor plan, the AI system 50 assumes several potential layouts, such as a studio apartment (1R), a 2DK, and a 3LDK, and proposes items such as furniture photographs suitable for each layout. For example, the AI system 50 proposes furniture as follows for a 3LDK:

“Queen or double bed (master bedroom), semi-double or single bed (children's room/guest room), dining table and chairs (for 4 to 6 seaters), large sofa (L-shaped or for 3 seaters or more), center or coffee table, large TV stand and storage shelves, bookcase or living room storage, work desk and chair (for home office), cupboard or sideboard, kitchen counter or island table, entryway storage (shoe rack and umbrella stand), and dresser”.

The predicted proposal is not necessarily accurate. Since the display 60 is visible to the customer, if the customer finds furniture of interest, the customer may make an utterance such as “Now that you mention it, it would be good to have functional storage shelves”. The microphone 301 captures such audio data, and the AI system 50 further analyzes text data and identifies that the utterance made by the customer includes “storage shelves”. Thus, the AI system 50 can propose, for example, recommended storage shelves. The server apparatus 30 can preferably cause, for example, photographs of storage shelves to be displayed in the same area 254.

(5) The area 255 displays the topic “Recommended plan for spouse's birthday” and a proposal. This proposal is a predicted proposal obtained by the AI system 50 analyzing the customer's utterance, “spouse's birthday”, and anticipating and proposing a service that has a high probability of being desired in the future.

That is, since the birthday of the customer's spouse is near, the AI system 50 anticipates that a plan to spend time together on the birthday will be needed in the near future.

(6) The area 256 displays the topic “Accommodations in XX area” and a proposal (for example, the images of the recommended accommodations). This proposal is a predicted proposal obtained by the AI system 50 analyzing the customer's utterance, “We plan to travel on the birthday”, and anticipating and proposing a service that has a high probability of being desired in the future. That is, since the customer travels with the customer's spouse, the AI system 50 anticipates that recommended hotels and the like at the destination will be needed in the near future. Since the AI system 50 does not know the destination, the AI system 50 selects locations that are in peak sightseeing season on the birthday and proposes recommended hotels at the locations.

Since the optimal proposals are products or services included in conversation text data, the server apparatus 30 can propose products or services included in the customer's utterances without omission. Since the predicted proposals anticipate products or services that are not mentioned in the customer's utterances but have a high probability of being desired in the future, the server apparatus 30 can identify potential customer demand and make proposals. Furthermore, using the predicted proposals, the server apparatus 30 can propose products or services for latent needs that are not consciously recognized by the customer.

The areas 251 to 256 may display utterances from which the respective proposals are generated. The utterances from which the proposals are generated may be displayed when the sales representative performs an operation. For each proposal, classification of an optimal proposal and a predicted proposal may be displayed. Thus, utterance data including utterances made in a space and space information of the space (e.g., the type of event performed in the space, activities intended in the space, and characteristics of the space) can be provided to the AI system 50, and the AI system 50 can be caused to generate proposals based on information on the space and the content of the utterances.

A proposal display screen in an initial stage of a conversation will be described with reference to FIG. 21. FIG. 21 illustrates a proposal display screen (2) 250 displayed on the display 60 by the server apparatus 30. In the description of FIG. 21, differences from FIG. 20 will be described. The proposal display screen (2) 260 illustrated in FIG. 21 displays proposals generated by the AI system 50 based only on customer information when the number of proposals based on the conversation is less than six. The phrase “based only on customer information” refers to proposals not including conversation text data, and information in the various storage units 304, such as the space information 1, the space information 2, and the space information 3, is used to generate proposals.

The areas 251 to 253 illustrated in FIG. 21 are the same as those of FIG. 20. The areas 254 to 256 illustrated in FIG. 21 present optimal proposals proposed by the AI system 50 based only on customer information without using text data accumulated by the conversation. Information obtained from the conversation is little in an early stage of the conversation. However, a proposal can be made from, for example, the past purchase history of the customer information.

The proposals presented in the areas 254 to 256 illustrated in FIG. 21 can be made by the AI system 50 when the AI control unit 37 generates a prompt such as “Until the total number of proposals based on the following conversation becomes six, please propose products that have a high probability of being desired based only on customer information”.

(7) The area 254 displays a proposal “latest information on a brand purchased previously” and the brand's collection. This proposal is an optimal proposal obtained by the AI system 50 analyzing the purchase history of the customer information and proposing a product of the same brand. That is, the AI system 50 determines that the customer may prefer the same brand, and acquires a product of the brand based on the product information. The server apparatus 30 acquires photographs of a product of the proposed optimal proposal from the product information, and transmits the photographs to the terminal apparatus 10.

(8) The area 255 displays the topic “Latest menu at the same restaurant as last year's birthday dinner” and a proposed menu. This proposal is an optimal proposal obtained by the AI system 50 analyzing the purchase history of the customer information and proposing a menu of the same restaurant used in the past. The purchase history of the customer information includes a purchase history of a service proposed by the sales representative or the server apparatus 30. The AI system 50 determines that the customer may prefer meals at the same restaurant, and causes a latest menu of the restaurant to be displayed. The latest menu of the restaurant may be searched for by the AI system 50 via a network, or may be searched for by the server apparatus 30.

The server apparatus 30 transmits the latest menu of the restaurant to the terminal apparatus 10.

(9) The area 256 displays the topic “Brand popular among persons of the same age group” and a proposal of the brand's collection. This proposal is an optimal proposal obtained by the AI system 50 proposing a brand popular among males of the same age group based on the age and the gender of the customer information.

The AI system 50 searches for a product brand popular for each age group. The server apparatus 30 transmits the proposed brand to the terminal apparatus 10.

### Closing Processing

When the remaining time until an end time of a business negotiation registered in schedule information becomes less than a predetermined value, or when it is detected from the conversation that the business negotiation is approaching its end, the display 60 displays a closing screen summarizing the content of the business negotiation. The closing screen may be displayed by an operation by the sales representative or an instruction by voice.

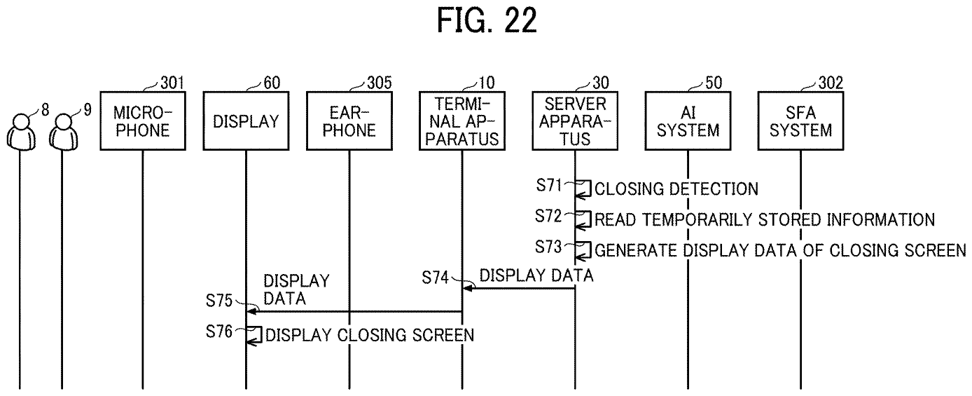

FIG. 22 is a sequence diagram illustrating processing for displaying a closing screen on the display 60.

In step S71, the closing detection unit 35 detects that the business negotiation is approaching its end, based on phrases included in a conversation, for example, “Thank you for your time today”, “How about your next visit?”, and “We will send you materials summarizing today's content later”. Additionally or alternatively, the closing detection unit 35 compares the current time and an end time in schedule information, and detects that the business negotiation is approaching its end when the remaining time becomes less than a predetermined time. Alternatively, the AI control unit 37 may generate a prompt for detecting that the business negotiation is approaching its end from conversation text data, and repeatedly transmit the prompt to the AI system 50. The prompt may be, for example, “If the conversation text data includes an expression indicating that the business negotiation is approaching its end, please generate a closing detection flag”. When the AI control unit 37 acquires the closing detection flag from the AI system 50, the control unit 32 determines that the current time is the closing timing of the business negotiation. The closing detection unit 35 may determine closing when closing is detected based on both a time and the closing detection flag. Additionally or alternatively, the sales representative 9 may instruct the terminal apparatus 10 to start the closing processing.

In response to the control unit 32 of the server apparatus 30 acquiring a notification of detection of closing from the closing detection unit 35 or the AI control unit 37, in step S72, the control unit 32 reads temporarily stored information recorded in the current business negotiation from the temporarily stored information storage unit 48.

In step S73, the control unit 32 designates the display 60 as the display destination and causes the display data generation unit 38 to generate display data of a closing screen. The display data generation unit 38 generates display data of a closing screen using the temporarily stored information.

In step S74, the transmission unit 39 of the server apparatus 30 transmits the display data of the closing screen to the terminal apparatus 10 together with information on the display destination (i.e., the display 60). The reception unit 14 of the terminal apparatus 10 receives the display data, and passes the display data to the information display unit 16 based on the information on the display destination (i.e., the display 60).

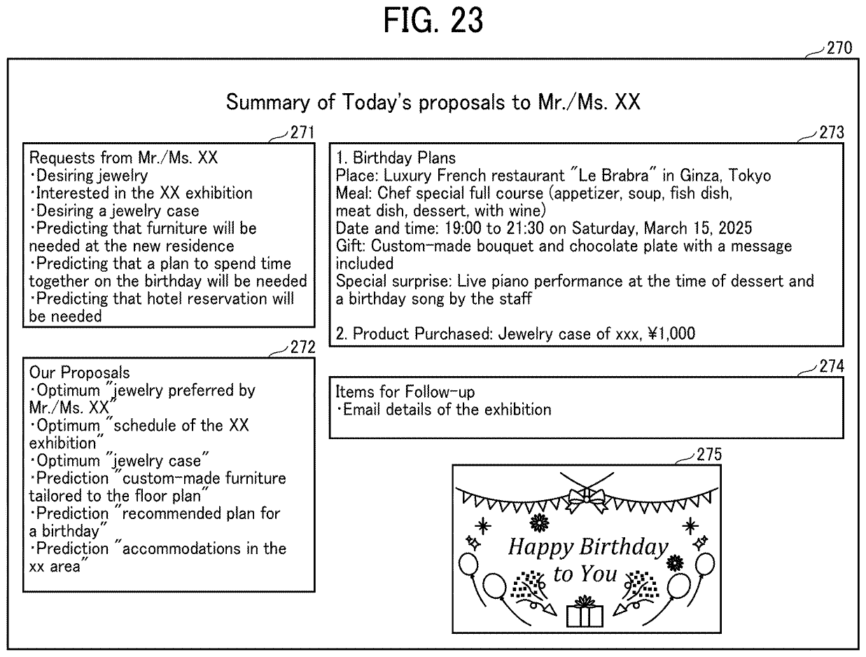

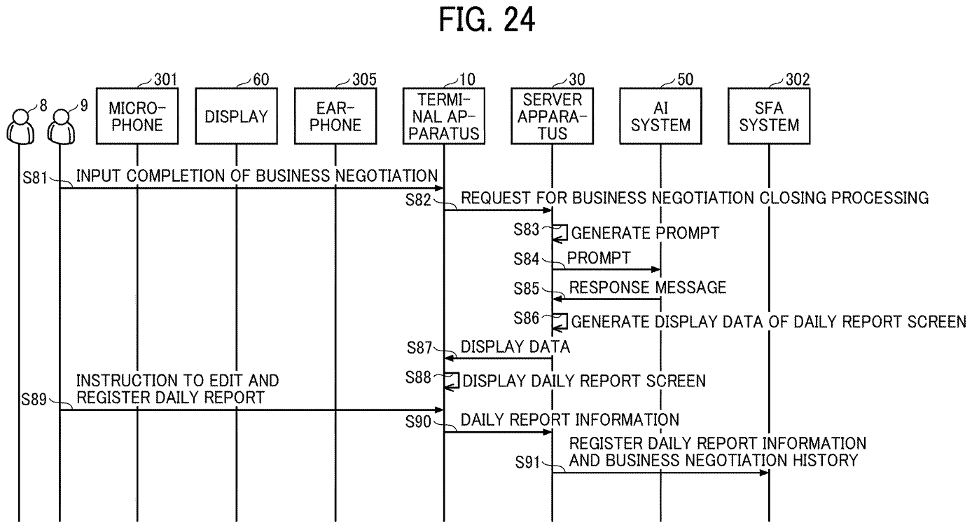

In steps S75 and S76, the information display unit 16 causes the display 60 to display the closing screen (see FIG. 23) based on the display data.

The control unit 32 may also cause the terminal apparatus 10 to display the closing screen. In this case, the display data generation unit 38 also generates display data of the closing screen for the terminal apparatus 10. Thus, the terminal apparatus 10 and the display 60 can display the same closing screen. The content to be confirmed by the sales representative 9 on the terminal apparatus 10 may differ from the content displayed on the display 60. For example, only the terminal apparatus 10 may display a purchase probability estimated by the AI system 50.

Rather than using information in the temporarily stored information storage unit 48 for display of the closing screen, the server apparatus 30 may transmit a prompt including the information in the temporarily stored information storage unit 48 to the AI system 50 to generate information on the closing screen. Alternatively, the server apparatus 30 may transmit a prompt including all accumulated text data, the space information 1, the space information 2, the space information 3, and the instruction, “Please create information summarizing the entire business negotiation”, to the AI system 50 to generate information on the closing screen.

FIG. 23 illustrates an example of a closing screen 270 displayed on the display 60. The closing screen 270 includes a request field 271, a proposal field 272, a decisions field 273, and an action list field 274.

The request field 271, the proposal field 272, the decisions field 273, and the action list field 274 displayed on the closing screen 270 are registered in the temporarily stored information table (see FIG. 5). The request field 271 lists the content of the “extracted request” column of the temporarily stored information table. The proposal field 272 lists the content of the “proposal item” column of the temporarily stored information table. The decisions field 273 lists the content of the “decisions” column of the temporarily stored information table. The action list field 274 lists the content of the “action list” column of the temporarily stored information table. Thus, the closing screen 270 displays requests, proposals, decisions, and an action list on a single screen.

Since the closing screen 270 is automatically displayed on the display 60, the customer 8 and the sales representative 9 can review the business negotiation and share decisions and action items. In addition, since the customer 8 can confirm proposals again, an effect of proposing products again is also obtained.

The closing screen 270 may further display an illustration 275. The AI system 50 may generate the illustration 275 based on the content of one or more principal conversations, or may acquire the illustration 275 via a network.

### After End of Business Negotiation

When the business negotiation ends such as when the customer 8 leaves the business negotiation room, the sales representative 9 generates a business negotiation history and a daily report. In the present embodiment, the server apparatus 30 generates a business negotiation history and a daily report summarizing the content of the business negotiation and registers the business negotiation history and the daily report in the SFA system 302. This prevents the sales representative 9 from forgetting to create the business negotiation history and the daily report or from having to spend time creating such documents.

FIG. 24 is a sequence diagram illustrating processing performed by the server apparatus 30 to generate a business negotiation history and a daily report.

In step S81, the sales representative 9 inputs the completion of the business negotiation into the terminal apparatus 10. Specifically, the sales representative 9 inputs the completion of the business negotiation into the application. The sales representative 9 may press some button or give an instruction by voice such as “The business negotiation has been completed, so please create a business negotiation history and a daily report”. The operation reception unit 13 of the terminal apparatus 10 receives the completion of the business negotiation. When a predetermined time elapses from an end time in schedule information, the server apparatus 30 may automatically start business negotiation closing processing.

In step S82, the transmission unit 12 of the terminal apparatus 10 transmits a request for business negotiation closing processing to the server apparatus 30.

In step S83, the reception unit 31 of the server apparatus 30 receives the request for business negotiation closing processing as operation information and notifies the control unit 32 of the request for business negotiation closing processing. As the business negotiation closing processing, the control unit 32 determines to create a business negotiation history and a daily report. The control unit 32 requests the AI control unit 37 to generate a prompt using, for example, accumulated text data.

The AI control unit 37 generates a prompt for instructing the AI system 50 to generate a business negotiation history and a daily report, based on the accumulated text data, the space information 1, the space information 2, the space information 3, the temporarily stored information, information in the various storage units 304, and a system prompt prepared in advance.

A simple example of the system prompt is as follows.
<Example of system prompt> Participants of the business negotiation are as follows.
{Customer name, sales representative name} Customer requests registered in advance are as follows.
{Consultation details} A location at which the business negotiation is performed is as follows.
{Business negotiation room} Customer information is as follows.
{Customer information} Temporarily stored information is as follows.
{Temporarily stored information} Conversation content is as follows.
{Conversation text data} Items of the daily report are as follows.
{Items of daily report} Items of business negotiation history
{Items of business negotiation history} Please generate a business negotiation history and a daily report using the above information.
<End of example of system prompt>

In this case, the AI control unit 37 creates a prompt by inserting information input by the sales representative 9 and information retrieved from each storage unit into the {***} portions of the system prompt.

The {Customer name, sales representative name} are defined as follows:

{Mr. Ichiro Tanaka with customer identification information C0001, Sales representative: Suzuki} This information is manually entered by the sales representative 9 or retrieved from the customer information or the schedule information. This information is space information 1.

The {Consultation details} is defined as follows:

{“I would like to give a gift.”} This information is manually entered by the sales representative 9 or retrieved from the schedule information. This information is space information 2.

The {Business negotiation room} is defined as follows:

{VIP room 1} This information is manually entered by the sales representative 9 or retrieved from the schedule information. This information is space information 3.

The {Customer information}, {Temporarily stored information}, and {Conversation text data} are contents of the customer information storage unit 51, the temporarily stored information storage unit 48, and the text data storage unit 49, respectively.

The {Items of daily report} is defined as follows:

{Daily report identification information, business negotiation history identification information, agenda, proposals, purchased products, next visit, internal notes} These items of information are the items of the daily report information table.

The {Items of business negotiation history} is defined as follows:

{Business negotiation history identification information, date and time, customer identification information, purchased product identification information, action items, person in charge} These items of information are the items of the business negotiation history table.

In step S84, the AI control unit 37 inputs the prompt generated as described above to the AI system 50.

In step S85, the AI system 50 generates a response message including a business negotiation history and a daily report, based on trained parameters. The AI system 50 transmits the response message to the AI control unit 37. The response acquisition unit 43 of the AI control unit 37 acquires the response from the AI system 50. Depending on a control procedure, the first response is not a final response, and a final response message is obtained by repeatedly performing the processing of steps S84 and S85 a plurality of times. The AI control unit 37 transmits the generated response message to the control unit 32.

In step S86, the control unit 32 designates the terminal apparatus 10 as the display destination and requests the display data generation unit 38 to generate display data of a daily report screen. The display data generation unit 38 generates display data for causing the terminal apparatus 10 to display the daily report screen. The business negotiation history is not displayed on the terminal apparatus 10 when the sales representative 9 does not have to check the business negotiation history. If the sales representative 9 checks the business negotiation history, the display data generation unit 38 generates display data for causing the terminal apparatus 10 to display a business negotiation history screen.

In step S87, the transmission unit 39 of the server apparatus 30 transmits the generated display data and information on the display destination (i.e., the terminal apparatus 10) to the terminal apparatus 10.

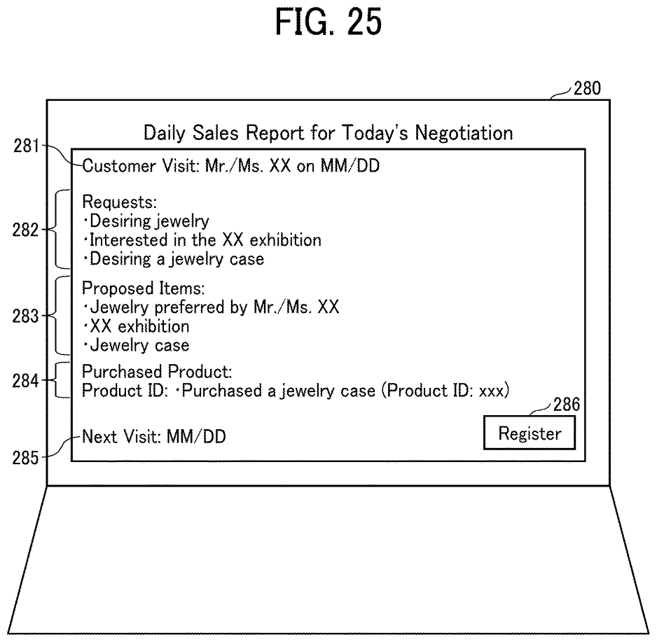

In step S88, the reception unit 14 of the terminal apparatus 10 receives the display data, and passes the display data to the display control unit 15 based on the information on the display destination (i.e., the terminal apparatus 10). The display control unit 15 causes the terminal apparatus 10 to display the daily report screen (see FIG. 25) based on the display data.

In step S89, the sales representative 9 edits the daily report on the terminal apparatus 10 as appropriate and then performs an operation of registering the daily report, or presses a registration button 286 illustrated in FIG. 25. The sales representative 9 may perform an operation of editing and registering the daily report by voice. The terminal apparatus 10 receives the operation of editing and registering the daily report.

In step S90, the transmission unit 12 of the terminal apparatus 10 transmits daily report information to the server apparatus 30 together with a registration request.

In step S91, the reception unit 31 of the server apparatus 30 receives, as operation information, the registration request for registering the daily report information and notifies the control unit 32 of the registration request. The control unit 32 requests the system API 41 to register the daily report information and the business negotiation history by specifying the daily report information and the business negotiation history. The system API 41 requests the SFA system 302 to register the daily report information and the business negotiation history.

FIG. 25 illustrates an example of a daily report screen 280 displayed on the terminal apparatus 10. The daily report screen 280 is a sales report for today's business negotiation. In FIG. 25, items such as bibliographic information 281, requests 282, proposals 283, a purchased product 284, and next visit 285 are displayed. The bibliographic information 281 is stored in the customer information or the schedule information, and the other items are stored in the temporarily stored information. The purchased product 284 is included in the decisions. The daily report screen 280 may further display, for example, conversation text data.

The sales representative 9 is allowed to edit the bibliographic information 281, the requests 282, the proposals 283, the purchased product 284, and the next visit 285. This is because the AI system 50 may generate unintended information or omit information to be used. In response to the sales representative 9 pressing the registration button 286, the terminal apparatus 10 transmits the daily report information to the server apparatus 30.

### Registration and Update of Customer Information

Audio data captured during a business negotiation may include customer information. However, it is time-consuming and prone to error for a sales representative to register or update customer information later after taking notes. The server apparatus 30 according to the present embodiment registers customer information in the SFA system 302 during or after the business negotiation, based on text data acquired by the server apparatus 30 during the business negotiation.

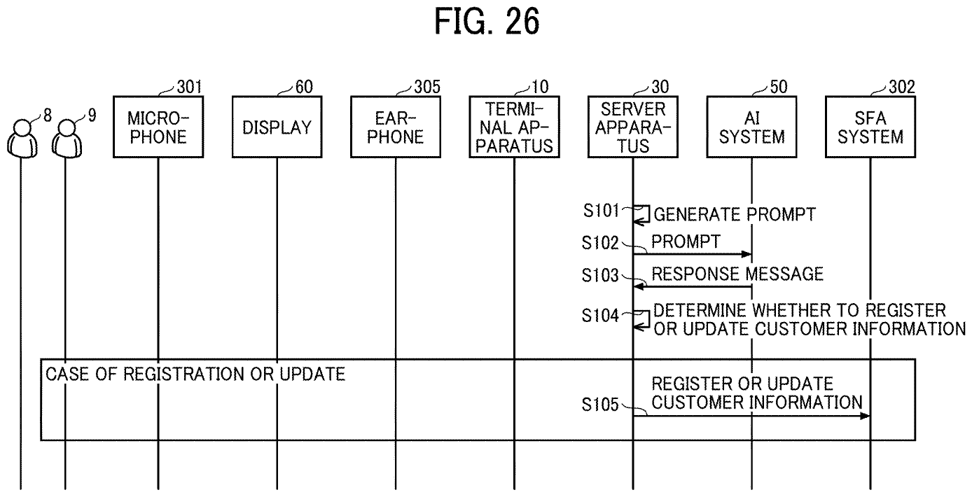

FIG. 26 is a sequence diagram illustrating processing performed by the server apparatus 30 to register or update customer information. The processing illustrated in FIG. 26 may be performed during the business negotiation or after the business negotiation.

In step S101, the control unit 32 determines to register or update customer information in response to acquiring text data during the business negotiation or in response to a business negotiation closing operation after the business negotiation. The control unit 32 requests the AI control unit 37 to generate a prompt using, for example, accumulated text data.

The AI control unit 37 generates a prompt for instructing the AI system 50 to register and update customer information, based on the accumulated text data, the space information 1, the space information 2, the space information 3, the temporarily stored information, information in the various storage units 304, and a system prompt prepared in advance.

A simple example of the system prompt is as follows.
<Example of system prompt> Current customer information is as follows.
{Customer information} Items of customer information are as follows.
{Items of customer information} Based on the following conversation, please extract any unregistered customer information having customer information items from the text data. Please extract any information indicating customer characteristics together with item names even if the information has no customer information items.
Based on the following conversation, please determine customer information that is already registered in an item of customer information but has been changed, and extract customer information to be updated from the text data.
{Conversation text data}
<End of example of system prompt>

In this case, the AI control unit 37 creates a prompt by inserting information retrieved from each storage unit into the {***} portions of the system prompt.

The {Customer information} and {Conversation text data} are contents of the customer information storage unit 51 and the text data storage unit 49, respectively.

The {Items of customer information} may be all the items of the customer information table.

In step S102, the AI control unit 37 inputs the prompt generated as described above to the AI system 50.

In step S103, the AI system 50 generates a response message including customer information to be registered or updated, based on trained parameters. When the conversation text data does not include customer information, the AI system 50 generates a response message indicating that the conversation text data does not include customer information. The AI system 50 transmits the response message to the AI control unit 37. The response acquisition unit 43 of the AI control unit 37 acquires the response from the AI system 50. Depending on a control procedure, the first response is not a final response, and a final response message is obtained by repeatedly performing the processing of steps S102 and S103 a plurality of times. The AI control unit 37 transmits the generated response message to the control unit 32.

In step S104, the control unit 32 determines whether customer information to be registered or updated is included in the response message.

When customer information to be registered or updated is included in the response message, in step S105, the control unit 32 requests the system API 41 to register the customer information by specifying the customer information to be registered or updated and an item name. The system API 41 requests the SFA system 302 to register or update the customer information.

Thus, customer information can be registered or updated without the sales representative 9 having to perform registration or update operations. The server apparatus 30 can also update customer information based on a conversation. For example, when the conversation includes that the customer 8 has “moved”, the AI system 50 determines that the customer 8 has moved. Then, in response to detecting that the customer conversation includes an address, the AI system 50 determines to update an address of the customer information. Alternatively, the AI system 50 determines to update a telephone number, based on the conversation, “I changed my telephone number”.

### Use Scenario for Sales Solutions

The information processing system 1 according to the present embodiment is applicable to a wide variety of business negotiations other than for products. As an example, proposals displayed on the display 60 in a use scenario for a sales solution will be described.

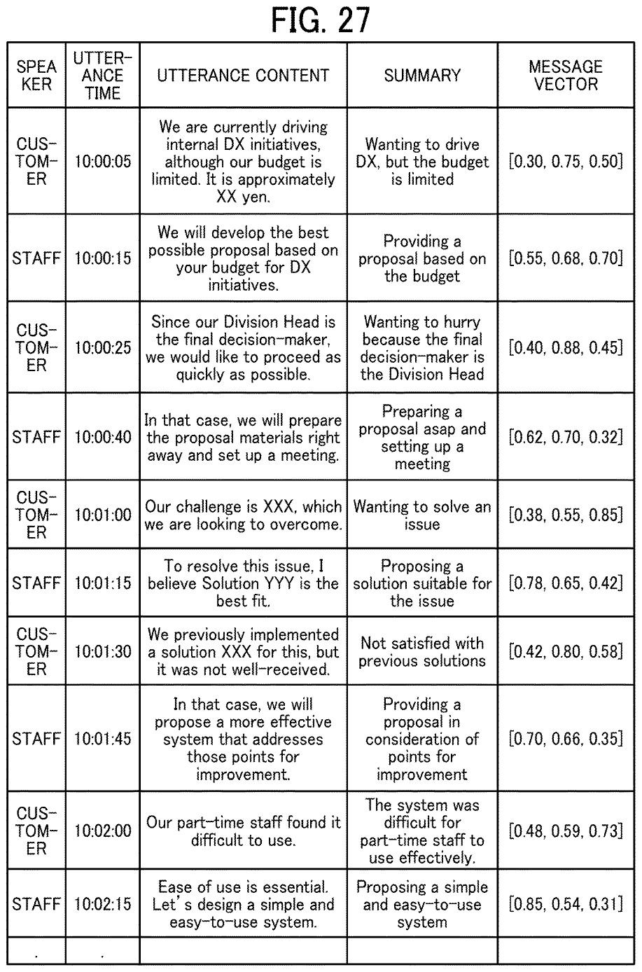

FIG. 27 is a diagram illustrating an example of conversation text data stored in the text data storage unit 49 in a sales solution. The text data illustrated in FIG. 27 has the same items as that of FIG. 4, except for the content of the conversation. Thus, the accumulation unit 36 stores text data of a business negotiation performed in a space in the text data storage unit 49. Processing for displaying an optimal proposal and a predicted proposal may be performed in accordance with the sequence diagram illustrated in FIG. 19.

The customer stated the following:
“We are currently driving internal DX initiatives, although our budget is limited. It is approximately XX yen.
Since our Division Head is the final decision-maker, we would like to proceed as quickly as possible.
Our challenge is XXX, which we are looking to overcome.
We previously implemented a solution XXX for this, but it was not well-received.
Our part-time staff found it difficult to use”.

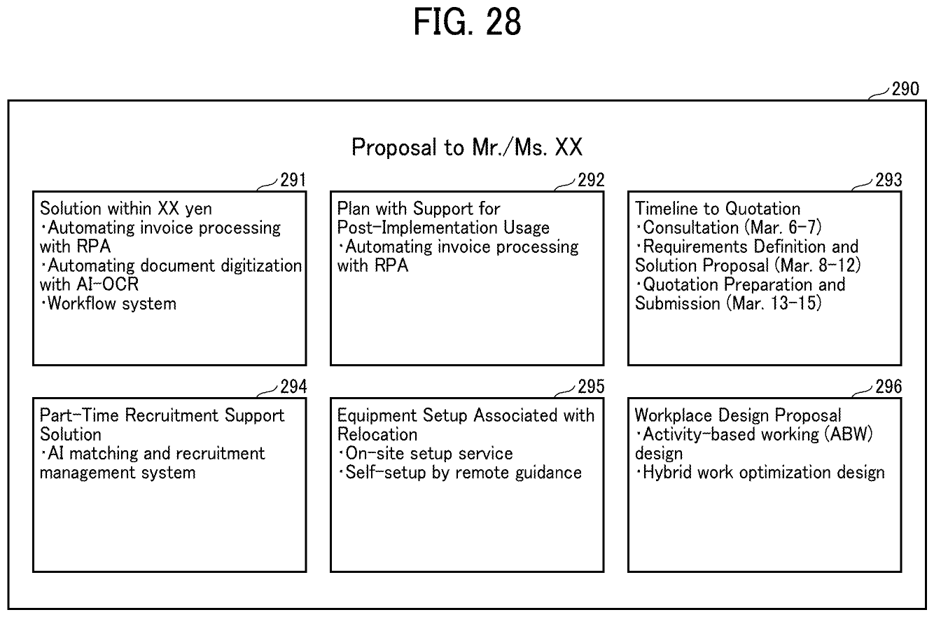

FIG. 28 illustrates a proposal display screen (3) 290 displayed on the display 60 by the server apparatus 30. The proposal display screen (3) 290 displays six proposals generated by the AI system 50. The proposal display screen (3) 290 may have a configuration similar to that of FIG. 20, and differences will be described.

As an example, in FIG. 28, areas 291, 292, and 293 present optimal proposals generated by the AI system 50 based on the conversation information and the customer information. In a sales solution, the optimal proposals are recommended solutions. As an example, in FIG. 28, areas 294, 295, and 296 present predicted proposals predicted by the AI system 50 from text data accumulated by the conversation, although such proposals are not directly requested by the customer in their utterance. In a sales solution, the predicted proposals are proposals anticipating services or products that are not directly mentioned in the conversation but have a high probability of being desired in the future.

(1) The area 291 displays the topic “Solution within XX yen” and a list of proposed solutions. This proposal is an optimal proposal proposed by the AI system 50 by analyzing the customer's utterances “We are currently driving internal DX initiatives” and “our budget is limited. It is approximately XX yen”. The server apparatus 30 acquires a list of products of the proposed optimal proposals from the product information and causes the terminal apparatus 10 to display the list.

(2) The area 292 displays the topic “Plan with support for post-implementation usage” and a list of proposed solutions. This proposal is an optimal proposal proposed by the AI system 50 based on a determination that the customer is seeking a solution with support, as inferred from the customer's utterance, “We . . . implemented a solution . . . , but it was not well-received”. The AI system 50 identifies a solution with support from the list of solutions in the area 291. The server apparatus 30 causes the terminal apparatus 10 to display this optimal proposal.

(3) The area 293 displays the topic “Schedule until quotation” and, as a proposal, a schedule until quotation. This proposal is an optimal proposal proposed by the AI system 50 based on a determination that the customer is seeking a rapid implementation of the solution, as inferred from the customer's utterance, “We would like to proceed quickly”. The AI system 50 generates a general schedule until quotation. The server apparatus 30 causes the terminal apparatus 10 to display this optimal proposal.

(4) The area 294 displays the topic “Part-time recruitment support solution” and a list of proposed solutions. This proposal is a predicted proposal obtained by the AI system 50 analyzing the customer's utterance, “Our part-time staff found it difficult to use”, and anticipating and proposing a service that has a high probability of being desired in the future. That is, the AI system 50 anticipates that the customer will need a part-time recruitment support solution in the near future, based on the customer's desire for part-time staff to master the solution. The server apparatus 30 causes the terminal apparatus 10 to display this predicted proposal.

(5) The area 295 displays the topic “Equipment setup associated with relocation” and a proposal. This proposal is a predicted proposal obtained by the AI system 50 analyzing the customer's utterance, “We are thinking of relocating the office to Shibuya”, and anticipating and proposing a service that has a high probability of being desired in the future. That is, the AI system 50 anticipates that the customer will have a need for an equipment setup service associated with relocation of equipment in the near future, based on the customer's move. The server apparatus 30 causes the terminal apparatus 10 to display this predicted proposal.

(6) The area 296 displays the topic “Workplace design proposal” and a proposal. This proposal is a predicted proposal obtained by the AI system 50 analyzing the customer's utterance, “We are thinking of relocating the office to Shibuya”, and anticipating and proposing a service that has a high probability of being desired in the future. That is, the AI system 50 anticipates that the customer will have a need for a workplace design service for the new office in the near future, based on the customer's move. The server apparatus 30 acquires the predicted proposal and causes the predicted proposal to be displayed on the terminal apparatus 10.

The areas 291 to 296 may display utterances from which the respective proposals are generated. The utterances from which the proposals are generated may be displayed when the sales representative performs an operation. For each proposal, classification of an optimal proposal and a predicted proposal may be displayed.

### Playback of Operation on Proposal Display Screen

The server apparatus 30 may display, on a proposal display screen, a demo video of a product or service in addition to a simple display thereof. In the present embodiment, the space 360 is equipped with the large-screen display 60, which can be effectively utilized.

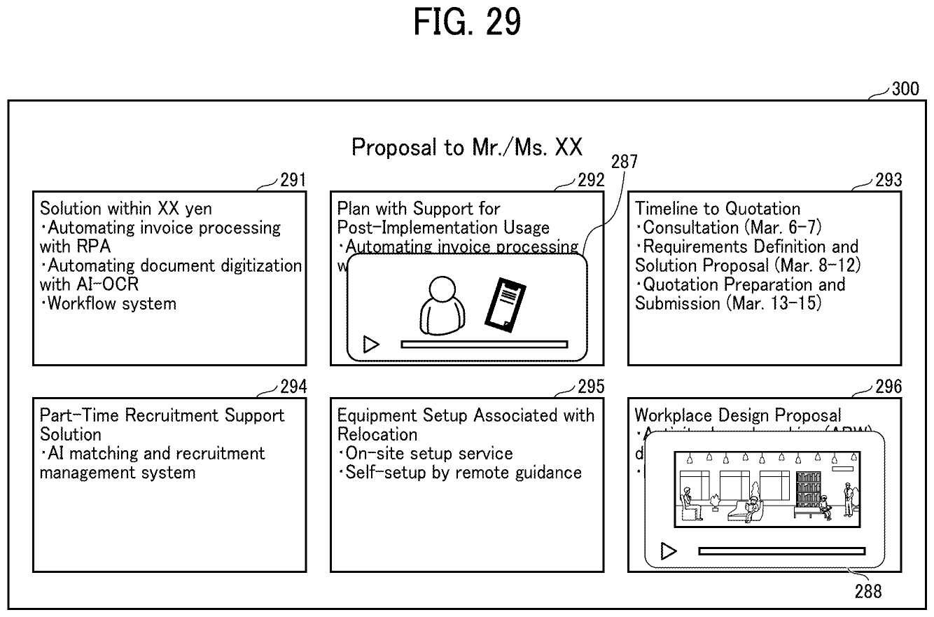

FIG. 29 illustrates a proposal display screen (4) 290 displayed on the display 60 by the server apparatus 30. In the description of FIG. 29, differences from FIG. 28 will be described. On a proposal display screen (4) 300 illustrated in FIG. 29, videos 287 and 288 are played back in the areas 292 and 296, respectively. The videos 287 and 288 are, for example, demo videos of solutions. The AI system 50 acquires demo videos or uniform resource locators (URLs) thereof from the websites of the solutions and passes the demo videos or the URLs to the control unit 32. The demo videos or the URLs may be stored in the product information, and the control unit 32 may retrieve the demo videos or the URLs from a product information database, based on product identification information transmitted from the AI system 50. The control unit 32 acquires the demo videos or the URLs thereof, and causes the display data generation unit 38 to generate display data to be displayed in the areas 292 and 296 of the proposal display screen (4) 300. The demo videos may be embedded in the areas 292 and 296, or the URLs may be embedded in the areas 292 and 296. The display 60 connects to the URLs and downloads the demo videos.

In FIG. 29, the videos 287 and 288 are displayed in the areas 292 and 296, respectively. All of the areas 291 to 296 may display videos. When generating an optimal proposal or a predicted proposal, the AI system 50 determines whether a related video exists on the web. If any related video exists, the AI system 50 passes the related video to the control unit 32 in association with the corresponding area.

Rather than merely playing back the existing videos 287 and 288, the server apparatus 30 may play back videos generated by the AI system 50. Specifically, the server apparatus 30 may transmit, to the AI system 50, an instructive prompt for generating a video tailored to a product or solution, thereby causing the AI system 50 to generate the video. The server apparatus 30 causes the AI system 50 to generate a concept movie combining customer utterances and key points of solutions that can be provided.

A prompt related to generation of a video is, for example, as follows.
<Example of system prompt> Participants of the business negotiation are as follows.
{Customer name, sales representative name} Customer requests registered in advance are as follows.
{Consultation details} A location at which the business negotiation is performed is as follows.
{Business negotiation room} Customer information is as follows.
{Customer information} A list of solutions that can be proposed is as follows.
{Solution product information} Please select and propose a solution optimal for the customer based on the following conversation.
Please anticipate, select, and propose products or services that the customer is highly likely to desire in the future based on the following conversation.
Furthermore, if the dialogue of this business negotiation includes decisions, please indicate the decisions.
Furthermore, if the dialogue of this business negotiation includes an action list, please indicate the action list.
Furthermore, please select a solution optimal for the customer based on the following conversation, and generate one or more videos for promoting sales of the selected solution.
{Conversation text data} Furthermore, the decisions made in the business negotiation so far are as follows.
{Decisions} Furthermore, the action list from the business negotiation so far is as follows.
{Action list}
<End of example of system prompt>

Thus, playback of a video on the display 60 enhances the appeal of a product or service.

### Content Change According to Display Destination

Even when the display 60 and the terminal apparatus 10 display the same screen, it may be desirable to display different information on the display 60 and the terminal apparatus 10 of the sales representative 9. For example, it is desirable that sensitive information, such as cost prices, information on other customers, or internal information, be displayed on the terminal apparatus 10 but not on the display 60. Such information may be hereinafter referred to as confidential information. The control unit 32 of the server apparatus 30 holds, in advance, a confidential information list not to be displayed on the display 60, and controls the confidential information to be displayed only on the terminal apparatus 10.

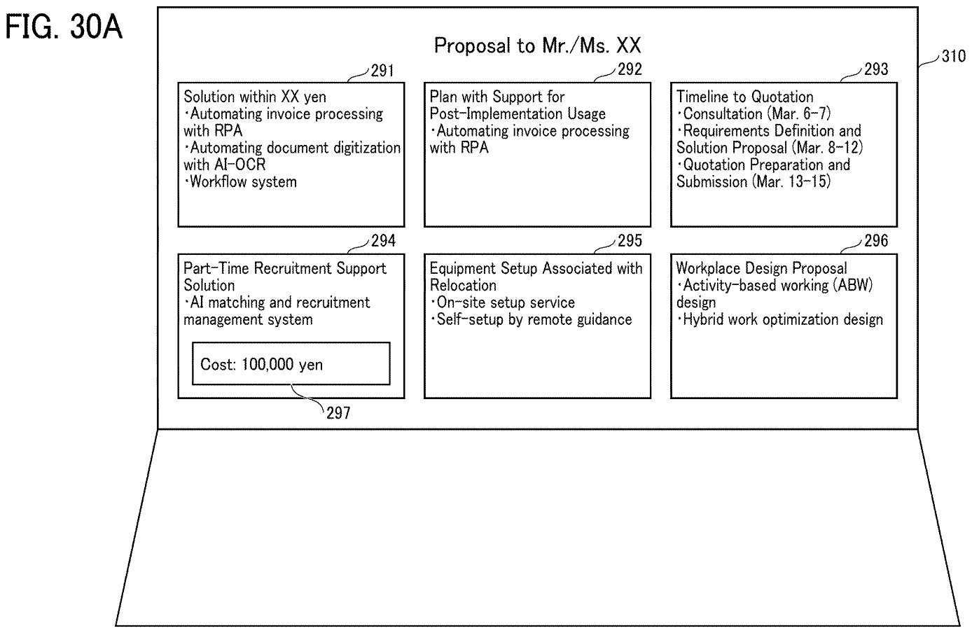

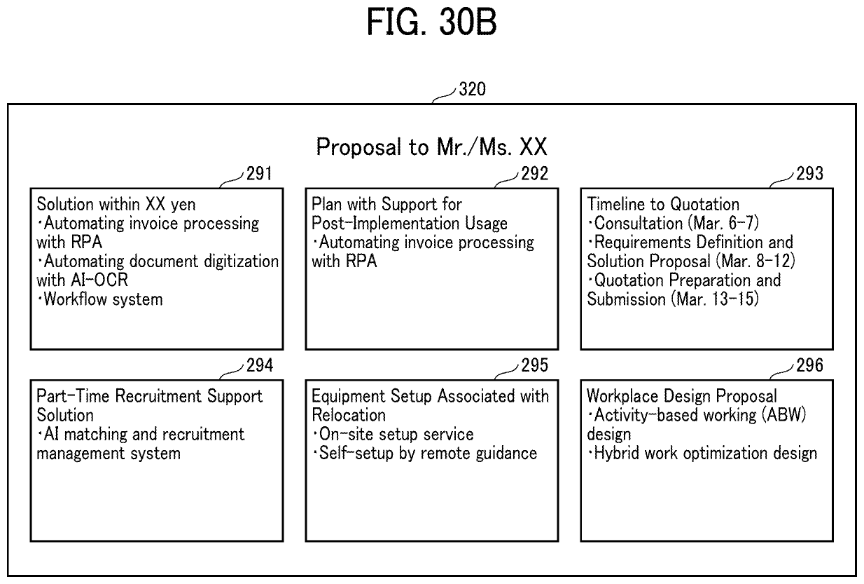

FIGS. 30A and 30B illustrate proposal display screens (5) 310 and 320 displayed on the terminal apparatus 10 and the display 60 by the server apparatus 30, respectively. In the description of FIG. 30, differences from FIG. 28 will be described. FIG. 30A illustrates the proposal display screen (5) 310 displayed on the terminal apparatus 10, and FIG. 30B illustrates the proposal display screen (5) 320 displayed on the display 60. The proposal display screen (5) 310 displays a cost price 297, whereas the proposal display screen (5) 320 does not display a cost price. Thus, the server apparatus 30 can cause confidential information to be displayed only on the terminal apparatus 10.

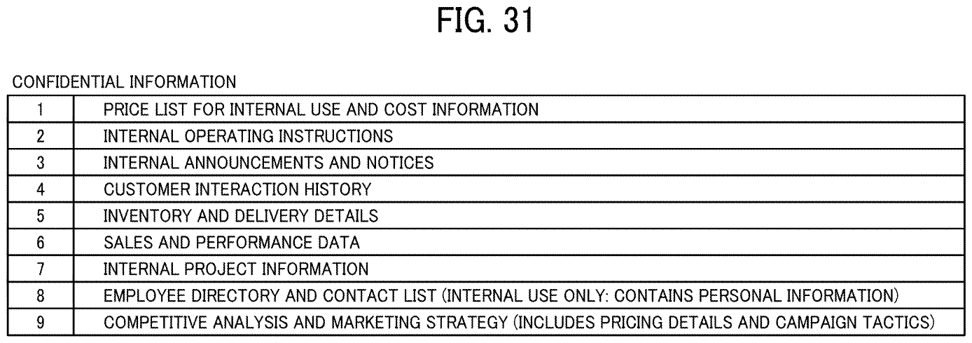

FIG. 31 illustrates an example of confidential information. The AI control unit 37 transmits confidential information to the AI system 50 in advance, and generates a prompt for providing notification when a proposal includes confidential information. Thus, when a proposal includes confidential information, the control unit 32 can identify, via the AI system 50, which portion of the information contained in the proposal is the confidential information. The control unit 32 performs control such that confidential information is displayed on the terminal apparatus 10 and is not displayed on the display 60. In some cases, the product information table includes information to be kept confidential. In such cases, among product information of a product to be proposed retrieved by the control unit 32 from the product information table, product information excluding confidential information is displayed on the display 60, and product information including the confidential information is displayed on the terminal apparatus 10.

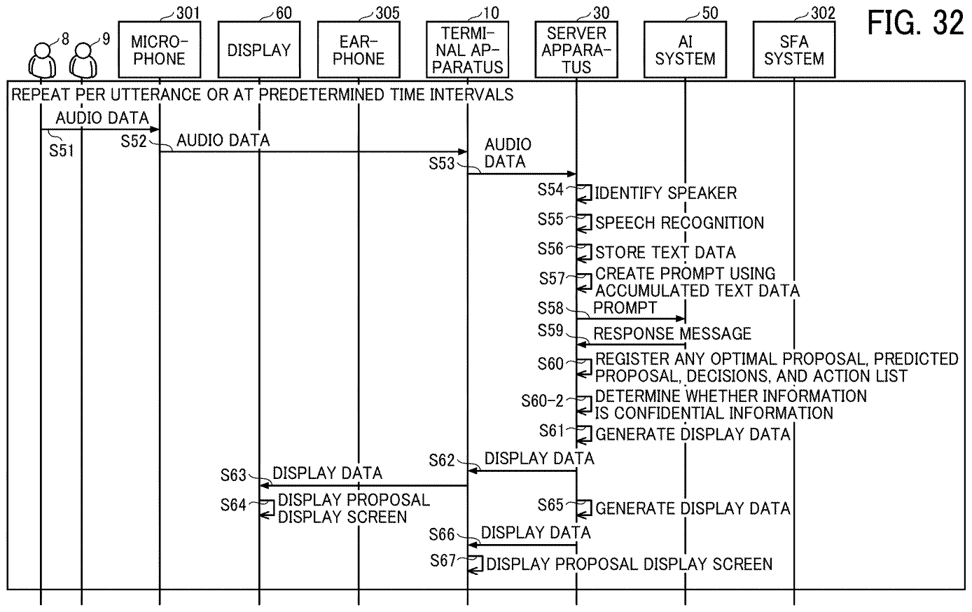

FIG. 32 is a sequence diagram illustrating processing performed by the server apparatus 30 to display a proposal on the terminal apparatus 10 and the display 60. In the description of FIG. 32, differences from FIG. 19 will be described. The processing of steps S51 to S60 may be similar to that of FIG. 19. In the response message, the proposal also includes confidential information.

In response to acquiring the response message from the AI control unit 37, in step S60-2, the control unit 32 determines whether confidential information is included. Since confidential information is included, the control unit 32 determines to generate different display data for the display 60 and for the terminal apparatus 10.

In step S61, the control unit 32 designates the display 60 as the display destination and requests the display data generation unit 38 to generate display data including an optimal proposal and a predicted proposal while omitting the confidential information. The display data generation unit 38 generates display data of a proposal display screen to be displayed on the display 60 to present the optimal proposal and the predicted proposal. This display data is an example of first display data.

In step S62, the transmission unit 39 of the server apparatus 30 transmits the generated display data and information on the display destination (i.e., the display 60) to the terminal apparatus 10.

In steps S63 and S64, the reception unit 14 of the terminal apparatus 10 receives the display data, and passes the display data to the information display unit 16 based on the information on the display destination (i.e., the display 60). The information display unit 16 causes the display 60 to display the proposal display screen (FIG. 30B) based on the display data.

In step S65, the control unit 32 designates the terminal apparatus 10 as the display destination and requests the display data generation unit 38 to generate display data including an optimal proposal and a predicted proposal while leaving the confidential information included. The display data generation unit 38 generates display data of a proposal display screen to be displayed on the terminal apparatus 10 to present the optimal proposal, the predicted proposal, and the confidential information. This display data is an example of second display data.

In step S66, the transmission unit 39 of the server apparatus 30 transmits the generated display data and information on the display destination (i.e., the terminal apparatus 10) to the terminal apparatus 10.

In step S67, the reception unit 14 of the terminal apparatus 10 receives the display data, and passes the display data to the display control unit 15 based on the information on the display destination (i.e., the terminal apparatus 10). The display control unit 15 causes the terminal apparatus 10 to display the proposal display screen (FIG. 30A) based on the display data.

Thus, even if a proposal includes confidential information, the server apparatus 30 can control the confidential information to be displayed only on the terminal apparatus 10. The display control is not limited to the method as described above, and the information display unit 16 of the terminal apparatus 10 may control the display 60 to display a screen different from a screen displayed on the terminal apparatus 10.

### Display of Proposal in Response to Operation by Sales Representative

The terminal apparatus 10 of the sales representative 9 and the display 60 display the same proposal. Alternatively, a different proposal may be displayed on the display 60. Specifically, the proposal displayed on the display 60 may be selected by the sales representative 9.

That is, the server apparatus 30 may initially cause the terminal apparatus 10 to display proposals, and then cause the display 60 to display any proposal selected by the sales representative 9 from among the proposals displayed on the terminal apparatus 10. Thus, the terminal apparatus 10 of the sales representative 9 and the display 60 can display different content. In addition, the sales representative 9 can select a product to be promoted and display the product to the customer 8.

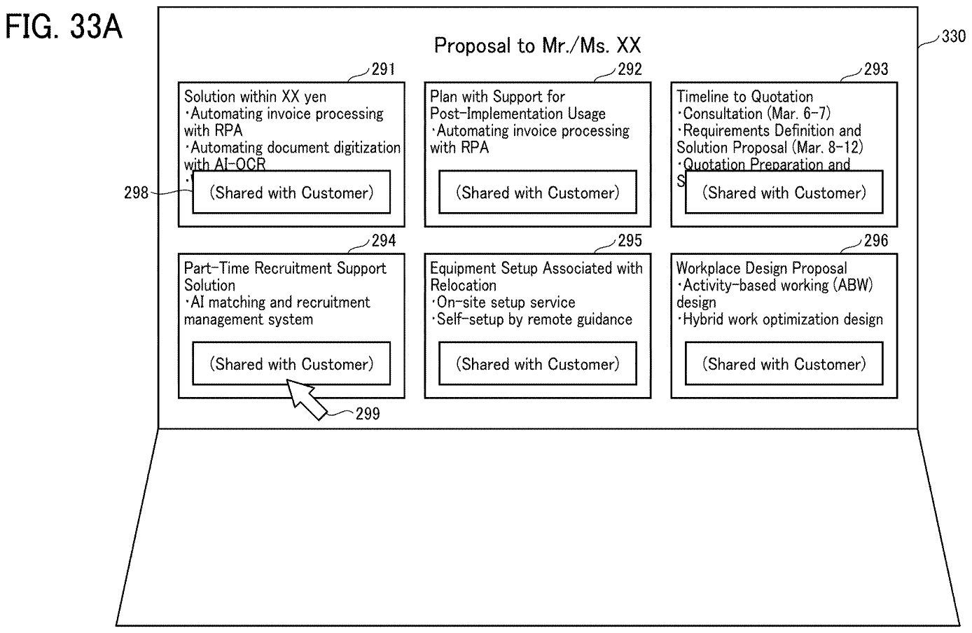

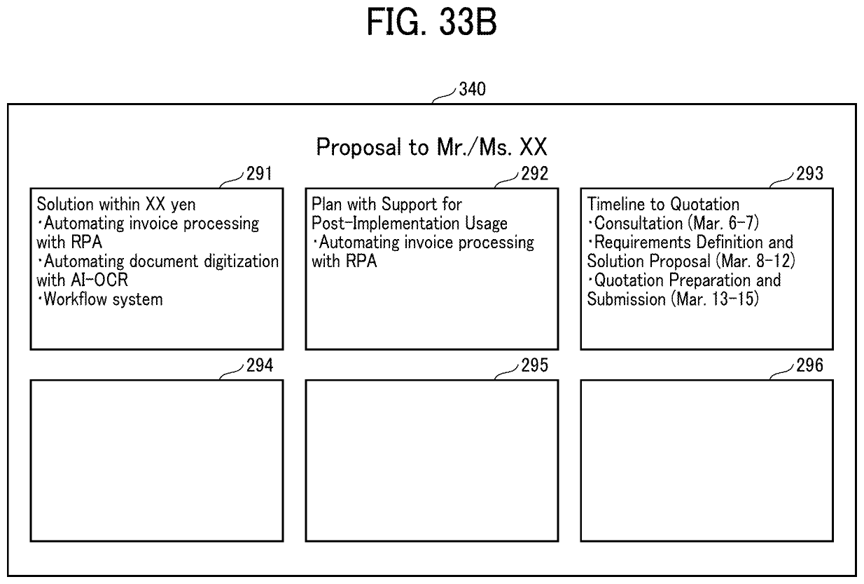

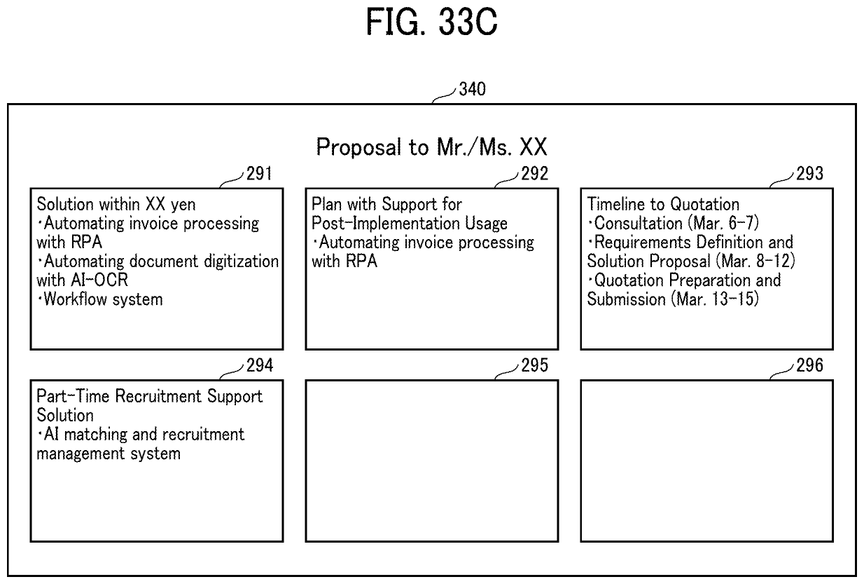

FIGS. 33A, 33B, and 33C illustrate proposal display screens (6) 330 and 340 displayed on the terminal apparatus 10 and the display 60 by the server apparatus 30. In the description of FIG. 33, differences from FIG. 28 will be described. FIG. 33A illustrates the proposal display screen (6) 330 displayed on the terminal apparatus 10, and FIGS. 33B and 33C illustrate the proposal display screen (6) 340 displayed on the display 60. The proposal display screen (6) 330 displays a display button 298 in each of the areas 291 to 296. When the display button 298 is pressed by a mouse cursor 299 or a tap operation, the proposal presented in the corresponding area is also displayed on the display 60.

On the proposal display screen (6) 340 illustrated in FIG. 33B, the proposals in the areas 291 to 293 are displayed, whereas the proposals in the areas 294 to 296 are not displayed. In response to the sales representative 9 pressing the display button 298 in the area 294 when the proposal display screen (6) 340 illustrated in FIG. 33B is displayed on the display 60, as illustrated in FIG. 33C, the area 294 on the display 60 displays the same proposal.

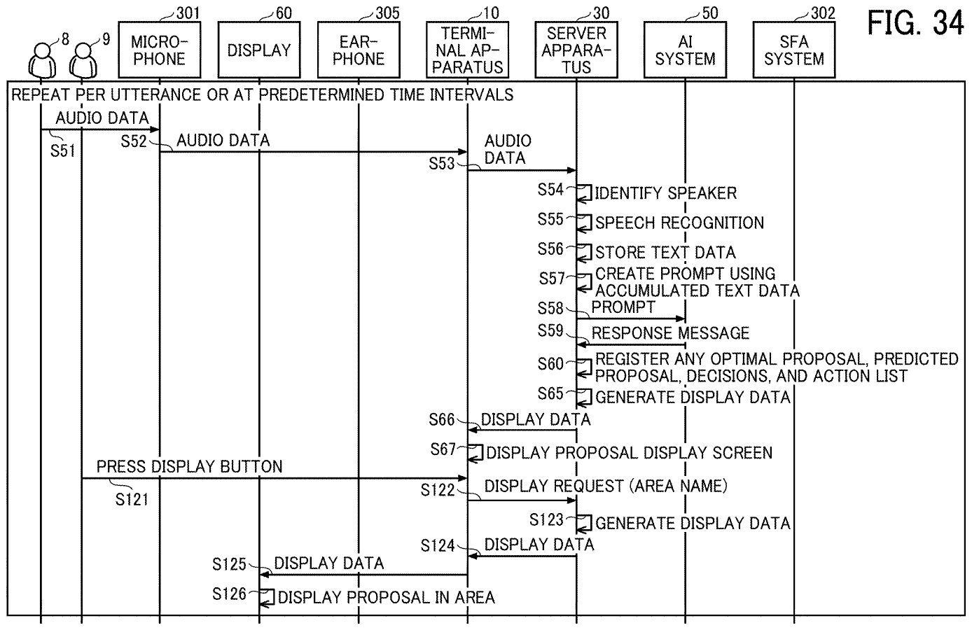

FIG. 34 is a sequence diagram illustrating processing performed by the server apparatus 30 to display a proposal on the terminal apparatus 10 and the display 60 based on audio data, the space information 1, the space information 2, and the space information 3 in accordance with an operation by the sales representative 9. In the description of FIG. 34, differences from FIG. 19 will be described. The processing of steps S51 to S60 may be similar to that of FIG. 19.

In step S65, the control unit 32 designates the terminal apparatus 10 as the display destination and requests the display data generation unit 38 to generate display data including an optimal proposal and a predicted proposal. The display data generation unit 38 generates display data of a proposal display screen to be displayed on the terminal apparatus 10 to present the optimal proposal and the predicted proposal. The display data generation unit 38 arranges the display button 298 in each area.

In step S66, the transmission unit 39 of the server apparatus 30 transmits the generated display data and information on the display destination (i.e., the terminal apparatus 10) to the terminal apparatus 10.

In step S67, the reception unit 14 of the terminal apparatus 10 receives the display data, and passes the display data to the display control unit 15 based on the information on the display destination (i.e., the terminal apparatus 10). The display control unit 15 causes the terminal apparatus 10 to display the proposal display screen (FIG. 33A) based on the display data.

In step S121, the sales representative 9 confirms the proposal and then presses the display button 298 to select a proposal (e.g., a product or service) to be presented to the customer 8. The operation reception unit 13 accepts the press of the display button 298.

In step S122, the transmission unit 12 of the terminal apparatus 10 transmits, to the server apparatus 30, a display request for displaying a proposal with a designated area name.

In step S123, the reception unit 31 of the server apparatus 30 receives the display request as operation information and notifies the control unit 32 of the display request. In response to the display request, the control unit 32 specifies the area name and the display destination (i.e., the display 60), and requests the display data generation unit 38 to generate display data for the area. The display data generation unit 38 generates display data for displaying, on the display 60, the optimal proposal or predicted proposal displayed in the area. The display data may be display data only for the corresponding area.

In step S124, the transmission unit 39 of the server apparatus 30 transmits the generated display data and information on the display destination (i.e., the display 60) to the terminal apparatus 10. The display data specifies the area.

In steps S125 and S126, the reception unit 14 of the terminal apparatus 10 receives the display data, and passes the display data to the information display unit 16 based on the information on the display destination (i.e., the display 60). Based on the display data, the information display unit 16 causes the optimal proposal or the predicted proposal to be displayed in the specified area of the proposal display screen (FIG. 33C) displayed on the display 60.

Thus, proposals are first displayed on the terminal apparatus 10 and the sales representative 9 selects a proposal to be presented. Thus, the sales representative 9 can select a product to be promoted and display the product to the customer 8. The display control is not limited to the method as described above, and the information display unit 16 of the terminal apparatus 10 may control the display 60 to display a screen different from a screen displayed on the terminal apparatus 10.

### Voice Message Output from Earphone

A supervisor who is monitoring a conversation between a customer and a sale representative is allowed to whisper effective instructions exclusively to the sales representative. In the present embodiment, the AI system 50 allows the supervisor to provide such effective instructions privately to the sales representative.

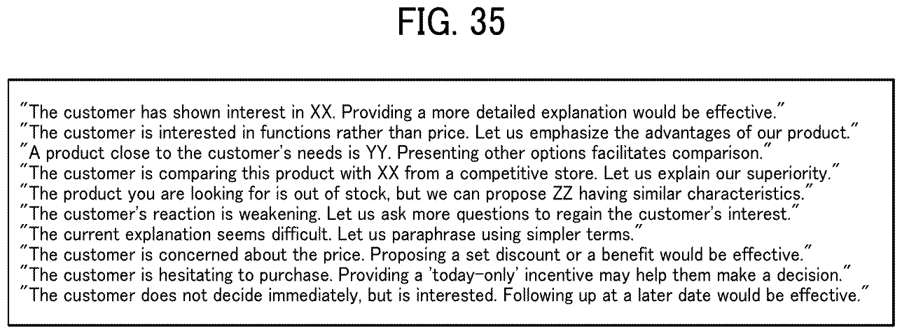

FIG. 35 illustrates example proposals provided via voice messages delivered through the earphone 305 by the AI system 50 based on a conversation.

“The customer has shown interest in XX. Providing a more detailed explanation would be effective.”

This message is based on a keyword of high interest to the customer. Since the AI system 50 has detected a keyword of high interest to the customer, the AI system 50 instructs the sales representative to provide a detailed explanation of functions for which the customer has demonstrated purchase intent.

“The customer is interested in functions rather than price. Let us emphasize the advantages of our product.”

This message indicates a hint for appropriate product proposal. Since the AI system 50 has detected what the customer is interested in, the AI system 50 instructs the sales representative to provide a detailed explanation of functions in which the customer has shown interest.

“A product close to the customer's needs is YY. Presenting other options facilitates comparison.”

This message indicates a hint for appropriate product proposal. Since the AI system 50 has detected a product close to the customer's needs, the AI system 50 instructs the sales representative to propose a more appropriate product.

“The customer is comparing this product with XX from a competitive store. Let us explain our superiority.”

This message indicates a point of competitive comparison. Since the AI system 50 has detected that the customer is comparing the proposed product with a competitor's product, the AI system 50 instructs the sales representative to explain the superiority.

“The product you are looking for is out of stock, but we can propose ZZ having similar characteristics.”

This message indicates inventory status and an alternative proposal. Since the AI system 50 has detected that the product is out of stock, the AI system 50 instructs the sales representative to explain a similar product.

“The customer's reaction is weakening. Let us ask more questions to regain the customer's interest.”

This message is based on detection of a change in the attitude of the customer. Since the AI system 50 has detected a change in the customer's reaction, the AI system 50 provides the sales representative with instructions such as asking questions and changing topics.

“The current explanation seems difficult. Let us paraphrase using simpler terms.”

This provides a simplified paraphrase of technical terms. Since the AI system 50 has determined that the explanation is difficult to understand, the AI system 50 advises the sales representative to explain using simpler words.

“The customer is concerned about the price. Proposing a set discount or a benefit would be effective.”

This is advice for price negotiation. Since the AI system 50 has detected that the customer has concerns regarding the price, the AI system 50 instructs the sales representative to explain that the price is justified.

“The customer is hesitating to purchase. Providing a ‘today-only’ incentive may help them make a decision.”

This indicates timing for closing the business negotiation. Since the AI system 50 has detected that the customer is close to purchasing, the AI system 50 instructs the sales representative to present information for encouraging decision.

“The customer does not decide immediately, but is interested. Following up at a later date would be effective.”

This indicates the need for a follow-up. Since the AI system 50 has detected that the customer does not purchase but may purchase later, the AI system 50 instructs the sales representative to follow up without fail.

The AI control unit 37 generates a prompt below to request the AI system 50 to generate an instruction to the earphone 305. Other configurations of the prompt may be similar to those for optimal proposals and predicted proposals.

“Based on the following conversation, please generate advice effective for the sales representative to help close the business negotiation. For example, this is a kind of information that a supervisor monitoring a conversation between the customer and the sales representative would like to whisper exclusively to the sales representative.”

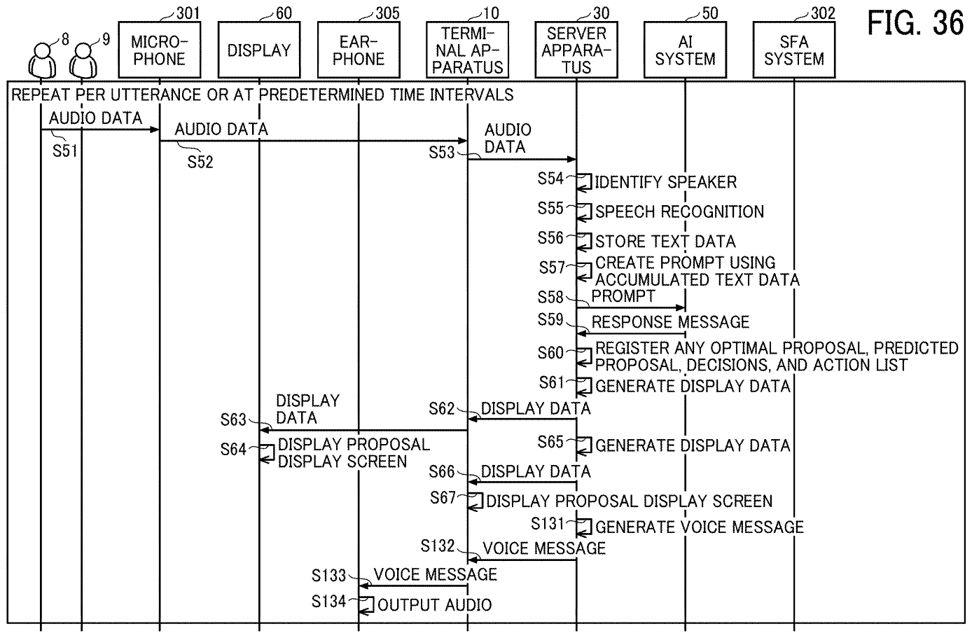

FIG. 36 is a sequence diagram illustrating processing performed by the server apparatus 30 to output a voice message from the earphone 305 based on audio data, the space information 1, the space information 2, and the space information 3. In the description of FIG. 36, differences from FIG. 19 will be described. The processing of steps S51 to S67 may be similar to that of FIG. 19.

When the response message from the AI system 50 includes an instruction to the sales representative 9, in step S131, the control unit 32 designates the earphone 305 as the output destination and requests the display data generation unit 38 to generate a voice message. The display data generation unit 38 generates a voice message to output the instruction to the earphone 305. Another example of the voice message to be generated may be audio data generated by converting the content of display data generated in step S65 into text and reading the text aloud, or may be audio data generated by reading aloud text summarizing the content of the display data.

In step S132, the transmission unit 39 of the server apparatus 30 transmits the generated voice message and information on the output destination (i.e., the earphone 305) to the terminal apparatus 10.

In steps S133 and S134, the reception unit 14 of the terminal apparatus 10 receives the voice message and passes the voice message to the voice message output unit 17 based on the information on the output destination (i.e., the earphone 305). The voice message output unit 17 causes the earphone 305 to output audio based on the voice message.

Thus, the AI system 50 can provide effective instructions exclusively to the sales representative 9, based on the conversation.

Rather than simply proposing a product based on a conversation, the server apparatus 30 causes the AI system 50 to recognize the situation within a space and propose a product or service. Thus, an appropriate product or service can be proposed.

### Second Embodiment

A second embodiment of the present disclosure describes a server apparatus 30 configured to visualize a customer's emotion detected by an emotion sensor during a conversation and provide advice on appropriate measures based on the emotion.

### Functions

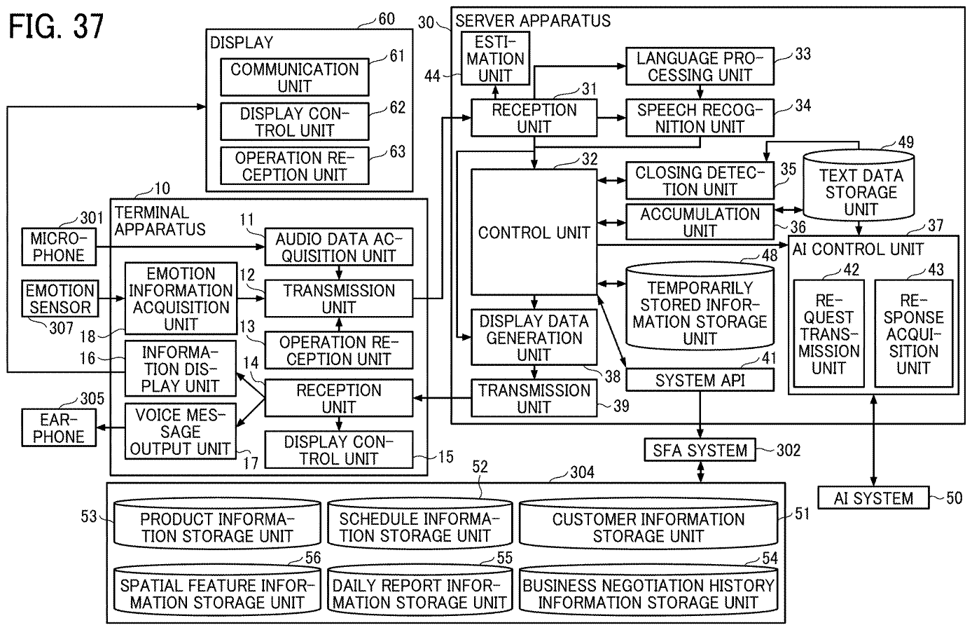

FIG. 37 is a diagram illustrating an example functional configuration of the information processing system 1 according to the present embodiment. In the description of FIG. 37, identical or similar reference signs are given to functional units similar to those in FIG. 3, and the description of the functional units is omitted.

The terminal apparatus 10 further includes an emotion information acquisition unit 18. The emotion information acquisition unit 18 acquires customer emotion information from an emotion sensor 307. An example function of the emotion sensor 307 will be described.

The emotion sensor 307 includes a Doppler-based pulse wave measurement unit and a microcomputer that analyzes pulse wave data by a library. The Doppler-based pulse wave measurement unit and the microcomputer are integrated into a single sensor. This allows the emotion sensor 307 to perform, at the edge, predetermined information processing for acquisition of biological information such as vital data, emotion analysis, and visualization. Specifically, the emotion sensor 307 uses a 24 GHz Doppler sensor to measure a pulse wave without contact. The emotion sensor 307 analyzes the measured pulse wave shape and fluctuation of pulse interval by using the microcomputer, and determines the states of brain activity (central nervous system) and the autonomic nerve system. Then, by a predetermined algorithm, the emotion sensor 307 estimates emotions in real time, such as “concentration (immersion)”, “relaxation”, “drowsiness (boredom or lethargy)”, “fatigue”, “arousal (tension or energy)”, and “exhaustion (degree of burnout)”, and “visualizes” the emotions using numerical values. The emotion sensor 307 performs non-contact measurement of emotion information of a person within a range from close proximity to several meters. The emotion sensor 307 detects emotion information at predetermined time intervals.

The emotion sensor 307 may be a contact or non-contact sensor. The customer may wear the emotion sensor 307 in any way, such as around the neck, as a wristwatch, or integrated into a hat. The emotion sensor 307 may be installed away from the customer to acquire emotion information remotely. The emotion sensor 307 may estimate emotions using, for example, voice tone and speaking speed of a person, in addition to the person's vital data.

The transmission unit 12 transmits the emotion information to the server apparatus 30 together with the audio data. In the server apparatus 30, the display data generation unit 38 generates display data for visualizing and displaying the emotions of the customer during the business negotiation.

Instead of the emotion sensor 307, an estimation unit 44 of the server apparatus 30 may estimate emotions using one or more of vital data, voice tone, and speaking speed. In this case, the vital data is transmitted to the server apparatus 30. Emotions may be estimated by an external server rather than the server apparatus 30, or at least one of vital data and audio data for analyzing voice tone and speaking speed may be transmitted to the AI system 50, and the AI system 50 may estimate emotions.

### Display of Proposal Based on Audio Data

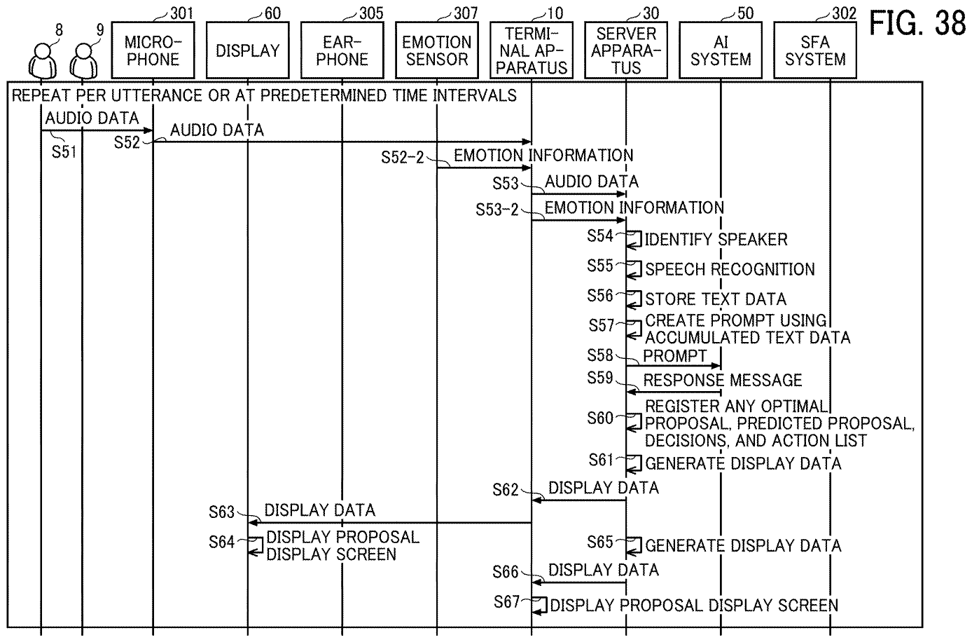

FIG. 38 is a sequence diagram illustrating processing performed by the server apparatus 30 to display a proposal based on audio data acquired from the space 360, the space information 1, the space information 2, and the space information 3, and to display emotion information. In the description of FIG. 38, differences from FIG. 19 will be described.

In step S52-2, the emotion information acquisition unit 18 of the terminal apparatus 10 acquires emotion information from the emotion sensor 307.

In step S53-2, the transmission unit 12 transmits the emotion information to the server apparatus 30 in real time or at intervals of a predetermined time period. The timing of transmitting the audio data and the timing of transmitting the emotion information are not necessarily the same.

Subsequent processing is the same as that of FIG. 19, except that, in step S65, the control unit 32 designates the terminal apparatus 10 as the display destination and requests the display data generation unit 38 to generate display data including an optimal proposal and a predicted proposal. In the present embodiment, furthermore, the control unit 32 designates the terminal apparatus 10 as the display destination and requests the display data generation unit 38 to generate display data including the emotion information. The display data generation unit 38 generates display data of a proposal display screen to be displayed on the terminal apparatus 10 to present the optimal proposal, the predicted proposal, and the emotion information.

The control unit 32 may also request the AI system 50 to provide information for improving the emotion information of the customer. An example system prompt will be presented. This system prompt is an instruction to generate a proposal based on the emotion information.
<Example of system prompt> Emotion information of participants of the business negotiation will be transmitted.
{Emotion information} When customer emotion information is unsuitable for the business negotiation such as negative emotion information (e.g., low concentration, high drowsiness, low arousal, or high exhaustion), please generate information for improving the emotion information.
<End of example of system prompt>

This system prompt allows the AI system 50 to propose, for example, information for turning negative emotions into positive emotions. For example, the AI system 50 provides a proposal such as “How about taking a break?” or a suggestion such as “The customer's concentration seems to be decreasing”. These proposals are also included in the display data and transmitted to the terminal apparatus 10. The transmission unit 39 may transmit information for improving the emotion information to the earphone 305 as audio data.

The server apparatus 30 may acquire information for improving the emotion information from another server without using the AI system 50, or the server apparatus 30 may generate information for improving the emotion information.

In step S66, the transmission unit 39 of the server apparatus 30 transmits the generated display data, including emotion information, and information on the display destination (i.e., the terminal apparatus 10) to the terminal apparatus 10.

In step S67, the reception unit 14 of the terminal apparatus 10 receives the display data, and passes the display data to the display control unit 15 based on the information on the display destination (i.e., the terminal apparatus 10). The display control unit 15 causes the terminal apparatus 10 to display the proposal display screen based on the display data. The proposal display screen displays the emotion information.

### Example Screen

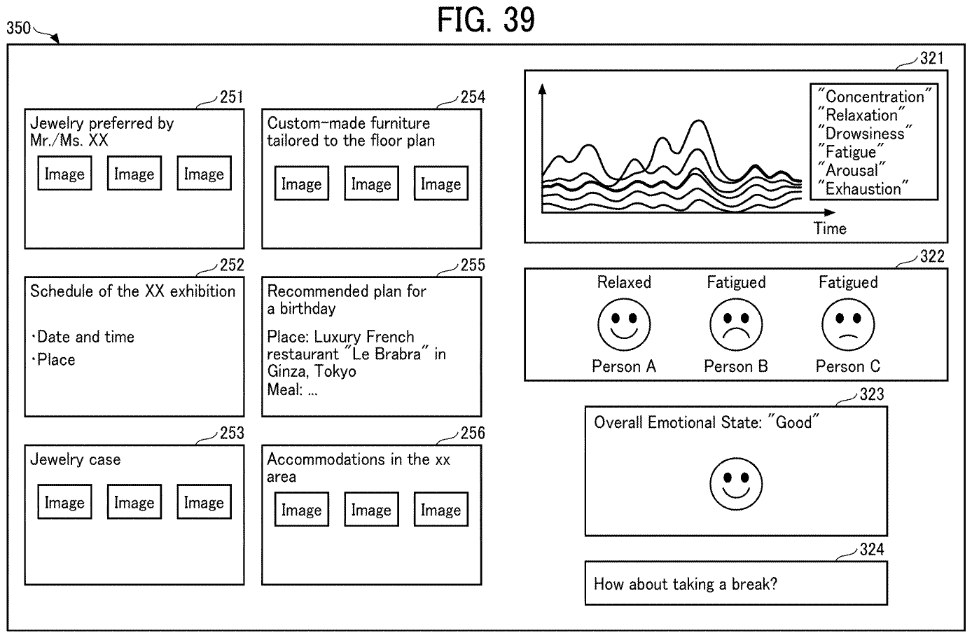

FIG. 39 illustrates a proposal display screen (7) 350 displayed on the terminal apparatus 10 by the server apparatus 30. The proposal display screen (7) 350 includes areas 251 to 256 that display six proposals generated by the AI system 50, and emotion information areas 321 to 323 that display emotion information.

The emotion information area 321 displays transitions of customer emotions in real time during the business negotiation in chronological order. Customer emotion information (concentration, relaxation, drowsiness, fatigue, and arousal) is color-coded, with their intensity transitions over time displayed in a graph. Emotion information of a sales representative may also be displayed in addition to the customer emotion information.

In the emotion information area 322, current emotion of each customer participating in the business negotiation is displayed as an icon. In FIG. 39, three customers participate in the business negotiation, and respective current emotions of the three customers are displayed. Each icon is labeled with an emotion name above and a customer name below. The current emotion of each customer is updated, for example, at intervals of a predetermined time period or each time the emotion changes.

In the emotion information area 323, emotion information summarizing emotions of a plurality of customers is displayed as an icon. The emotion information of the summarized emotions may represent, for example, the average of the emotions of the customers, the most frequent emotion, or the emotion least suitable for the business negotiation. This allows the sales representative to grasp the customer reactions at a glance. The emotion information summarizing the emotions of the customers is updated at intervals of a predetermined time period or each time the emotion changes.

The proposal display screen (7) 350 further includes an advice display field 324 that displays information generated by the AI system 50 to enhance customer emotion information. This allows the sales representative to proceed with the business negotiation with reference to this information as appropriate.

In addition to the effects of the first embodiment, the present embodiment allows a sales representative to monitor customer emotion information during a business negotiation, enabling the sales representative to appropriately proceed with the business negotiation based on customer emotions. Since information for improving customer emotion information is displayed, the sales representative can guide the customer toward an emotional state suitable for the business negotiation.

### Third Embodiment

A third embodiment of the present disclosure describes a server apparatus 30 that, after a business negotiation, registers information generated during the business negotiation in an external service system 308. Unlike existing methods in which meeting minutes are manually registered in the external service system 308, the present embodiment automates integration with the external service system 308.

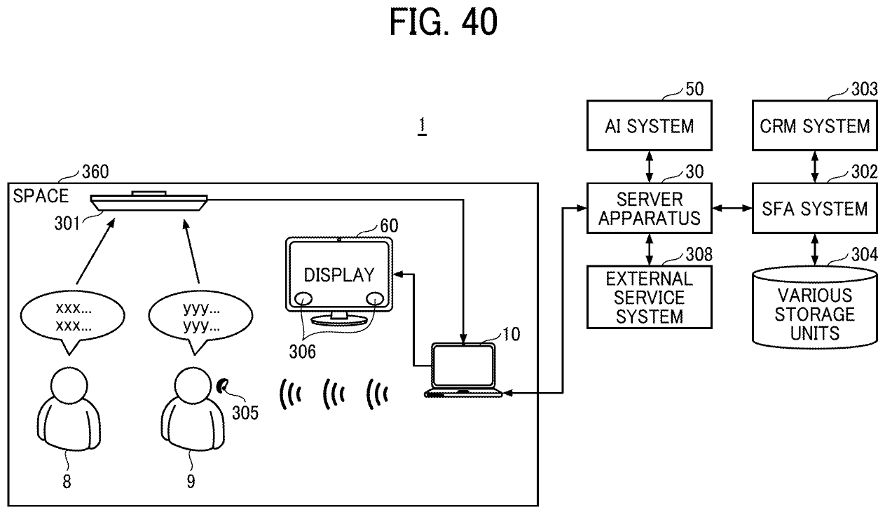

FIG. 40 is a diagram illustrating an example system configuration of the information processing system 1. In the description of FIG. 40, differences from FIG. 1 will be described. In the information processing system 1 according to the present embodiment, the server apparatus 30 is configured to cooperate with the external service system 308. The external service system 308 provides not only a storage service but also a service for managing information in a form suitable for the information.

The external service system 308 may be, for example, a cloud service by which an application can be created with no code to implement systematization and efficiency enhancement of business. The external service system 308 centrally manages, for example, customer information, case management, and task progress. Flexible customization of items is possible, and linkage with other services is also possible. The external service system 308 allows a user without knowledge of programming to construct an internal business application according to the needs of the company. The external service system 308 can also be used as a storage to store and share files and data.

The external service system 308 may be, for example, a customer management system. The external service system 308 centrally manages, for example, customer information, business negotiation history, and activity logs, and optimizes sales activities. With abundant analysis functions and dashboards, the external service system 308 supports decision making, enables cooperation with various extension applications, and automates business processes. The external service system 308 also has a storage function to store files and documents.

The external service system 308 may be, for example, an online whiteboard tool. The external service system 308 is an infinite-canvas whiteboard tool usable online. The external service system 308 allows, for example, sticky notes, graphics, and images to be placed anywhere as desired, and is suitable for ideation and meetings. The external service system 308 allows a plurality of persons to edit simultaneously, facilitating remote collaboration. The external service system 308 provides a wide variety of templates, supporting business workflows and mind map creation. Created boards are stored on the cloud and function as storage.

The external service system 308 may be, for example, a note-taking app. Since the note-taking app is AI-powered, the external service system 308 is suitable for information organization and learning assistance. Based on input materials and notes, the external service system 308 causes AI to summarize content and answer questions. The external service system 308 enables efficient knowledge accumulation and retrieval, and is suitable for research and learning assistance. This allows a user to upload a document and interact with AI. Stored materials are stored on the cloud.

### Functions

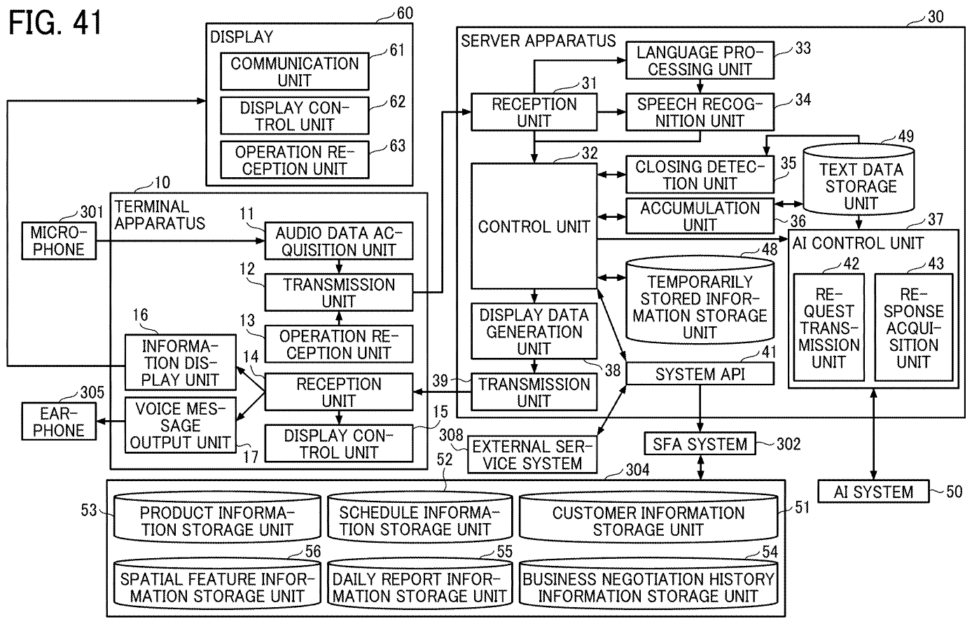

FIG. 41 is a diagram illustrating an example functional configuration of the information processing system 1 according to the present embodiment. In the description of FIG. 41, identical or similar reference signs are given to functional units similar to those in FIG. 3, and the description of the functional units is omitted.

The system API 41 of the server apparatus 30 is communicable with the external service system 308. The system API 41 converts information generated during a business negotiation into a data format suitable for the external service system 308 and exports (registers) the information. Furthermore, the system API 41 imports information generated during a business negotiation and stored in the external service system 308 by converting the information into a data format in the server apparatus 30.

### Registration of Information Generated During Business Negotiation

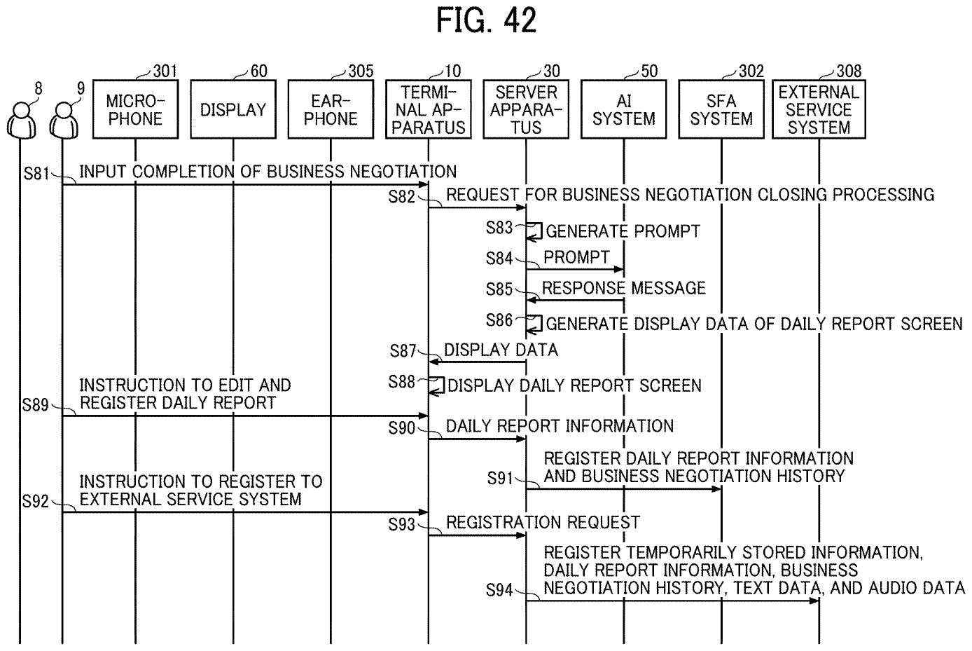

FIG. 42 is a sequence diagram illustrating processing performed by the server apparatus 30 to register information generated during a business negotiation in the external service system 308. In the description of FIG. 42, differences from FIG. 24 will be described. The processing of steps S81 to S91 may be similar to that of FIG. 24.

In step S92, the sales representative 9, who has registered the daily report and the business negotiation history, performs an operation on the terminal apparatus 10 to register information generated during the business negotiation in the external service system 308. The terminal apparatus 10 receives the operation of registering the information. The information generated during the business negotiation includes temporarily stored information, daily report information, business negotiation history, text data, and audio data. The information generated during the business negotiation may be registered by the sales representative 9, or after step S91, the server apparatus 30 may automatically start registering the information generated during the business negotiation in the external service system 308. Thus, cooperation can be implemented automatically without manual operation.

In step S93, the transmission unit 12 of the terminal apparatus 10 transmits a registration request for registering the information generated during the business negotiation to the server apparatus 30.

In step S94, the reception unit 31 of the server apparatus 30 receives the registration request and notifies the control unit 32 of the registration request.

The control unit 32 requests the system API 41 to register the temporarily stored information, the daily report information, the business negotiation history, the text data, and the audio data by designation. In addition, for example, a summary of text data for each utterance and a summary of text data for each speaker may be registered. The system API 41 converts these items into a data format of the external service system 308 at the registration destination, and requests the external service system 308 to register the items in association with identification information of the business negotiation. The data format of the external service system 308 at the registration destination is known. For example, when the external service system 308 is configured to create a business application with no code, information is stored in a tabular form, and thus information to be stored is associated with each column of the table and is converted into a tabular data format. At this time, the system API 41 creates a correspondence table indicating in which columns the temporarily stored information, the daily report information, the business negotiation history, the text data, and the audio data are stored. For information having a plurality of items, such as the temporarily stored information, a correspondence table between the items and respective columns is created. Thus, the system API 41 can import the temporarily stored information, the daily report information, the business negotiation history, the text data, and the audio data from the external service system 308.

### Download of Information Generated During Business Negotiation

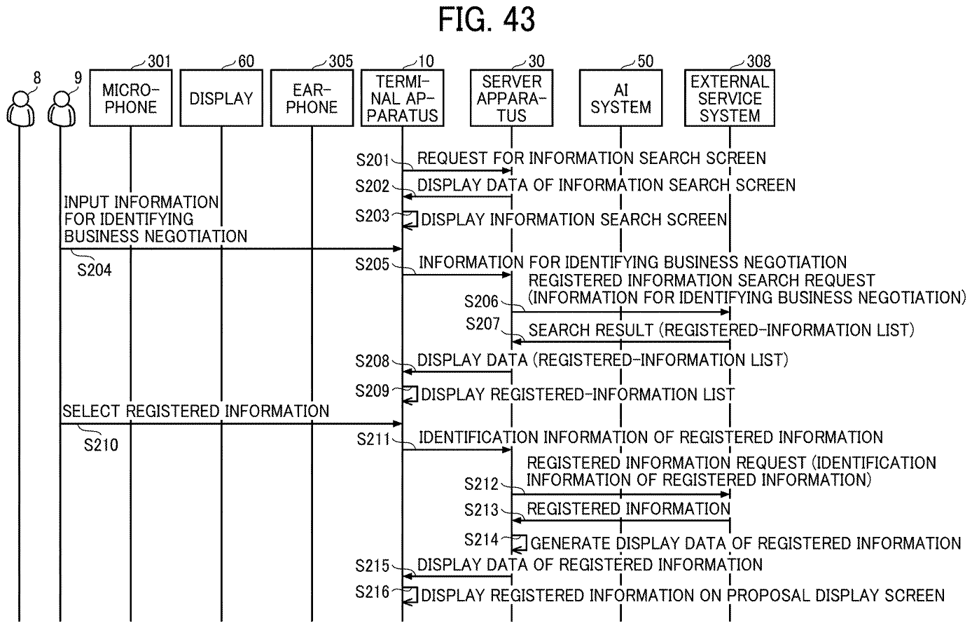

FIG. 43 is a sequence diagram illustrating processing and operations for allowing the sales representative 9 to download, from the external service system 308, information generated during a business negotiation. Information generated during the business negotiation and registered in the external service system 308 may be conveniently referred to as “registered information”.

In step S201, the sales representative 9 operates the terminal apparatus 10 to activate the information processing system 1. In response to the operation by the sales representative 9, the transmission unit 12 of the terminal apparatus 10 requests the server apparatus 30 for an information search screen. The information search screen is a screen for searching registered information registered in the external service system 308.

In step S202, the reception unit 31 of the server apparatus 30 receives the request, and the control unit 32 causes the display data generation unit 38 to generate display data of the information search screen. The information search screen is displayed only on the terminal apparatus 10. The display data generation unit 38 generates display data of the information search screen, and the transmission unit 39 transmits the display data of the information search screen to the terminal apparatus 10 together with information on the display destination (i.e., the terminal apparatus 10).

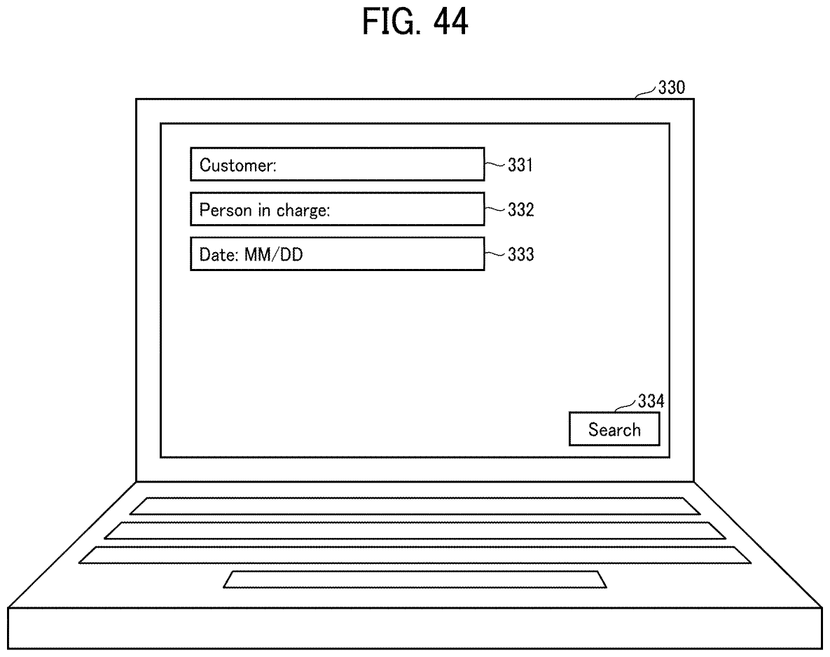

In step S203, the reception unit 14 of the terminal apparatus 10 receives the display data, and passes the display data to the display control unit 15 based on the information on the display destination (i.e., the terminal apparatus 10). The display control unit 15 causes the terminal apparatus 10 to display the information search screen based on the display data. At this point in time, a blank form screen (see FIG. 44) is displayed.

In step S204, the sales representative 9 inputs information from which the business negotiation can be identified to the search screen to identify registered information to be downloaded. Examples of the information from which the business negotiation can be identified may include a sales representative name, a customer name, and the date of the business negotiation. The operation reception unit 13 receives the input.

In step S205, the transmission unit 12 of the terminal apparatus 10 transmits a search request to the server apparatus 30 together with the input information from which the business negotiation can be identified.

In step S206, the reception unit 31 of the server apparatus 30 receives the search request, and then passes the information from which the business negotiation can be identified to the control unit 32. The control unit 32 requests the system API 41 to search the registered information using the designated information from which the business negotiation can be identified. The system API 41 requests the external service system 308 to search the registered information using the designated information from which the business negotiation can be identified.

In step S207, the external service system 308 searches the registered information using the information from which the business negotiation can be identified, and transmits a search result to the server apparatus 30. The system API 41 of the server apparatus 30 receives the search result. Specifically, the system API 41 of the server apparatus 30 receives a registered-information list.

In response to the system API 41 of the server apparatus 30 acquiring the registered-information list matching the search, in step S208, the control unit 32 determines to display the registered-information list on the terminal apparatus 10 since the registered-information list is requested by the sales representative 9. The control unit 32 designates the terminal apparatus 10 as the display destination and causes the display data generation unit 38 to generate display data of the registered-information list. The registered-information list is displayed only on the terminal apparatus 10. The display data generation unit 38 generates display data of the registered-information list, and the transmission unit 39 transmits the display data of the registered-information list to the terminal apparatus 10 together with information on the display destination (i.e., the terminal apparatus 10).

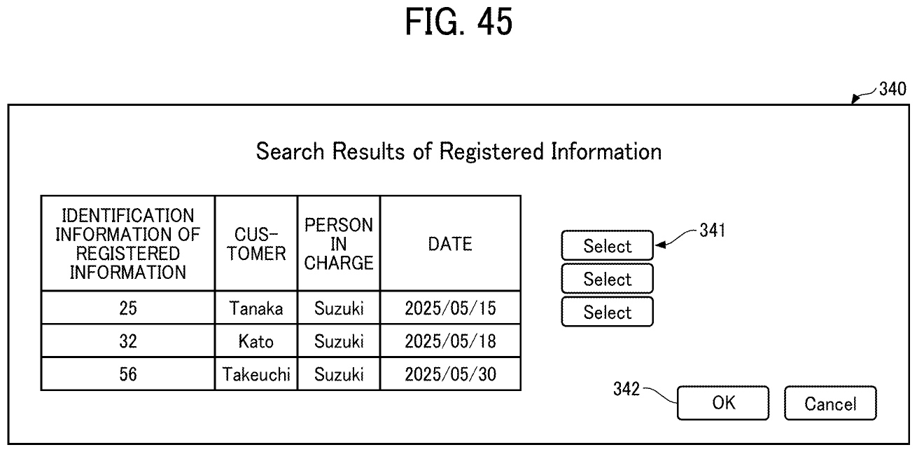

In step S209, the reception unit 14 of the terminal apparatus 10 receives the display data, and passes the display data to the display control unit 15 based on the information on the display destination (i.e., the terminal apparatus 10). The display control unit 15 causes the terminal apparatus 10 to display the registered-information list (see FIG. 45) based on the display data.

In step S210, the sales representative 9 selects, from the list, registered information of a business negotiation to be displayed. The operation reception unit 13 receives the selection.

In step S211, the transmission unit 12 of the terminal apparatus 10 transmits identification information of the selected registered information to the server apparatus 30.

In step S212, the reception unit 31 of the server apparatus 30 receives the identification information of the registered information as operation information, and then passes the identification information to the control unit 32. Since the identification information of the registered information has been identified, the control unit 32 requests the system API 41 to acquire registered information using the designated identification information of the registered information. The system API 41 requests the external service system 308 to acquire registered information using the designated identification information of the registered information.

In step S213, the external service system 308 acquires registered information identified by the identification information of the registered information. The external service system 308 returns the registered information to the server apparatus 30.

In step S214, the system API 41 acquires the registered information from the external service system 308 at the registration destination, and converts the registered information into a data format of the server apparatus 30 by using the correspondence table described above. In response to acquiring the registered information, the system API 41 passes the registered information to the control unit 32. In response to acquiring the registered information, the control unit 32 designates the terminal apparatus 10 as the display destination and causes the display data generation unit 38 to generate display data of the registered information. The display data generation unit 38 generates, for example, display data of a business negotiation setting screen on which the registered information is set.

In step S215, the transmission unit 39 of the server apparatus 30 transmits information on the display destination (i.e., the terminal apparatus 10) and the display data to the terminal apparatus 10.

In step S216, the reception unit 14 of the terminal apparatus 10 receives the display data, and passes the display data to the display control unit 15 based on the information on the display destination (i.e., the terminal apparatus 10). The display control unit 15 causes the registered information to be displayed on, for example, the proposal display screen based on the display data.

### Example Screen

FIG. 44 illustrates an information search screen 330 displayed on the terminal apparatus 10 in step S201. The information search screen 330 illustrated in FIG. 44 includes, for example, a customer field 331, a person-in-charge field 332, and a date field 333. The sales representative 9 specifies a business negotiation for which registered information is to be displayed by selecting one or more of a customer, a person in charge, and a date, and then presses a search button 334.

FIG. 45 illustrates a registered-information list screen 340 displayed on the terminal apparatus 10 in step S209. The registered-information list screen 340 includes a customer name, a sales representative name, and a date on which a business negotiation was performed, in association with identification information of registered information. Since the name of the sales representative 9 is “Suzuki”, a registered-information list associated with “Suzuki” is displayed. The sales representative 9 selects registered information to be displayed, by using a selection button 341 and then presses an OK button 342. Accordingly, the terminal apparatus 10 can display the selected registered information.

The temporarily stored information, the daily report information, the business negotiation history, the text data, and the audio data contained in the registered information are displayed in forms suitable for the information, such as in FIG. 20.

According to the present embodiment, information generated during a business negotiation can be registered in the external service system 308 and can also be downloaded. This automates the registration of meeting minutes to the external service system 308, resulting in a reduced workload on the sales representative.

### Fourth Embodiment

A fourth embodiment of the present disclosure describes a terminal apparatus 10 that displays, for example, an optimal proposal and a predicted proposal on a plurality of displays 60 when the space 360 is equipped with the displays 60.

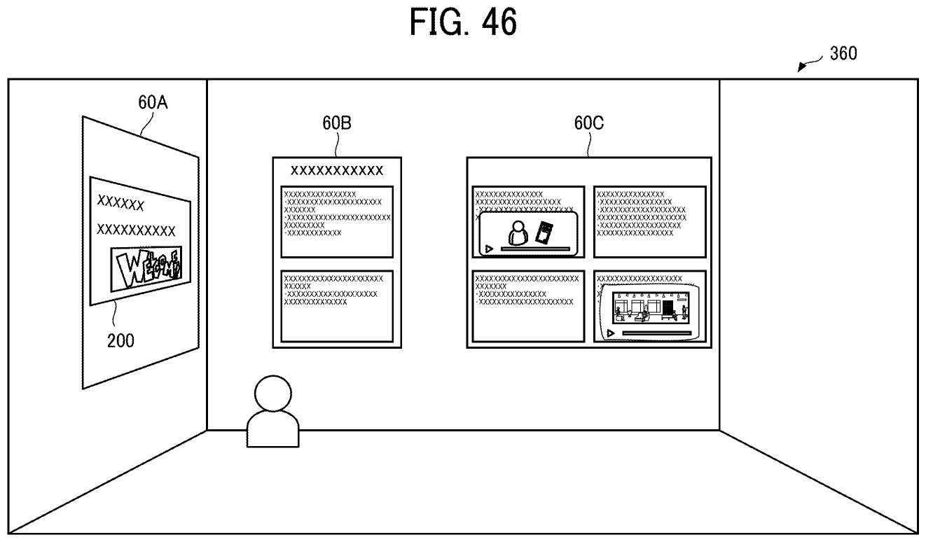

FIG. 46 illustrates displays 60 installed in the space 360. FIG. 46 illustrates three displays 60, that is, displays 60A, 60B, and 60C. Any one of the displays 60A, 60B, and 60C may be referred to as a “display 60”. The number of displays 60 within the space 360 is an example. The displays 60A, 60B, and 60C do not necessarily have the same size.

In FIG. 46, as an example, the display 60A displays the welcome message screen 200. The display 60B displays the areas 291 and 294 illustrated in FIG. 28. The display 60C displays the areas 292, 293, 295, and 296 illustrated in FIG. 28. Thus, the displays 60 can divide and display information such as optimal proposals, predicted proposals, decisions, and action lists into separate areas. Thus, each area can be enlarged for clarity. Alternatively, when each area is not enlarged, for example, multiple optimal proposals, predicted proposals, decisions, and action lists can be displayed at one time, thereby enhancing information visibility.

### Functions

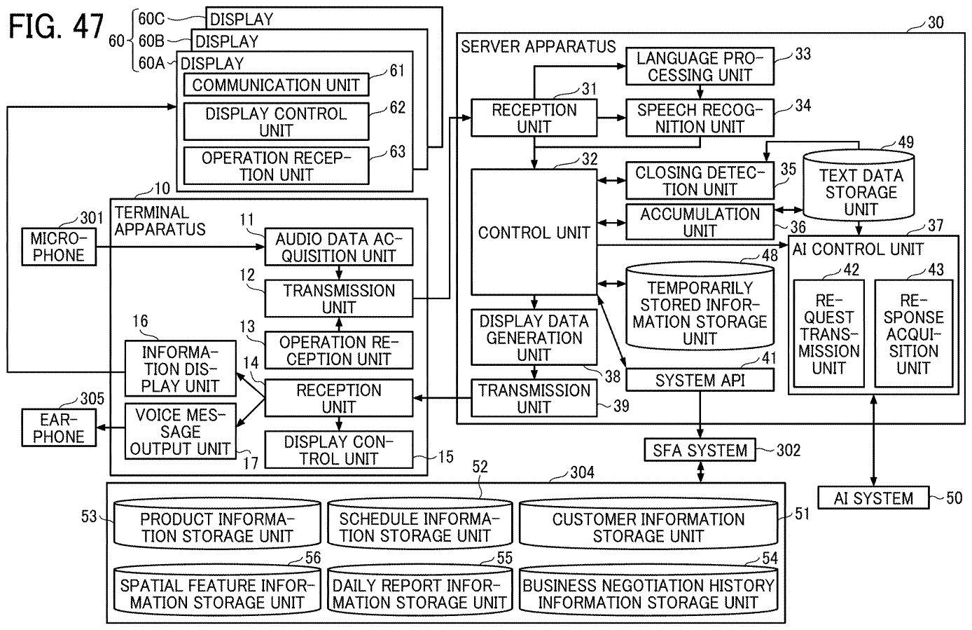

FIG. 47 is a diagram illustrating an example functional configuration of the information processing system 1 according to the present embodiment. In the description of FIG. 47, identical or similar reference signs are given to functional units similar to those in FIG. 3, and the description of the functional units is omitted. In FIG. 47, the displays 60A to 60C are connected to the information display unit 16. Various algorithms may be employed for determining how the information display unit 16 causes the displays 60A to 60C to display optimal proposals and predicted proposals. The sales representative 9 may set in advance the information to be displayed on the displays 60A to 60C.

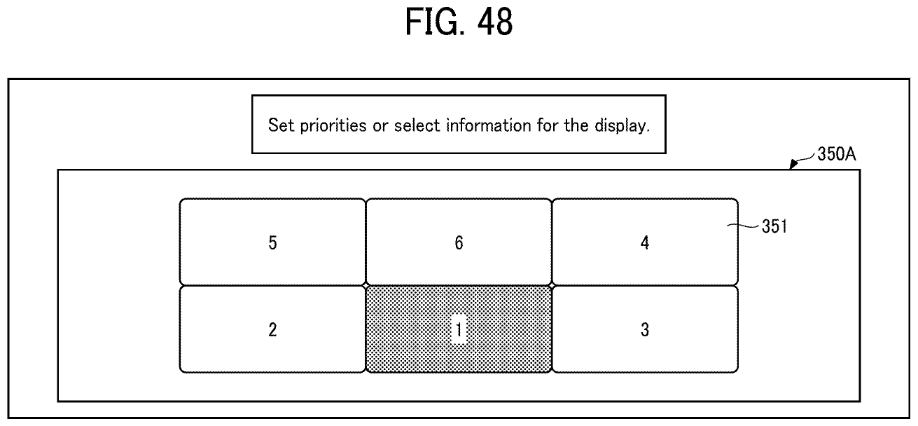

FIG. 48 illustrates a setting screen 350 for setting information to be displayed on the displays 60A to 60C by the sales representative 9. FIG. 48 illustrates, by way of example but not limitation, a multi-display in which a plurality of displays 60 are connected to the terminal apparatus 10. In FIG. 48, six displays 60 are used.

For example, the sales representative 9 assigns priorities to cells 351 on the setting screen 350. The information display unit 16 displays, for example, optimal proposals, predicted proposals, decisions, and action lists in accordance with the priorities.

For example, the sales representative 9 designates which cells 351 on the setting screen 350 display the welcome message screen 200, optimal proposals, predicted proposals, decisions, and action lists.

Based on these settings, the information display unit 16 performs display control as follows.

(1) The display 60A constantly displays the welcome message screen 200. Alternatively, after displaying the welcome message screen 200 for a certain period, the display 60A is used for displaying, for example, optimal proposals, predicted proposals, decisions, and action lists.

(2) A certain number of areas are displayed on the display 60B, and when the capacity is reached, subsequent areas are displayed on the display 60C. Once the display 60C reaches capacity, the information display unit 16 starts overwriting the oldest areas on the display 60B.

(3) In addition, the information display unit 16 may detect the viewing direction of the customer, and after all of the displays 60B and 60C reach capacity, replace less-frequently viewed areas while retaining areas being attended to. The information display unit 16 may retain an area including information having high relevance to text data included in utterances made by the customer and the sales representative. Furthermore, information related to a product for which purchase is decided may constantly be displayed. A less-frequently viewed area or an area including information having low relevance to the text data may be displayed in a reduced size on a predetermined display 60. In this case, as the number of areas displayed on the predetermined display 60 increases, the size of each area is reduced.

The flow of display processing may be similar to that in the sequence diagram of FIG. 19. In step S63, the information display unit 16 allocates which of the displays 60A to 60C is to display, for example, an optimal proposal, a predicted proposal, decisions, or an action list, based on the settings illustrated in FIG. 48 and the rules (1) to (3). The information display unit 16 stores the sizes or resolutions of the displays 60A to 60C, and determines the number of areas that can be displayed on each display 60, based on the area size and the sizes of the displays 60A to 60C.

Furthermore, the sales representative 9 may give a voice instruction of information to be displayed on the displays 60A to 60C. For example, the sales representative 9 provides an instruction, such as “Display the optimal proposal on the display 60A”, to the server apparatus 30. The sales representative 9 also provides an instruction on which area to display on which display 60, for example, “Move this area from the display 60B to the display 60C” or “Move [information item name] from the display 60B to the display 60C”.

Furthermore, rather than arranging one or more areas for an optimal proposal, a predicted proposal, decisions, or an action list in a display 60, a single area may be enlarged to span across a plurality of displays 60. This display mode is implemented by settings in which a plurality of cells on the screen illustrated in FIG. 48 are defined as a single display 60.

According to the present embodiment, each area for displaying an optimal proposal, a predicted proposal, decisions, or an action list can be enlarged, and when each area is not enlarged, information visibility is enhanced.

### Fifth Embodiment

A fifth embodiment of the present disclosure describes a terminal apparatus 10 including a Web browser incorporating an AI system. Web browsers are becoming more sophisticated and AI-enabled, and a Web browser can have all or some functions of an AI system. In this case, the terminal apparatus 10 can minimize communication with the server apparatus 30 and display an optimal proposal or a predicted proposal with a quick response.

### Functions

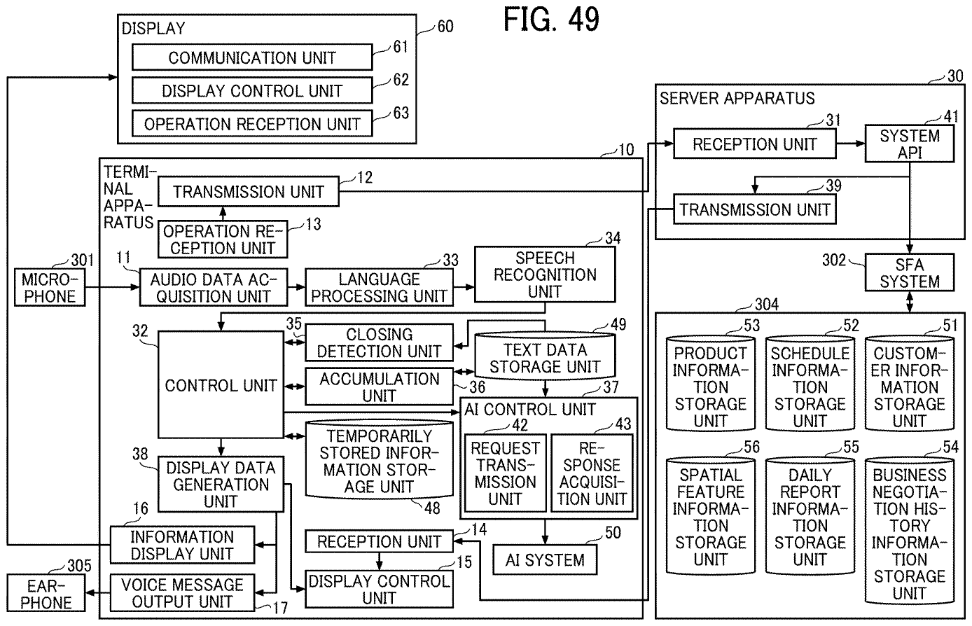

FIG. 49 is a diagram illustrating an example functional configuration of the information processing system 1 according to the present embodiment. The terminal apparatus 10 has functions of the server apparatus 30 illustrated in FIG. 3 described in the first embodiment. That is, the server apparatus 30 includes the reception unit 31, the system API 41, and the transmission unit 39, and the other functional units are included in the terminal apparatus 10. The reception unit 31 receives a request for a Web application from the terminal apparatus 10, and the transmission unit 39 transmits the Web application to the terminal apparatus 10. Thereafter, the terminal apparatus 10 executes the Web application, thereby cooperating with the AI system 50 to generate and display, for example, an optimal proposal or a predicted proposal. Accordingly, the functions of each functional unit included in the terminal apparatus 10 may be similar to those when the functions are included in the server apparatus 30.

In FIG. 49, the terminal apparatus 10 includes the AI system 50, and the server apparatus 30 does not include the AI system 50. However, the server apparatus 30 may also include the AI system 50. In this case, the AI system 50 of the terminal apparatus 10 and the AI system 50 of the server apparatus 30 may be selectively used according to the content of processing. For example, the terminal apparatus 10 may perform simple AI processing such as chat, and the server apparatus 30 may perform high-load AI processing such as data analysis and image generation. As a method of selective use, the sales representative 9 may explicitly request processing by the server apparatus 30, or the AI system 50 of the terminal apparatus 10 may determine whether processing is to be performed by the terminal apparatus 10 or the server apparatus 30 in accordance with an instruction from the control unit 32.

### Operations

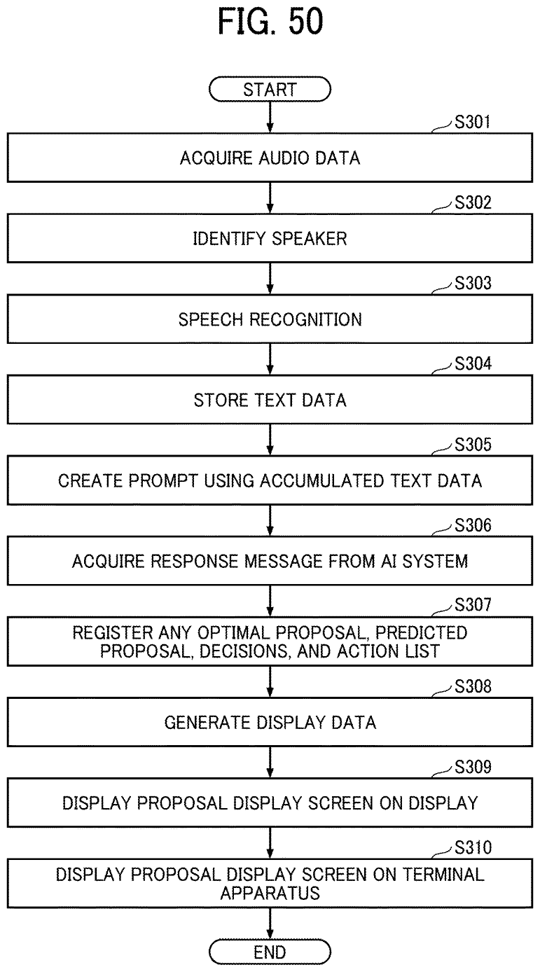

FIG. 50 is a flowchart illustrating processing performed by the terminal apparatus 10 to display a proposal based on audio data acquired from the space 360, the space information 1, the space information 2, and the space information 3. Since the processing performed by the terminal apparatus 10 in FIG. 50 may be similar to the processing performed by the server apparatus 30 in FIG. 19, details of each step are as described with reference to FIG. 19.

In step S301, the customer 8 and the sales representative 9 start a conversation. The microphone 301 acquires audio data of utterances made by the sales representative 9 and the customer 8. The microphone 301 transmits audio data to the terminal apparatus 10 in real time or at intervals of a predetermined time period. The audio data acquisition unit 11 of the terminal apparatus 10 acquires the audio data.

In step S302, the language processing unit 33 performs speaker diarization and identifies a speaker with suitable granularity such as for each segment of audio data, for each sentence, or for each word.

In step S303, the speech recognition unit 34 converts the audio data into text data.

In step S304, the control unit 32 requests the accumulation unit 36 to accumulate the text data, and the accumulation unit 36 accumulates the text data in the text data storage unit 49.

In step S305, the AI control unit 37 generates a prompt for instructing the AI system 50 to generate an optimal proposal, a predicted proposal, decisions, and an action list.

In step S306, the AI system 50 generates a response message including an optimal proposal, a predicted proposal, decisions, and an action list in accordance with input of the prompt. The response acquisition unit 43 acquires the response message from the AI system 50 and passes the response message to the control unit 32.

In step S307, when the response message includes an optimal proposal, a predicted proposal, decisions, and an action list, the control unit 32 registers the optimal proposal, the predicted proposal, the decisions, and the action list in the temporarily stored information storage unit 48.

In step S308, the control unit 32 designates the display 60 as the display destination and requests the display data generation unit 38 to generate display data including an optimal proposal and a predicted proposal. The display data generation unit 38 generates display data of a proposal display screen to be displayed on the display 60 to present the optimal proposal and the predicted proposal. The display data generation unit 38 generates display data of a proposal display screen to be displayed on the terminal apparatus 10 to present the optimal proposal and the predicted proposal.

In step S309, the information display unit 16 causes the display 60 to display the proposal display screen based on the display data.

In step S310, the display control unit 15 causes the terminal apparatus 10 to display the proposal display screen based on the display data.

In addition to the effects of the first embodiment, the present embodiment allows the terminal apparatus 10 to generate an optimal proposal or a predicted proposal, reducing the time until, for example, an optimal proposal or a predicted proposal is displayed from a conversation.

### Sixth Embodiment

A sixth embodiment of the present disclosure describes in detail processing performed by a Web browser executed on the terminal apparatus 10 in the first embodiment to the fifth embodiment. The Web browser may be a browser application or may be an application using a WebView function. The WebView is a mechanism or a component for displaying a Web page in a native application. The WebView can display Web content (HTML/CSS/JavaScript®) as part of an application screen without opening a Web browser.

The Web browser includes a browser engine, a script engine, and a network engine.

The browser engine refers to a function of interpreting a structure (HTML) and a style (CSS) of a Web page and displaying the Web page on a screen. Functions of the browser engine include HTML parsing to build a Document Object Model (DOM) tree, CSS parsing to apply style rules, layout calculation to determine the position and size of each element, painting to execute pixel-level rendering processing (reflection on a UI), and recalculation and redrawing for re-rendering in accordance with changes in the DOM/CSS.

The network engine refers to a function of acquiring and transmitting resources of a Web page, such as HTML, CSS, scripts, and images, by using a communication protocol such as Hypertext Transfer Protocol (HTTP) or Hypertext Transfer Protocol Secure (HTTPS). Functions of the network engine include generation and transmission of a URL request to request GET/POST operations to a server, protocol management to perform communication in procedures corresponding to protocols such as HTTP, HTTPS, and Hypertext Transfer Protocol version 2 (HTTP/2), response reception to acquire an HTML document, an image, and JSON, cache control to manage reuse of the same resources, and security support such as Transport Layer Security (TLS) communication and certificate checking.

The script engine is an execution engine that interprets and executes JavaScript®, and refers to a function responsible for dynamic operations of a Web page, such as event processing and DOM operations. Functions of the script engine include parsing and syntax analysis to convert JavaScript® code into an abstract syntax tree (AST), just-in-time (JIT) compilation to convert the JavaScript® code into bytecode for acceleration and execute the bytecode, execution context management to maintain variables, functions, and scopes, garbage collection to perform memory management and automatic release, and linkage with the DOM.

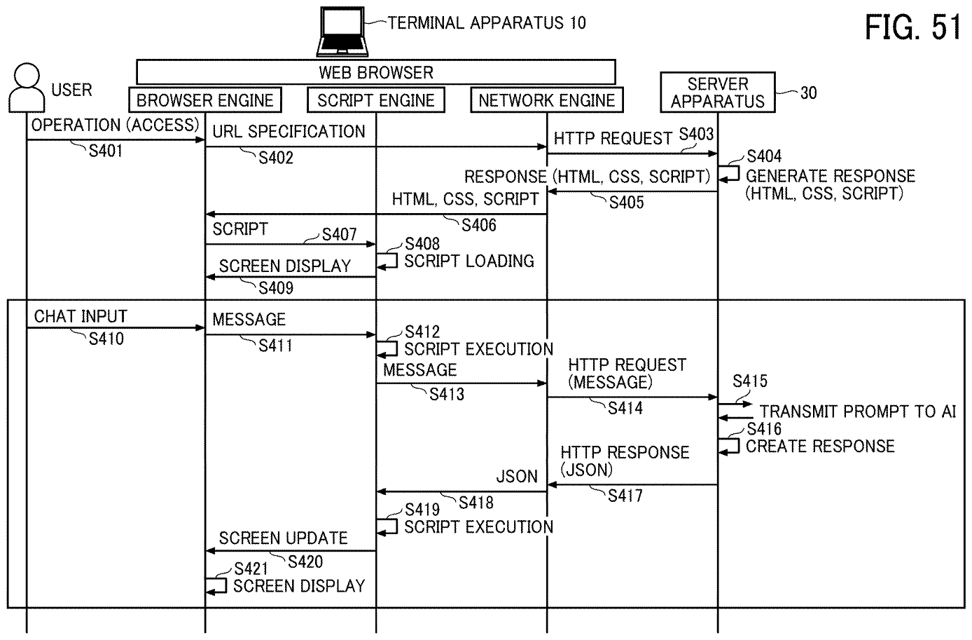

FIG. 51 is a sequence diagram illustrating processing performed by the Web browser to display an optimal proposal or a predicted proposal on a proposal display screen.

Steps S401 to S409 describe a flow for displaying an initial screen on a display. The initial screen corresponds to, for example, the proposal display screen (1) 250 illustrated in FIG. 20.

In step S401, a user or a person in charge performs an operation on the terminal apparatus 10 to connect to the server apparatus 30. The operation reception unit 13 of the terminal apparatus 10 receives the operation.

In response to the operation, in step S402, the browser engine of the Web browser transmits the URL of the server apparatus 30 to the network engine.

In step S403, the network engine generates and transmits an HTTP request addressed to the URL. An HTTP request using a so-called GET method means a request for updating the entire screen.

In step S404, the reception unit 31 of the server apparatus 30 receives the HTTP request, and the control unit 32 generates a response message as described in the embodiments described above. Since the request is a normal HTTP request, the control unit 32 determines to return information of the entire screen. The display data generation unit 38 generates an HTTP response. The HTTP response contains display data for causing a screen including the response message to be displayed. The HTTP response includes, for example, HTML, CSS, and scripts.

In step S405, the transmission unit 39 of the server apparatus 30 transmits the HTTP response to the terminal apparatus 10.

In step S406, the network engine receives the HTTP response and transmits the HTTP response to the browser engine.

In step S407, the browser engine passes the described scripts to the script engine.

In step S408, the script engine loads the scripts into memory.

In step S409, the script engine executes the scripts to generate content, and passes the content to the browser engine. The browser engine displays a screen by arranging the content generated by the script engine on a screen generated by analyzing the HTML and the CSS. Since the HTML contains the element enclosed by the <html> and </html> tags, the browser engine clears the current DOM, parses new HTML, and re-renders the display.

Thus, in the initial screen display, the Web browser displays a screen using all of the HTML, the CSS, and the scripts (see, for example, FIG. 20).

Steps S410 to S421 describe a flow for updating and displaying messages and images on a screen currently being displayed on the display. This screen corresponds to, for example, the proposal display screen (2) 270 illustrated in FIG. 23, the proposal display screen (3) 290 illustrated in FIG. 28, or the proposal display screen (4) 300 illustrated in FIG. 29.

In step S410, the user inputs audio data to the terminal apparatus 10 for a business negotiation. The audio data acquisition unit 11 acquires the audio data.

In step S411, the browser engine transmits the audio data to the script engine.

In step S412, the script engine executes processing described in the scripts for a case where audio data is input. In response to receiving the audio data, the script engine adds “/api/” to the destination URL for an HTTP request. In a Web server, a URL that includes “/api/” conventionally indicates a request for data only. A path containing “/api/” is a route that returns data used for programs, rather than HTML for screen updates. Therefore, the server apparatus 30 returns only data in a format such as JSON or XML. The script engine determines to transmit an HTTP request that includes the audio data following “/api/”.

In step S413, the script engine transmits the audio data to the network engine.

In step S414, the network engine transmits, to the server apparatus 30, the HTTP request in which the audio data is included in the destination URL.

In step S415, the reception unit 31 of the server apparatus 30 receives the HTTP request and transmits a prompt to the AI system 50 as in the embodiments described above to generate a response message.

Based on the receipt of the audio data along with “/api/”, in step S416, the display data generation unit 38 of the server apparatus 30 incorporates into the JSON only a difference from the current screen. In the present embodiments, the JSON includes the response message.

In step S417, the display data generation unit 38 of the server apparatus 30 generates an HTTP response including the JSON. The transmission unit 39 of the server apparatus 30 transmits the HTTP response to the terminal apparatus 10.

In step S418, the network engine receives the HTTP response and transmits the HTTP response to the script engine.

In step S419, the script engine executes processing described in the scripts for a case where display data is received. For example, the script engine analyzes “document.getElementById(\“hat-area\”).innerHTML=renderMessages(data)” and determines to additionally display a response message such as an optimal proposal or a predicted proposal.

In step S420, the script engine transmits the JSON to the browser engine and requests update of a screen.

In step S421, the browser engine causes the response message included in the JSON to be displayed on the proposal display screen to update the proposal display screen. Thus, instead of redisplaying an entire Web page, the terminal apparatus 10 can newly display only an updated portion. In addition, a single-page application can load faster.

The server apparatus 30 can reduce a processing load for displaying, for example, an optimal proposal or a predicted proposal on a screen such as a proposal display screen, and can shorten the time to display such a proposal.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

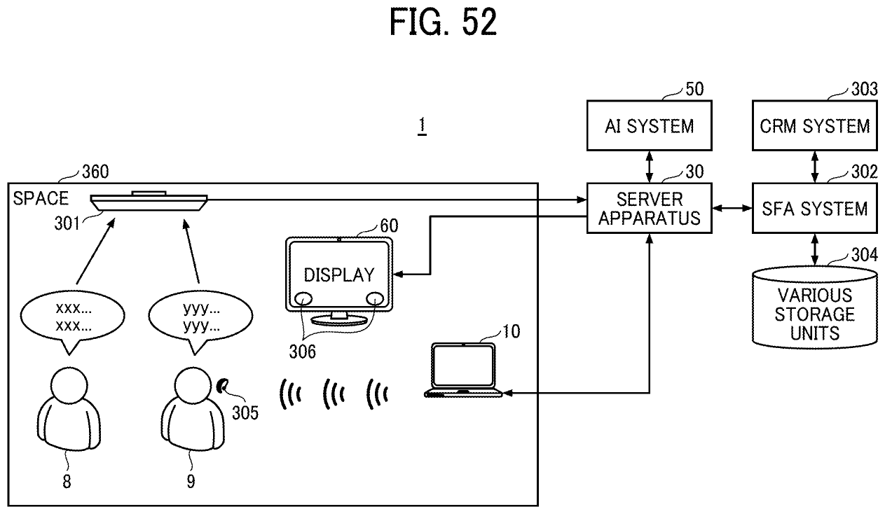

For example, the information processing system 1 may have a configuration as illustrated in FIG. 52. FIG. 52 is a diagram illustrating the information processing system 1 located in the space 360 according to a modification. The microphone 301 and the display 60 are connected to the server apparatus 30. In the illustrated configuration, audio data of the customer 8 and the sales representative 9 is transmitted to the server apparatus 30, and the server apparatus 30 transmits a proposal to the display 60.

The server apparatus 30 also transmits display data of, for example, a business negotiation space settings screen and a daily report screen to the terminal apparatus 10. Accordingly, the processing performed by the server apparatus 30 is the same as that illustrated in FIG. 19, except that the server apparatus 30 switches the transmission destination of the display data.

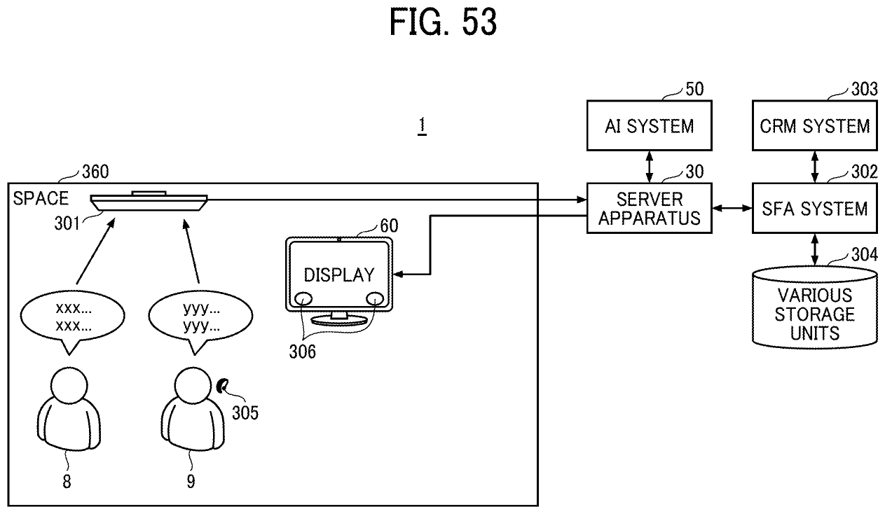

Alternatively, as illustrated in FIG. 53, the terminal apparatus 10 may be omitted from the space 360. In the illustrated configuration, since the business negotiation space settings screen is not displayed on the terminal apparatus 10, the customer 8 may be identified based on audio data, or the server apparatus 30 may cause the display 60 to display the business negotiation space settings screen. An instruction from the sales representative 9 can be given by audio data. Alternatively, the display 60 receives operations performed by the sales representative 9. In addition, a screen to be displayed on the terminal apparatus 10, such as a daily report screen, is displayed on a PC used by the sales representative 9 at an office or at home. A voice message is transmitted to the earphone 305 via the display 60, or is transmitted from the server apparatus 30 directly to the earphone 305.

FIG. 54 is a perspective view of a wearable microphone 309, by way of example but not limitation. The wearable microphone 309 is worn, for example, around a wrist or around a neck like a necklace. The wearable microphone 309 captures all the detectable audio. A user can also manually mute the wearable microphone 309. The wearable microphone 309 may be a smartphone.

The wearable microphone 309 may be the emotion sensor 307 for emotion estimation or may be a sensor for acquiring vital data.

The example configurations such as the configuration illustrated in FIG. 3 are divided based on major functions to facilitate understanding of processing performed by the server apparatus 30 and the terminal apparatus 10. No limitation on the present disclosure is intended by how the functions are divided into processing units or by the names of the functions. The processes of the server apparatus 30 and the terminal apparatus 10 may be divided into a greater number of processing units in accordance with the processing details. In addition, the division may be made such that each processing unit includes more processing operations.

The apparatuses or devices described in one or more embodiments of the present disclosure are merely examples of computing environments that implement the embodiments disclosed herein. In some embodiments, the server apparatus 30 includes a plurality of computing devices such as a server cluster. The computing devices are configured to communicate with each other via any type of communication link including a network and a shared memory, and perform the processing disclosed herein.

According to a modification, the display example of FIG. 20 may be configured such that the content of utterances made in the space and captured by a microphone, which may be fixed or wearable, is also displayed on the display 60. Specifically, the content of utterances made in the space is converted into text by any of the terminal apparatus 10, the server apparatus 30, and the AI system 50 and is displayed on a screen of the display 60. At that time, the content of the utterances may be summarized. The displayed content of the utterances may be segmented and displayed by time, meaning, or utterance units. The segments of the content of the utterances may be enclosed in rectangles. The segments may be displayed in association with times. Alternatively, the content of the utterances may be presented on sticky notes that are movable across the screen in accordance with a user operation, with each segment displayed on an individual sticky note. The user is allowed to freely reposition and display each utterance segment. In the example illustrated in FIG. 20, the user can reposition the images in the area 251 in units of sticky notes, and reposition the date and time and the location in the area 252 in units of sticky notes. The repositioning may be performed across the areas 251 to 256.

Furthermore, the workflow defining the processing performed by the server apparatus 30 and the AI system 50 described above may be created by using a workflow creation tool. Thus, a series of processes (workflow) can be created and edited using the workflow creation tool, including the types and contents of prompts to be transmitted to the AI system 50, processing before transmission of the prompts, and the processing performed by the server apparatus 30 after transmission of the prompts. Specifically, the user can use the workflow creation tool to create and edit the series of processing flows illustrated in FIG. 19. Thus, flexibility of a space experience can be enhanced. The workflow defines a series of work procedures and flows of business, and is a definition for automating processes by determining the order of the processes based on rules of which processes are to be executed.

Further, the server apparatus 30 is configured to share disclosed processing steps, for example, the processing steps illustrated in FIG. 13, FIG. 16, and FIG. 19, in various combinations. For example, a process executed by a predetermined unit may be executed by a plurality of information processing apparatuses included in the server apparatus 30. The server apparatus 30 may be implemented as a single server apparatus or may be divided into a plurality of apparatuses.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The present disclosure includes the following aspects.

In Aspect 1, an information processing system includes an information processing apparatus, a terminal apparatus, a microphone included in a space, and a display included in the space. The information processing apparatus includes a first reception unit, a request transmission unit, a response acquisition unit, a display data generation unit, and a first transmission unit. The first reception unit receives from the terminal apparatus audio data including an utterance made by a person in the space. The utterance is input to the microphone. The request transmission unit transmits a prompt to artificial intelligence (AI). The prompt includes space information and content of the audio data and requests a proposal based on the space information and the content of the audio data. The space information includes information related to the space. The response acquisition unit acquires a response transmitted from the AI. The display data generation unit generates, based on the response, display data of a screen including the proposal. The first transmission unit transmits the display data to the terminal apparatus. The terminal apparatus includes a second transmission unit, an information display unit, and a display control unit. The second transmission unit transmits the audio data to the information processing apparatus. The information display unit causes the display to display the screen based on the display data. The display control unit causes the display located in the space to display the screen including the proposal for the person, based on the display data.

According to Aspect 2, in the information processing system of Aspect 1, the request transmission unit adds information related to the person to the prompt, and the prompt includes a prompt for instructing the proposal for the person.

According to Aspect 3, in the information processing system of Aspect 2, the information related to the person includes at least one of an age of the person, a gender of the person, or a purchase history of the person, and the prompt includes a prompt for instructing a proposal of a product or a service for the person.

According to Aspect 4, in the information processing system of Aspect 2 or Aspect 3, the prompt includes a prompt for instructing a first proposal of a product or a service matching a request specified in the utterance included in the audio data.

According to Aspect 5, in the information processing system of Aspect 4, the prompt includes a prompt for instructing, based on the content of the audio data, a second proposal of a product or a service inferred from the audio data to match the request.

According to Aspect 6, in the information processing system of Aspect 5, the display displays the first proposal and the second proposal on a single screen.

According to Aspect 7, in the information processing system of any one of Aspects 1 to 6, the display displays the proposal for each topic of the utterance extracted from the audio data.

According to Aspect 8, in the information processing system of any one of Aspects 1 to 7, the terminal apparatus further includes an operation reception unit. The display control unit causes the terminal apparatus to display a screen for setting the space information. The operation reception unit receives the space information input to the screen by a user. The second transmission unit transmits the space information to the information processing apparatus.

According to Aspect 9, in the information processing system of any one of Aspects 1 to 8, the space information includes at least one of information on an event performed in the space, information on the person who makes the utterance in the space, or information indicating a characteristic of the space.

According to Aspect 10, in the information processing system of any one of Aspects 1 to 9, the display data generation unit generates display data for displaying a plurality of proposals on a single screen. The first transmission unit transmits the display data for displaying the plurality of proposals on the single screen to the display located in the space. The display located in the space displays, based on the display data, the plurality of proposals on the single screen.

According to Aspect 11, in the information processing system of any one of Aspects 1 to 10, the request transmission unit transmits a prompt to the AI, the prompt including the content of the audio data and the space information and requesting generation of a daily report, the response acquisition unit acquires the daily report transmitted from the AI, the display data generation unit generates display data for displaying the acquired daily report, the first transmission unit transmits the display data to the display located in the space to display the display data, and the display located in the space displays the daily report, based on the display data.

According to Aspect 12, in the information processing system of any one of Aspects 1 to 11, the request transmission unit transmits a prompt to the AI, the prompt including the content of the audio data and the space information and requesting generation of a video related to a proposal, the proposal being related to the content of the audio data, the response acquisition unit acquires the video or a uniform resource locator (URL) of the video, the video or the URL being transmitted from the AI, the display data generation unit generates display data for displaying the acquired video, and the first transmission unit transmits the display data to the display located in the space to display the display data, and the display located in the space plays back the video, based on the display data.

According to Aspect 13, in the information processing system of Aspect 8, the display data generation unit generates first display data to be displayed on the display, and generates second display data different from the first display data, the second display data including information not to be displayed on the display, the first transmission unit transmits the first display data to the display located in the space to display the first display data, and transmits the second display data to the terminal apparatus to display the second display data, the display located in the space displays, based on the first display data, the screen including the proposal for the person, and the terminal apparatus displays, based on the second display data, the proposal for the person and the information not to be displayed on the display.

According to Aspect 14, in the information processing system of Aspect 8, the display data generation unit generates display data to be displayed on the terminal apparatus, and the first transmission unit transmits, to the terminal apparatus, the display data to be displayed on the terminal apparatus. In a case where user operation information for causing a proposal included in the display data to be displayed on the display and information specifying the proposal are received by the first reception unit from the terminal apparatus, the display data generation unit generates display data of the specified proposal, and the first transmission unit transmits the display data of the specified proposal to the display located in the space to display the display data, and the display located in the space displays the specified proposal, based on the display data of the specified proposal.

According to Aspect 15, in the information processing system of any one of Aspects 1 to 12, in the space, a sales representative and a customer have a conversation, the sales representative wears an earphone, the request transmission unit transmits a prompt to the AI, the prompt including the content of the audio data and the space information and requesting generation of an instruction to the sales representative, the generation of the instruction being based on a proposal related to the content of the audio data, the response acquisition unit acquires the instruction transmitted from the AI, the display data generation unit generates a voice message for outputting the acquired instruction, the first transmission unit transmits the voice message to the space to output the voice message from the earphone, and the earphone outputs the instruction, based on the voice message.

According to Aspect 16, the information processing system of Aspect 1 further includes an emotion sensor or an estimation unit. The emotion sensor or the estimation unit estimates emotion information of the person. The display data generation unit generates display data for displaying the estimated emotion information, the first transmission unit transmits the display data to the space to display the display data on the terminal apparatus, and the terminal apparatus displays the emotion information, based on the display data.

According to Aspect 17, in the information processing system of Aspect 1, the information processing apparatus is communicable with an external service system via a system application programming interface (API), and the system API converts the proposal for the person into a data format of the external service system and registers the converted proposal in the external service system.

According to Aspect 18, in the information processing system of Aspect 1, the information processing apparatus is communicable with an external service system via a system application programming interface (API), and the system API transmits data summarizing the content of the audio data including the utterance to the external service system to register the data in the external service system.

According to Aspect 19, in the information processing system of Aspect 18, the system API receives, from the external service system, the data summarizing content of past audio data registered in the external service system.

In Aspect 20, an information processing system includes an information processing apparatus, a microphone included in a space, and a display included in the space. The information processing apparatus includes a first reception unit, a request transmission unit, a response acquisition unit, a display data generation unit, and a first transmission unit. The first reception unit receives audio data including an utterance made by a person in the space. The utterance is input to the microphone. The request transmission unit transmits a prompt to artificial intelligence (AI). The prompt includes space information and content of the audio data and requests a proposal based on the space information and the content of the audio data. The space information includes information related to the space. The response acquisition unit acquires a response transmitted from the AI. The display data generation unit generates, based on the response, display data of a screen including the proposal. The first transmission unit transmits the display data to the display. The display located in the space includes a display unit. The display unit displays the screen including the proposal for the person, based on the display data.

1. An information processing system comprising:
an information processing apparatus;
a terminal apparatus;
a microphone located in a space; and
a display located in the space,
the information processing apparatus including first circuitry configured to:
receive audio data from the terminal apparatus, the audio data including an utterance made by a person in the space, the utterance being input to the microphone;
transmit a prompt to artificial intelligence (AI), the prompt including space information and content of the audio data and requesting a proposal based on the space information and the content of the audio data, the space information including information related to the space;
acquire a response transmitted from the AI;
generate, based on the response, display data of a screen including the proposal; and
transmit the display data to the terminal apparatus,
the terminal apparatus including second circuitry configured to:
transmit the audio data to the information processing apparatus; and
cause the display to display the screen including the proposal for the person, based on the display data.

2. The information processing system according to claim 1, wherein
the first circuitry is configured to add information related to the person to the prompt, and
the prompt includes a prompt for instructing the proposal for the person.

3. The information processing system according to claim 2, wherein
the information related to the person includes at least one of an age of the person, a gender of the person, or a purchase history of the person, and
the prompt for instructing the proposal is a prompt for instructing a proposal of a product or a service for the person.

4. The information processing system according to claim 2, wherein
the prompt for instructing the proposal is a prompt for instructing a first proposal of a product or a service matching a request specified in the utterance included in the audio data.

5. The information processing system according to claim 4, wherein
the prompt for instructing the proposal is a prompt for instructing, based on the content of the audio data, a second proposal of a product or a service inferred from the audio data to match the request.

6. The information processing system according to claim 5, wherein the display displays the first proposal and the second proposal on a single screen.

7. The information processing system according to claim 1, wherein
the display displays the proposal for each topic of the utterance extracted from the audio data.

8. The information processing system according to claim 1, wherein the second circuitry of the terminal apparatus is configured to:
display a screen for setting the space information;
receive the space information input to the screen by a user; and
transmit the space information to the information processing apparatus.

9. The information processing system according to claim 1, wherein
the space information includes at least one of information on an event performed in the space, information on the person who makes the utterance in the space, or information indicating a characteristic of the space.

10. The information processing system according to claim 1, wherein
the first circuitry is configured to:
generate display data for displaying a plurality of proposals on a single screen; and
transmit the display data for displaying the plurality of proposals on the single screen to the display, and
the display displays, based on the display data, the plurality of proposals on the single screen.

11. The information processing system according to claim 1, wherein
the first circuitry is configured to:
transmit a prompt to the AI, the prompt including the content of the audio data and the space information and requesting generation of a daily report;
acquire the daily report transmitted from the AI;
generate display data for displaying the acquired daily report; and
transmit the display data to the display, and
the display displays the daily report, based on the display data.

12. The information processing system according to claim 1, wherein
the first circuitry is configured to:
transmit a prompt to the AI, the prompt including the content of the audio data and the space information and requesting generation of a video related to a proposal, the proposal being related to the content of the audio data;
acquire one of the video and a uniform resource locator (URL) of the video that is transmitted from the AI;
generate display data for displaying the video; and
transmit the display data to the display, and
the display plays back the video, based on the display data.

13. The information processing system according to claim 1, wherein
the first circuitry is configured to:
generate first display data to be displayed on the display;
generate second display data different from the first display data, the second display data including information not to be displayed on the display;
transmit the first display data to the display; and
transmit the second display data to the terminal apparatus,
the display displays, based on the first display data, the screen including the proposal for the person, and
the second circuitry of the terminal apparatus is configured to cause the terminal apparatus to display, based on the second display data, the proposal for the person and the information not to be displayed on the display.

14. The information processing system according to claim 1, wherein
the first circuitry is configured to:
generate display data to be displayed on the terminal apparatus;
transmit, to the terminal apparatus, the display data to be displayed on the terminal apparatus; and
in a case where user operation information for causing a proposal included in the display data to be displayed on the display and information specifying the proposal are received from the terminal apparatus,
generate display data of the specified proposal, and
transmit the display data of the specified proposal to the display, and
the display displays the specified proposal, based on the display data of the specified proposal.

15. The information processing system according to claim 1, wherein
the first circuitry is configured to:
transmit a prompt to the AI, the prompt including the content of the audio data and the space information and requesting generation of an instruction to a user having a conversation with another user in the space, the generation of the instruction being based on a proposal related to the content of the audio data;
acquire the instruction transmitted from the AI;
generate a voice message for outputting the acquired instruction; and
transmit the voice message to be received by an earphone worn by the user, and
the earphone outputs the instruction, based on the voice message.

16. The information processing system according to claim 1, wherein
the first circuitry is configured to:
estimate emotion information of the person;
generate display data for displaying the estimated emotion information; and
transmit the display data to the terminal apparatus, and
the second circuitry of the terminal apparatus is configured to display the emotion information, based on the display data.

17. The information processing system according to claim 1, wherein
the information processing apparatus is communicable with an external service system via a system application programming interface (API), and
the system API converts the proposal for the person into a data format of the external service system and registers the converted proposal in the external service system.

18. The information processing system according to claim 1, wherein
the information processing apparatus is communicable with an external service system via a system application programming interface (API), and
the system API transmits data summarizing the content of the audio data including the utterance to the external service system to register the data in the external service system.

19. The information processing system according to claim 18, wherein
the system API receives, from the external service system, the data summarizing content of past audio data registered in the external service system.

20. An information processing method comprising:
receiving audio data, the audio data including an utterance made by a person in a space, the utterance being input to a microphone located in the space;
transmitting a prompt to artificial intelligence (AI), the prompt including space information and content of the audio data and requesting a proposal based on the space information and the content of the audio data, the space information including information related to the space;
acquiring a response transmitted from the AI;
generating, based on the response, display data of a screen including the proposal; and
causing a display located in the space to display the screen including the proposal for the person, based on the display data.

21. An apparatus comprising circuitry configured to:
acquire audio data, the audio data including an utterance made by a person in a space, the utterance being input to a microphone located in the space;
transmit a prompt to artificial intelligence (AI), the prompt including space information and content of the audio data and requesting a proposal based on the space information and the content of the audio data, the space information including information related to the space;
acquire a response transmitted from the AI;
generate, based on the response, display data of a screen including the proposal; and
cause a display located in the space to display the screen including the proposal for the person, based on the display data.
